(19) United States
(12) Patent Application Publication
(10) Pub. No.: US 2024/0284155 A1
(43) Pub. Date: Aug. 22, 2024

(54) LOCALLY INITIATED WIRELESS EMERGENCY ALERTS

(71) Applicant: View, Inc., Milpitas, CA (US)

(72) Inventors: Ji Hoon Lee, Louisville, CO (US); Yerang Hur, Fremont, CA (US); Nitesh Trikha, Pleasanton, CA (US)

(73) Assignee: View, Inc., Milpitas, CA (US)

(21) Appl. No.: 18/292,742

(22) PCT Filed: Jul. 26, 2022
(86) PCT No.: PCT/US2022/074162

§ 371 Date: Jan. 26, 2024

Related U.S. Application Data
(60) Provisional application No. 63/226,127, filed on Jul. 27, 2021.

(51) Int. Cl. H04W 4/90

(52) U.S. Cl. CPC H04W 4/90

(57) ABSTRACT

Locally-initiated, in-facility emergency alerts are provided. Wireless emergency alert (WEA) messages are initiated at a control interface of a facility. The WEA messages are forwarded to User Equipments (UEs) within an emergency incident area of the building over wireless communication links.

### CROSS REFERENCE TO RELATED APPLICATIONS

This application claims the benefit of U.S. Provisional Patent Application Ser. No. 63/226,127, filed Jul. 27, 2021, which is incorporated herein by reference.

### BACKGROUND

The Wireless Emergency Alerts (WEA) program is a governmentally-mandated service that is to be provided by all commercial cellular networks in the United States. The WEA program was established by the Federal Communications Commission (FCC) in response to the Warning, Alert, and Response Act of 2006, e.g., to allow wireless cellular service providers to send geographically-targeted emergency alerts to their subscribers. The Federal Emergency Management Agency (FEMA) is responsible, e.g., for the implementation and administration of the WEA program. Cellular services such as fourth generation (4G), and fifth generation (5G) cellular network services in the United States are required to support WEA messages. Cellular services such as those abiding by Long-Term Evolution (LTE) standard for wireless broadband communication for mobile devices and data terminals cellular network services (in the United States) are required to support WEA messages. All commercial 4G (e.g., 4G LTE) and 5G User Equipments (UEs) are equipped to receive WEA messages. The WEA process can include the following operations: (1) an authorized public safety official sends an alert message to a Federal Alert Gateway, (2) the Federal Alert Gateway forwards the alert message to one or more mobile service providers, (3) the mobile service providers then broadcast the alert to the UEs, and (4) the UEs will automatically receive the alert if they are located in, or travel to, a geographic area that is targeted by the alert.

Local emergencies may fail to attract the attention of public safety officials, and thus not be reported to UEs in an at-risk area. Such local emergencies may occur, for example, in association with a facility including a building, and/or confined to a floor of a building. IN association with the facility may include adjacent to the facility, in the premises of the facility, or within the facility. Individuals located in vulnerable areas may be placed at risk of harm. The full capabilities of the WEA program may not be utilized in local emergencies, e.g., associated with a facility. It may be beneficial to have an infrastructure that facilitates and/or implements WEA messages associated with the facility.

### SUMMARY

Various aspects disclosed herein alleviate at least part of the shortcomings related to implementing local and/or in-facility initiation of WEA messages. For example, disclosed herein is a network associated with a facility that facilitates WEA messaging (e.g., relating to emergency events).

In another aspect, a non-transitory a method of providing a wireless emergency alert message for a facility, the method comprises: receiving an alert for an emergency event at an in-facility network; identifying an emergency incident area of the facility; and sending the wireless emergency alert message through a cellular network to one or more wireless devices within the emergency incident area.

In some embodiments, the method further comprises: mapping a location of the emergency event to one or more cells of the cellular network that serve the emergency incident area; generating the wireless emergency alert message for the one or more cells; and sending the wireless emergency alert message to the one or more cells for distribution to the one or more wireless devices within the emergency incident area. In some embodiments, the method further comprises: obtaining a category for the emergency event; determining the emergency incident area of the facility based at least in part on the category; mapping a location of the emergency event to one or more cells of the cellular network that serve the emergency incident area; generating the wireless emergency alert message for the one or more cells; and sending the wireless emergency alert message to the one or more cells for distribution to the one or more wireless devices within the emergency incident area. In some embodiments, the method further comprises: receiving an alerting request incorporating the wireless emergency alert message; generating a write request incorporating the wireless emergency alert message; selecting one or more area identifiers corresponding to the emergency incident area, wherein each of the one or more area identifiers is associated with a corresponding destination cell of the cellular network; sending the write request and the one or more area identifiers to a mobility management mechanism; and receiving a confirmation message from the mobility management mechanism indicating that the wireless emergency alert message has been distributed to the corresponding destination cell. In some embodiments, the cellular network comprises a 4G network and/or a 5G network, the method further comprises: receiving an alerting request at a local cell broadcast center of the cellular network, the alerting request incorporating the wireless emergency alert message; generating a write replace warning request incorporating the wireless emergency alert message; selecting one or more tracking area identifiers corresponding to the emergency incident area, wherein each tracking area identifier is associated with a corresponding destination cell of the cellular network; sending the write replace warning request and the one or more tracking area identifiers to a local mobility management entity; and receiving a confirmation message from the mobility management entity indicating that the wireless emergency alert message has been distributed to the corresponding destination cell. In some embodiments, the method further comprises: receiving an alarm; generating the wireless emergency alert message for one or more target cells of the cellular network serving the emergency incident area; delivering a first broadcast request to a 4G cell broadcast function when any of the one or more target cells are in a 4G cellular network; delivering a second broadcast request to a 5G cell broadcast function when any of the one or more target cells are in a 5G cellular network; generating a first write replace warning request in response to the first broadcast request; generating a second write replace warning request in response to the second broadcast request; delivering at least one of the first write replace warning request and the second write replace warning request to the one or more target cells. In some embodiments, the method further comprises coupling the in-facility network to a plurality of devices. In some embodiments, the method further comprises disposing the plurality of devices in an envelope of an enclosure. In some embodiments, the envelope of the enclosure comprises a building of the facility. In some embodiments, the method further comprises configuring the in-facility network to provide power distribution and communication on a single path. In some embodiments, the single path comprises a coaxial cable, a twisted pair, an optical cable, or any of various combinations thereof. In some embodiments, the communication is compatible with a device control protocol, a command protocol, a 4G protocol, a 5G protocol, a video protocol, a media protocol, or any of various combinations thereof. In some embodiments, the method further comprises configuring the single path using a cabling system having a cable configured to transmit an electrical current, a first communication type utilized for control of at least one device of the facility, and a second communication type configured for media communication. In some embodiments, the method further comprises operatively coupling the at least one device of the facility to the in-facility network. In some embodiments, the method further comprises configuring a first antenna to receive signals of the second communication type external to the facility and transmit signals of the second communication type externally to the facility, which first antenna is operatively coupled to the cabling system. In some embodiments, the method further comprises configuring a second antenna to receive signals of the second communication type internal to the facility, and to transmit signals of the second communication type internally in the facility, which second antenna is operatively coupled to the cabling system. In some embodiments, the method further comprises operatively coupling at least one controller to the cabling system, the at least one controller being configured to control the at least one device using the first communication type. In some embodiments, the first communication type and the second communication type have no overlapping signal frequencies. In some embodiments, the first communication type is in one frequency window. In some embodiments, the first communication type comprises a plurality of frequency windows. In some embodiments, the second communication type is in one frequency window. In some embodiments, the second communication type comprises a plurality of frequency windows. In some embodiments, the method further comprises operatively coupling the cabling system to one or more signal frequency filters. In some embodiments, the method further comprises operatively coupling the cabling system to one or more signal amplifiers and/or repeaters. In some embodiments, the second communication type comprises fourth generation (4G) and/or fifth generation (5G) cellular communication. In some embodiments, the second communication type comprises analog radio-frequency signals. In some embodiments, the first antenna is a directional antenna. In some embodiments, the second antenna is part of a distributed antenna system. In some embodiments, the second antenna is disposed in one of a plurality of edge distribution frame devices disposed in the facility. In some embodiments, the electrical current is a direct current. In some embodiments, the method further comprises using the electrical current to supply electrical power to the at least one device of the facility. In some embodiments, the method further comprises supplying electrical power to the at least one device using a voltage of at most about 48 volts. In some embodiments, the facility comprises floors and wherein the cabling system comprises an optical cable that transits the first communication type and/or the second communication type between the floors. In some embodiments, the facility comprises a plurality of control panels and wherein the cabling system comprises an optical cable that transmits the first communication type and/or the second communication type between the plurality of control panels. In some embodiments, the cabling system comprises a distribution junction. In some embodiments, the distribution junction distributes the power unevenly. In some embodiments, the distribution junction distributes the first communication type and/or second communication type unevenly. In some embodiments, the distribution junction is passive. In some embodiments, the distribution junction comprises an active element. In some embodiments, the active element is a controller. In some embodiments, the method further comprises operatively coupling the in-facility network to at least one controller. In some embodiments, the method further comprises providing a cabling system having a cable configured to transmit an electrical current, a first communication type utilized for control of at least one device of the facility, and a second communication type configured for media communication. In some embodiments, the cabling system is configured to provide power distribution and communication to the at least one device of the facility. In some embodiments, the cabling system is configured to provide power distribution and communication to the at least one device of the facility on a single path. In some embodiments, the at least one controller is configured to generate the first communication type. In some embodiments, the at least one controller is configured to operatively couple to a building management system. In some embodiments, the first communication type is generated and/or utilized by the at least one device. In some embodiments, the at least one device of the facility comprises a sensor, emitter, antenna, tintable window, lighting, security system, heating ventilation and air conditioning system (HVAC), or any of various combinations thereof. In some embodiments, the sensor is configured for sensing, or directing sensing of, the emergency event. In some embodiments, the sensor is sensitive to movement. In some embodiments, the sensor comprises an accelerometer. In some embodiments, the emitter comprises a light emitter or a sound emitter. In some embodiments, the sensor comprises an infrared, ultraviolet, or visible light sensor. In some embodiments, the sensor is sensitive to at least one environmental characteristic comprises humidity, carbon dioxide, temperature, sound, electromagnetic, volatile organic compound, or pressure. In some embodiments, the sensor comprises a gas sensor sensitive to gas type, movement, and/or pressure. In some embodiments, the at least one device of the facility is part of a device ensemble comprises one or more devices enclosed in a housing. In some embodiments, the at least one device of the facility comprises at least two devices of the same type. In some embodiments, the at least one device of the facility comprises at least two devices that are not of the same type. In some embodiments, the facility is a multi-story building. In some embodiments, the multi-story building is a skyscraper. In some embodiments, the at least one device of the facility comprises at least one geo-location sensor operatively coupled to the in-facility network. In some embodiments, the at least one geo-location sensor comprises a transceiver having a known position. In some embodiments, the known position comprises a location within the facility. In some embodiments, the known position comprises a location within an enclosure. In some embodiments, the known position comprises third-party data. In some embodiments, the method further comprises establishing the known position using a traveler. In some embodiments, the at least one geo-location sensor comprises a plurality of stationary transceivers each having a known stationary position. In some embodiments, the at least one geo-location sensor further comprises a transitory transceiver. In some embodiments, the plurality of stationary transceivers are configured to locate the transitory transceiver in the facility. In some embodiments, the transitory transceiver is configured to be (i) carried by an occupant of the facility, and/or (ii) attached to an asset disposed in the facility. In some embodiments, the transceiver is disposed in a housing that comprises (i) sensors or (ii) a sensor and an emitter. In some embodiments, the housing is disposed in a fixture of the facility. In some embodiments, components of the housing are configured to facilitate adjustment of an environment of the facility in which the housing is disposed. In some embodiments, the at least one geo-location sensor comprises an ultra-wideband (UWB) device. In some embodiments, the method further comprises transmitting an alert message to an external entity outside the facility, in response to receiving the alert for the emergency event at the in-facility network. In some embodiments, the external entity comprises a police department, a fire department, the National Guard, a facility owner, a facility manager, a local governmental unit, or any of various combinations thereof. In some embodiments, the facility comprises one or more buildings. In some embodiments, the facility comprises one or more buildings and property adjoining the one or more buildings. In some embodiments, the wireless emergency alert message is provided locally to the facility. In some embodiments, the alert for the emergency event is received locally to the facility.

In another aspect, a non-transitory computer readable program product for providing a wireless emergency alert message for a facility, the non-transitory computer readable program product having instructions that, when read by at least one processor, cause the at least one processor to execute, or direct execution of, operations of any of the methods disclosed above.

In another aspect, a non-transitory computer readable program product for providing a wireless emergency alert message for a facility, the non-transitory computer readable program product having instructions that, when read by at least one processor, cause the at least one processor to execute operations comprises: (a) receiving, or directing receipt of, an alert for an emergency event at an in-facility network; (b) identifying, or directing identification of, an emergency incident area of the facility; and (c) sending, or directing sending of, the wireless emergency alert message through a cellular network to one or more wireless devices within the emergency incident area.

In another aspect, an apparatus for providing a wireless emergency alert message for a facility, the apparatus comprises at least one controller configured to operatively couple to an in-facility network and perform, or direct performance of, any of the methods disclosed above.

In another aspect, an apparatus for providing a wireless emergency alert message for a facility, the apparatus comprises at least one controller configured to operatively couple to an in-facility network and perform, wherein the at least one controller is further configured to: (a) receive, or direct receipt of, an alert for an emergency event at the in-facility network; (b) identify, or direct identification of, an emergency incident area of the facility; and (c) send, or direct sending of, the wireless emergency alert message through a cellular network to one or more wireless devices within the emergency incident area.

In another aspect, an apparatus for providing a wireless emergency alert message for a facility, the apparatus comprises at least one controller configured to operatively couple to a 4G cellular network and/or a 5G cellular network, wherein the at least one controller is further configured to: (a) receive, or direct receipt of, a wireless emergency alert from an in-facility network; (b) receive, or direct receipt of, one or more tracking area identifiers from the in-facility network that identify an emergency incident area of the facility; and (c) send, or direct sending of, the wireless emergency alert message to one or more wireless devices within the emergency incident area using the one or more tracking area identifiers.

In another aspect, a system for providing a wireless emergency alert message for a facility, the system comprises a network of a facility; and one or more sensors disposed in the facility and configured for sensing an emergency event, wherein the network is configured to one or more signals associated with any of the methods disclosed above.

In another aspect, a system for providing a wireless emergency alert message for a facility, the system comprises a network of a facility; and one or more sensors disposed in the facility and configured for sensing an emergency event; and wherein the network is configured to transmit wireless emergency alert message to a cellular network that serves the emergency incident area, which wireless emergency alert is generated based at least in part on measurements of the one or more sensors.

In another aspect, the present disclosure provides systems, apparatuses (e.g., controllers), and/or non-transitory computer-readable medium or media (e.g., software) that implement any of the methods disclosed herein.

In another aspect, the present disclosure provides methods that use any of the systems, computer readable media, and/or apparatuses disclosed herein, e.g., for their intended purpose.

In another aspect, an apparatus comprises at least one controller that is programmed to direct a mechanism used to implement (e.g., effectuate) any of the method disclosed herein, which at least one controller is configured to operatively couple to the mechanism. In some embodiments, at least two operations (e.g., of the method) are directed/executed by the same controller. In some embodiments, at less at two operations are directed/executed by different controllers.

In another aspect, an apparatus comprises at least one controller that is configured (e.g., programmed) to implement (e.g., effectuate) any of the methods disclosed herein. The at least one controller may implement any of the methods disclosed herein. In some embodiments, at least two operations (e.g., of the method) are directed/executed by the same controller. In some embodiments, at less at two operations are directed/executed by different controllers.

In some embodiments, one controller of the at least one controller is configured to perform two or more operations. In some embodiments, two different controllers of the at least one controller are configured to each perform a different operation.

In another aspect, a system comprises at least one controller that is programmed to direct operation of at least one another apparatus (or component thereof), and the apparatus (or component thereof), wherein the at least one controller is operatively coupled to the apparatus (or to the component thereof). The apparatus (or component thereof) may include any apparatus (or component thereof) disclosed herein. The at least one controller may be configured to direct any apparatus (or component thereof) disclosed herein. The at least one controller may be configured to operatively couple to any apparatus (or component thereof) disclosed herein. In some embodiments, at least two operations (e.g., of the apparatus) are directed by the same controller. In some embodiments, at less at two operations are directed by different controllers.

In another aspect, a computer software product (e.g., inscribed on one or more non-transitory medium) in which program instructions are stored, which instructions, when read by at least one processor (e.g., computer), cause the at least one processor to direct a mechanism disclosed herein to implement (e.g., effectuate) any of the method disclosed herein, wherein the at least one processor is configured to operatively couple to the mechanism. The mechanism can comprise any apparatus (or any component thereof) disclosed herein. In some embodiments, at least two operations (e.g., of the apparatus) are directed/executed by the same processor. In some embodiments, at less at two operations are directed/executed by different processors.

In another aspect, the present disclosure provides a non-transitory computer-readable program instructions (e.g., included in a program product comprising one or more non-transitory medium) comprising machine-executable code that, upon execution by one or more processors, implements any of the methods disclosed herein. In some embodiments, at least two operations (e.g., of the method) are directed/executed by the same processor. In some embodiments, at less at two operations are directed/executed by different processors.

In another aspect, the present disclosure provides a non-transitory computer-readable medium or media comprising machine-executable code that, upon execution by one or more processors, effectuates directions of the controller(s) (e.g., as disclosed herein). In some embodiments, at least two operations (e.g., of the controller) are directed/executed by the same processor. In some embodiments, at less at two operations are directed/executed by different processors.

In another aspect, the present disclosure provides a computer system comprising one or more computer processors and a non-transitory computer-readable medium or media coupled thereto. The non-transitory computer-readable medium comprises machine-executable code that, upon execution by the one or more processors, implements any of the methods disclosed herein and/or effectuates directions of the controller(s) disclosed herein.

In another aspect, the present disclosure provides a non-transitory computer readable program instructions that, when read by one or more processors, causes the one or more processors to execute any operation of the methods disclosed herein, any operation performed (or configured to be performed) by the apparatuses disclosed herein, and/or any operation directed (or configured to be directed) by the apparatuses disclosed herein.

In some embodiments, the program instructions are inscribed in a non-transitory computer readable medium or media. In some embodiments, at least two of the operations are executed by one of the one or more processors. In some embodiments, at least two of the operations are each executed by different processors of the one or more processors.

In another aspect, the present disclosure provides networks that are configured for transmission of any communication (e.g., signal) and/or (e.g., electrical) power facilitating any of the operations disclosed herein. The communication may comprise control communication, cellular communication, media communication, and/or data communication. The data communication may comprise sensor data communication and/or processed data communication. The networks may be configured to abide by one or more protocols facilitating such communication. For example, a communications protocol used by the network (e.g., with a BMS) can be a building automation and control networks protocol (BACnet). For example, a communication protocol may facilitate cellular communication abiding by at least a 2^{nd}, 3^{rd}, 4^{th}, or 5^{th} generation cellular communication protocol.

The content of this summary section is provided as a simplified introduction to the disclosure and is not intended to be used to limit the scope of any invention disclosed herein or the scope of the appended claims.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

These and other features and embodiments will be described in more detail with reference to the drawings.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings or figures (also “Fig.” and “Figs.” herein), of which:

FIG. 1 schematically shows a processing system;

FIG. 2 shows an example of a flow diagram for processing alert messages;

FIG. 3 schematically shows an example of an in-building wireless emergency alert system;

FIG. 4 schematically shows an example of an in-building wireless emergency alert gateway;

FIG. 5 schematically shows an example of an in-building 4G cell broadcast;

FIG. 6 schematically shows an example of an in-building 5G cell broadcast;

FIG. 7 schematically illustrates an example of a use case for processing alert messages;

FIG. 8 schematically shows a control system architecture and a building;

FIG. 9 schematically shows a building and a network;

FIG. 10 shows a block diagram of a network of devices;

FIG. 11 schematically depicts a communication network disposed in various enclosures;

FIG. 12 shows a schematic example of a sensor arrangement;

FIG. 13 shows a schematic example of a sensor arrangement and sensor data;

FIG. 14 shows a topographic map of measured property values;

FIG. 15 shows an apparatus, its components, and connectivity options;

FIG. 16 shows an example of temperature mapping in an enclosure;

FIG. 17 schematically depicts a controller;

FIG. 18 is a flowchart depicting an example of a method for accepting and

processing wireless alert messages;

FIG. 19 is a flowchart depicting an example of a method for processing event notifications;

FIG. 20 is a flowchart depicting an example of a method for distributing a wireless alert message in a 4G wireless communication system;

FIG. 21 is a flowchart depicting an example of a method for distributing a wireless alert message in a 5G wireless communication system;

FIG. 22 is a flowchart depicting an example of a method for distributing a wireless alert message in a communication system that provides a combination of 4G cells and 5G cells;

FIG. 23 schematically shows a layer structure of an electrochromic device; and

FIG. 24 schematically shows a cross section of an Insulated Glass Unite (IGU).

The figures and components therein may not be drawn to scale. Various components of the figures described herein may not be drawn to scale.

### DETAILED DESCRIPTION

While various embodiments of the invention have been shown, and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein might be employed.

Terms such as “a,” “an,” and “the” are not intended to refer to only a singular entity but include the general class of which a specific example may be used for illustration. The terminology herein is used to describe specific embodiments of the invention(s), but their usage does not delimit the invention(s).

When ranges are mentioned, the ranges are meant to be inclusive, unless otherwise specified. For example, a range between value 1 and value 2 is meant to be inclusive and include value 1 and value 2. The inclusive range will span any value from about value 1 to about value 2. The term “adjacent” or “adjacent to,” as used herein, includes “next to,” “adjoining,” “in contact with,” and “in proximity to.”

As used herein, including in the claims, the conjunction “and/or” in a phrase such as “including X, Y, and/or Z”, refers to in inclusion of any combination or plurality of X, Y, and Z. For example, such phrase is meant to include X. For example, such phrase is meant to include Y. For example, such phrase is meant to include Z. For example, such phrase is meant to include X and Y. For example, such phrase is meant to include X and Z. For example, such phrase is meant to include Y and Z. For example, such phrase is meant to include a plurality of Xs. For example, such phrase is meant to include a plurality of Ys. For example, such phrase is meant to include a plurality of Zs. For example, such phrase is meant to include a plurality of Xs and a plurality of Ys. For example, such phrase is meant to include a plurality of Xs and a plurality of Zs. For example, such phrase is meant to include a plurality of Ys and a plurality of Zs. For example, such phrase is meant to include a plurality of Xs and Y. For example, such phrase is meant to include a plurality of Xs and Z. For example, such phrase is meant to include a plurality of Ys and Z. For example, such phrase is meant to include X and a plurality of Ys. For example, such phrase is meant to include X and a plurality of Zs. For example, such phrase is meant to include Y and a plurality of Zs. The conjunction “and/or” is meant to have the same effect as the phrase “X, Y, Z, or any combination or plurality thereof.” The conjunction “and/or” is meant to have the same effect as the phrase “one or more X, Y, Z, or any combination thereof.”

The term “operatively coupled” or “operatively connected” refers to a first element (e.g., mechanism) that is coupled (e.g., connected) to a second element, to allow the intended operation of the second and/or first element. The coupling may comprise physical or non-physical coupling (e.g., communicative coupling). The non-physical coupling may comprise signal-induced coupling (e.g., wireless coupling). Coupled can include physical coupling (e.g., physically connected), or non-physical coupling (e.g., via wireless communication). Operatively coupled may comprise communicatively coupled.

An element (e.g., mechanism) that is “configured to” perform a function includes a structural feature that causes the element to perform this function. A structural feature may include an electrical feature, such as a circuitry or a circuit element. A structural feature may include an actuator. A structural feature may include a circuitry (e.g., comprising electrical or optical circuitry). Electrical circuitry may comprise one or more wires. Optical circuitry may comprise at least one optical element (e.g., beam splitter, mirror, lens and/or optical fiber). A structural feature may include a mechanical feature. A mechanical feature may comprise a latch, a spring, a closure, a hinge, a chassis, a support, a fastener, or a cantilever, and so forth. Performing the function may comprise utilizing a logical feature. A logical feature may include programming instructions. Programming instructions may be executable by at least one processor. Programming instructions may be stored or encoded on a medium accessible by one or more processors. Additionally, in the following description, the phrases “operable to,” “adapted to,” “configured to,” “designed to,” “programmed to,” or “capable of” may be used interchangeably where appropriate.

In some embodiments, an enclosure comprises an area defined by at least one structure. The at least one structure may comprise at least one wall. An enclosure may comprise and/or enclose one or more sub-enclosures. The at least one wall may comprise metal (e.g., steel), clay, stone, plastic, glass, plaster (e.g., gypsum), polymer (e.g., polyurethane, styrene, or vinyl), asbestos, fiber-glass, concrete (e.g., reinforced concrete), wood, paper, or a ceramic. The at least one wall may comprise wire, bricks, blocks (e.g., cinder blocks), tile, drywall, or frame (e.g., steel frame).

In some embodiments, the enclosure comprises one or more openings. The one or more openings may be reversibly closable. The one or more openings may be permanently open. A fundamental length scale of the one or more openings may be smaller relative to the fundamental length scale of the wall(s) that define the enclosure. A fundamental length scale may comprise a diameter of a bounding circle, a length, a width, or a height. A surface of the one or more openings may be smaller relative to the surface the wall(s) that define the enclosure. The opening surface may be a percentage of the total surface of the wall(s). For example, the opening surface can measure at most about 30%, 20%, 10%, 5%, or 1% of the walls(s). The wall(s) may comprise a floor, a ceiling, or a side wall. The closable opening may be closed by at least one window or door. The enclosure may be at least a portion of a facility. The facility may comprise a building. The enclosure may comprise at least a portion of a building. The building may be a private building and/or a commercial building. The building may comprise one or more floors. The building (e.g., floor thereof) may include at least one of: a room, hall, foyer, attic, basement, balcony (e.g., inner or outer balcony), stairwell, corridor, elevator shaft, façade, mezzanine, penthouse, garage, porch (e.g., enclosed porch), terrace (e.g., enclosed terrace), cafeteria, and/or Duct. In some embodiments, an enclosure may be stationary and/or movable (e.g., a train, an airplane, a ship, a vehicle, or a rocket).

In some embodiments, the enclosure encloses an atmosphere. The atmosphere may comprise one or more gases. The gases may include inert gases (e.g., comprising argon or nitrogen) and/or non-inert gases (e.g., comprising oxygen or carbon dioxide). The enclosure atmosphere may resemble an atmosphere external to the enclosure (e.g., ambient atmosphere) in at least one external atmosphere characteristic that includes: temperature, relative gas content, gas type (e.g., humidity, and/or oxygen level), airborne agents (e.g., pollutants, volatile organic compounds, dust and/or pollen), and/or gas velocity. The enclosure atmosphere may be different from the atmosphere external to the enclosure in at least one external atmosphere characteristic that includes: temperature, relative gas content, gas type (e.g., humidity, and/or oxygen level), airborne agents (e.g., dust and/or pollen), and/or gas velocity. For example, the enclosure atmosphere may be less humid (e.g., drier) than the external (e.g., ambient) atmosphere. For example, the enclosure atmosphere may contain the same (e.g., or a substantially similar) oxygen-to-nitrogen ratio as the atmosphere external to the enclosure. The velocity of the gas in the enclosure may be (e.g., substantially) similar throughout the enclosure. The velocity of the gas in the enclosure may be different in different portions of the enclosure (e.g., by flowing gas through to a vent that is coupled with the enclosure).

Certain disclosed embodiments provide a network infrastructure in the enclosure (e.g., a facility such as a building). The network infrastructure is available for various purposes such as for providing communication and/or power services. The communication services may comprise high bandwidth (e.g., wireless and/or wired) communications services. The communication services can be to occupants of a facility and/or users outside the facility (e.g., building). The network infrastructure may work in concert with, or as a partial replacement of, the infrastructure of one or more cellular carriers. The network infrastructure can be provided in a facility that includes electrically switchable windows. Examples of components of the network infrastructure include a high speed backhaul. The network infrastructure may include at least one cable, switch, physical antenna, transceivers, sensor, transmitter, receiver, radio, processor and/or controller (that may comprise a processor). The network infrastructure may be operatively coupled to, and/or include, a wireless network. The network infrastructure may comprise wiring. One or more sensors can be deployed (e.g., installed) in an environment as part of installing the network and/or after installing the network. The network may be a local network. The network may comprise a cable configured to transmit power and communication in a single cable. The communication can be one or more types of communication. The communication can comprise cellular communication abiding by at least a second generation (2G), third generation (3G), fourth generation (4G) or fifth generation (5G) cellular communication protocol. The communication may comprise media communication facilitating stills, music, or moving picture streams (e.g., movies or videos). The communication may comprise data communication (e.g., sensor data). The communication may comprise control communication, e.g., to control the one or more nodes operatively coupled to the networks. The network may comprise a first (e.g., cabling) network installed in the facility. The network may comprise a (e.g., cabling) network installed in an envelope of the facility (e.g., such as in an envelope of an enclosure of the facility. For example, in an envelope of a building included in the facility).

In another aspect, the present disclosure provides networks that are configured for transmission of any communication (e.g., signal) and/or (e.g., electrical) power facilitating any of the operations disclosed herein. The communication may comprise control communication, cellular communication, media communication, and/or data communication. The data communication may comprise sensor data communication and/or processed data communication. The networks may be configured to abide by one or more protocols facilitating such communication. For example, a communications protocol used by the network (e.g., with a BMS) can comprise a building automation and control networks protocol (BACnet). The network may be configured for (e.g., include hardware facilitating) communication protocols comprising BACnet (e.g., BACnet/SC), LonWorks, Modbus, KNX, European Home Systems Protocol (EHS), BatiBUS, European Installation Bus (EIB or Instabus), zigbee, Z-wave, Insteon, X10, Bluetooth, or WiFi. The network may be configure to transmit the control related protocol. A communication protocol may facilitate cellular communication abiding by at least a 2^{nd}, 3^{rd}, 4^{th}, or 5^{th} generation cellular communication protocol. The (e.g., cabling) network may comprise a tree, line, or star topologies. The network may comprise interworking and/or distributed application models for various tasks of the building automation. The control system may provide schemes for configuration and/or management of resources on the network. The network may permit binding of parts of a distributed application in different nodes operatively coupled to the network. The network may provide a communication system with a message protocol and models for the communication stack in each node (capable of hosting distributed applications (e.g., having a common Kernel). The control system may comprise programmable logic controller(s) (PLC(s)).

In various embodiments, a network infrastructure supports a control system for one or more windows such as tintable (e.g., electrochromic) windows. The control system may comprise one or more controllers operatively coupled (e.g., directly or indirectly) to one or more windows. While the disclosed embodiments describe tintable windows (also referred to herein as “optically switchable windows,” or “smart windows”) such as electrochromic windows, the concepts disclosed herein may apply to other types of switchable optical devices comprising a liquid crystal device, an electrochromic device, suspended particle device (SPD), NanoChromics display (NCD), Organic electroluminescent display (OELD), suspended particle device (SPD), NanoChromics display (NCD), or an Organic electroluminescent display (OELD). The display element may be attached to a part of a transparent body (such as the windows).

The tintable window may be disposed in a (non-transitory) facility such as a building, and/or in a transitory facility (e.g., vehicle) such as a car, RV, bus, train, airplane, helicopter, ship, or boat.

In some embodiments, a tintable window exhibits a (e.g., controllable and/or reversible) change in at least one optical property of the window, e.g., when a stimulus is applied. The change may be a continuous change. A change may be to discrete tint levels (e.g., to at least about 2, 4, 8, 16, or 32 tint levels). The optical property may comprise hue, or transmissivity. The hue may comprise color. The transmissivity may be of one or more wavelengths. The wavelengths may comprise ultraviolet, visible, or infrared wavelengths. The stimulus can include an optical, electrical and/or magnetic stimulus. For example, the stimulus can include an applied voltage and/or current. One or more tintable windows can be used to control lighting and/or glare conditions, e.g., by regulating the transmission of solar energy propagating through them. One or more tintable windows can be used to control a temperature within a building, e.g., by regulating the transmission of solar energy propagating through the window. Control of the solar energy may control heat load imposed on the interior of the facility (e.g., building). The control may be manual and/or automatic. The control may be used for maintaining one or more requested (e.g., environmental) conditions, e.g., occupant comfort, health and/or safety. The control may include reducing energy consumption of a heating, ventilation, air conditioning and/or lighting systems. At least two of heating, ventilation, and air conditioning may be induced by separate systems. At least two of heating, ventilation, and air conditioning may be induced by one system. The heating, ventilation, and air conditioning may be induced by a single system (abbreviated herein as “HVAC”). In some cases, tintable windows may be responsive to (e.g., and communicatively coupled to) one or more environmental sensors and/or user control. Tintable windows may comprise (e.g., may be) electrochromic windows. The windows may be located in the range from the interior to the exterior of a structure (e.g., facility, e.g., building). However, this need not be the case. Tintable windows may operate using liquid crystal devices, suspended particle devices, microelectromechanical systems (MEMS) devices (such as microshutters), or any technology known now, or later developed, that is configured to control light transmission through a window. Windows (e.g., with MEMS devices for tinting) are described in U.S. patent application Ser. No. 14/443,353, filed May 15, 2015, now U.S. Pat. No. 10,359,681, issued Jul. 23, 2019, titled “MULTI-PANE WINDOWS INCLUDING ELECTROCHROMIC DEVICES AND ELECTROMECHANICAL SYSTEMS DEVICES,” which is incorporated herein by reference in its entirety. In some cases, one or more tintable windows can be located within the interior of a building, e.g., between a conference room and a hallway. In some cases, one or more tintable windows can be used in automobiles, trains, aircraft, and other vehicles, e.g., in lieu of a passive and/or non-tinting window.

In some embodiments, the tintable window comprises an electrochromic device (referred to herein as an “EC device” (abbreviated herein as ECD), or “EC”). An EC device may comprise at least one coating that includes at least one layer. The at least one layer can comprise an electrochromic material. In some embodiments, the electrochromic material exhibits a change from one optical state to another, e.g., when an electric potential is applied across the EC device. The transition of the electrochromic layer from one optical state to another optical state can be caused, e.g., by reversible, semi-reversible, or irreversible ion insertion into the electrochromic material (e.g., by way of intercalation) and a corresponding injection of charge-balancing electrons. For example, the transition of the electrochromic layer from one optical state to another optical state can be caused, e.g., by a reversible ion insertion into the electrochromic material (e.g., by way of intercalation) and a corresponding injection of charge-balancing electrons. Reversible may be for the expected lifetime of the ECD. Semi-reversible refers to a measurable (e.g. noticeable) degradation in the reversibility of the tint of the window over one or more tinting cycles. In some instances, a fraction of the ions responsible for the optical transition is irreversibly bound up in the electrochromic material (e.g., and thus the induced (altered) tint state of the window is not reversible to its original tinting state). In various EC devices, at least some (e.g., all) of the irreversibly bound ions can be used to compensate for “blind charge” in the material (e.g., ECD).

In some implementations, suitable ions include cations. The cations may include lithium ions (Li+) and/or hydrogen ions (H+) (i.e., protons). In some implementations, other ions can be suitable. Intercalation of the cations may be into an (e.g., metal) oxide. A change in the intercalation state of the ions (e.g., cations) into the oxide may induce a visible change in a tint (e.g., color) of the oxide. For example, the oxide may transition from a colorless to a colored state. For example, intercalation of lithium ions into tungsten oxide (WO3-y (0<y≤˜0.3)) may cause the tungsten oxide to change from a transparent state to a colored (e.g., blue) state. EC device coatings as described herein are located within the viewable portion of the tintable window such that the tinting of the EC device coating can be used to control the optical state of the tintable window.

In some embodiments, systems, methods, and apparatuses are configured for accepting, processing, distributing, and/or displaying in facility (e.g., in-building) localized wireless emergency alert (WEA) messages. In an example, an apparatus may include a processor and a memory coupled with the processor that effectuates operations.

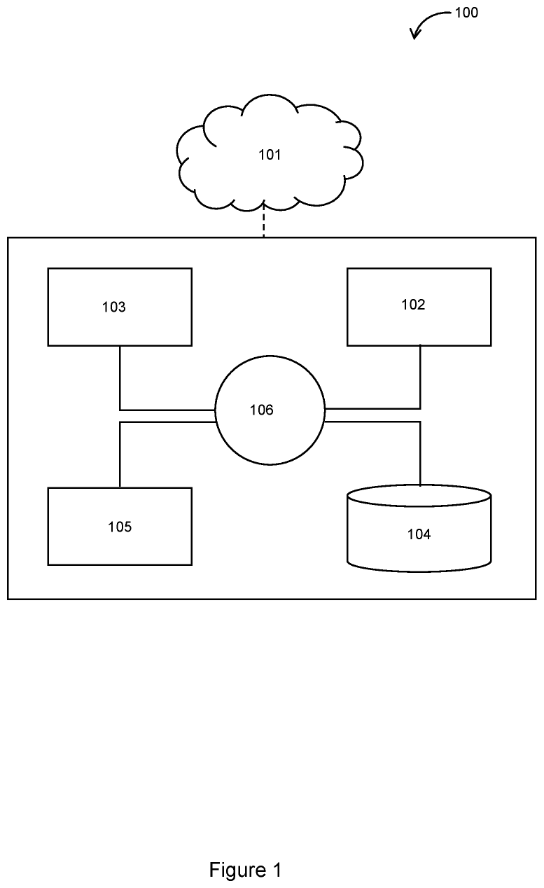

FIG. 1 shows a schematic example of a computer system 100 that is programmed or otherwise configured to perform one or more operations of any of the methods provided herein. The computer system can control (e.g., direct, monitor, and/or regulate) various features of the methods, apparatuses and systems of the present disclosure, such as, for example, control heating, cooling, lightening, and/or venting of an enclosure, or any combination thereof. The computer system can be part of, or be in communication with, any sensor or device ensemble disclosed herein. The computer may be coupled to one or more mechanisms disclosed herein, and/or any parts thereof. For example, the computer may be coupled to one or more sensors, valves, switches, lights, windows (e.g., IGUs), motors, pumps, optical components, or any combination thereof.

The computer system can include a processing unit (e.g., 106) (referred to herein as “processor”). A computer may comprise a processing unit. The computer system may include memory or memory location (e.g., 102) (e.g., random-access memory, read-only memory, flash memory), electronic storage unit (e.g., 104) (e.g., hard disk), communication interface (e.g., 103) (e.g., network adapter) for communicating with one or more other systems, and peripheral devices (e.g., 105), such as cache, other memory, data storage and/or electronic display adapters. In the example shown in FIG. 1, the memory 102, storage unit 104, interface 103, and peripheral devices 105 are in communication with the processing unit 106 through a communication bus (solid lines), such as a motherboard. The storage unit can be a data storage unit (or data repository) for storing data. The computer system can be operatively coupled to a computer network (“network”) (e.g., 101), e.g., with the aid of the communication interface. The network can comprise (i) the Internet, (ii) an internet and/or extranet, or (iii) an intranet and/or extranet that is in communication with the Internet. In some cases, the network is a telecommunication and/or data network. The network can include one or more computer servers, which can enable distributed computing, such as cloud computing. The network, in some cases with the aid of the computer system, can implement a peer-to-peer network, which may enable devices coupled to the computer system to behave as a client or a server.

The processing unit can execute a sequence of machine-readable instructions, which can be embodied in a program or software. The instructions may be stored in a memory location, such as the memory 102. The instructions can be directed to the processing unit, which can subsequently program or otherwise configure the processing unit to implement methods of the present disclosure. Examples of operations performed by the processing unit can include fetch, decode, execute, and write back. The processing unit may interpret and/or execute instructions. The processor may include a microprocessor, a data processor, a central processing unit (CPU), a graphical processing unit (GPU), a system-on-chip (SOC), a co-processor, a network processor, an application specific integrated circuit (ASIC), an application specific instruction-set processor (ASIPs), a controller, a programmable logic device (PLD), a chipset, a field programmable gate array (FPGA), or any combination thereof. The processing unit can be part of a circuit, such as an integrated circuit. One or more other components of the system 100 can be included in the circuit.

The storage unit can store files, such as drivers, libraries and saved programs. The storage unit can store user data (e.g., user preferences and user programs). In some cases, the computer system can include one or more additional data storage units that are external to the computer system, such as located on a remote server that is in communication with the computer system through an intranet or the Internet.

The computer system can communicate with one or more remote computer systems through a network. For instance, the computer system can communicate with a remote computer system of a user (e.g., operator). Examples of remote computer systems include personal computers (e.g., portable PC), slate or tablet PC's (e.g., Apple® iPad, Samsung® Galaxy Tab), telephones, Smart phones (e.g., Apple® iphone, Android-enabled device, Blackberry®), or personal digital assistants. A user (e.g., client) can access the computer system via the network.

Methods as described herein can be implemented by way of machine (e.g., computer processor) executable code stored on an electronic storage location of the computer system, such as, for example, on the memory 102 or electronic storage unit 104. The machine executable or machine-readable code can be provided in the form of software. During use, the processor 106 can execute the code. In some cases, the code can be retrieved from the storage unit and stored on the memory for ready access by the processor. In some situations, the electronic storage unit can be precluded, and machine-executable instructions are stored on memory.

The code can be pre-compiled and configured for use with a machine have a processer adapted to execute the code or can be compiled during runtime. The code can be supplied in a programming language that can be selected to enable the code to execute in a pre-compiled or as-compiled fashion.

In some embodiments, the processor comprises a code. The code can be program instructions. The program instructions may cause the at least one processor (e.g., computer) to direct a feed forward and/or feedback control loop. In some embodiments, the program instructions cause the at least one processor to direct a closed loop and/or open loop control scheme. The control may be based at least in part on one or more sensor readings (e.g., sensor data). One controller may direct a plurality of operations. At least two operations may be directed by different controllers. In some embodiments, a different controller may direct at least two of operations (a), (b) and (c). In some embodiments, different controllers may direct at least two of operations (a), (b) and (c). In some embodiments, a non-transitory computer-readable medium cause each a different computer to direct at least two of operations (a), (b) and (c). In some embodiments, different non-transitory computer-readable mediums cause each a different computer to direct at least two of operations (a), (b) and (c). The controller and/or computer readable media may direct any of the apparatuses or components thereof disclosed herein. The controller and/or computer readable media may direct any operations of the methods disclosed herein.

In some embodiments, the at least one sensor is operatively coupled to a control system (e.g., computer control system). The sensor may comprise light sensor, acoustic sensor, vibration sensor, chemical sensor, electrical sensor, magnetic sensor, fluidity sensor, movement sensor, speed sensor, position sensor, pressure sensor, force sensor, density sensor, distance sensor, or proximity sensor. The sensor may include temperature sensor, weight sensor, material (e.g., powder) level sensor, metrology sensor, gas sensor, or humidity sensor. The metrology sensor may comprise measurement sensor (e.g., height, length, width, angle, and/or volume). The metrology sensor may comprise a magnetic, acceleration, orientation, or optical sensor. The sensor may transmit and/or receive sound (e.g., echo), magnetic, electronic, or electromagnetic signal. The signal may comprise radio signal. The radio signal may comprise ultra-wide band radio signals. The signal may comprise visible, infrared, or ultraviolet light. The infrared sensor may detect animate objects (e.g., people). The signal may comprise an audio signal (e.g., human audio signal). The electromagnetic signal may comprise a visible, infrared, ultraviolet, ultrasound, radio wave, or microwave signal. The gas sensor may sense any of the gas delineated herein. The distance sensor can be a type of metrology sensor. The distance sensor may comprise an optical sensor, or capacitance sensor. The temperature sensor can comprise Bolometer, Bimetallic strip, calorimeter, Exhaust gas temperature gauge, Flame detection, Gardon gauge, Golay cell, Heat flux sensor, Infrared thermometer, Microbolometer, Microwave radiometer, Net radiometer, Quartz thermometer, Resistance temperature detector, Resistance thermometer, Silicon band gap temperature sensor, Special sensor microwave/imager, Temperature gauge, Thermistor, Thermocouple, Thermometer (e.g., resistance thermometer), or Pyrometer. The temperature sensor may comprise an optical sensor. The temperature sensor may comprise image processing. The temperature sensor may comprise a camera (e.g., IR camera, visible light camera, and/or CCD camera). The camera can be a high resolution camera (e.g., the resolution can be of at least 2 Kilo Pixel (K), 3K, 4K, or 5K camera). The sensor may comprise an accelerometer. The sensor may sense location and/or presence of people. The sensor may sense and/or locate enclosure occupants. The pressure sensor may comprise Barograph, Barometer, Boost gauge, Bourdon gauge, Hot filament ionization gauge, Ionization gauge, McLeod gauge, Oscillating U-tube, Permanent Downhole Gauge, Piezometer, Pirani gauge, Pressure sensor, Pressure gauge, Tactile sensor, or Time pressure gauge. The position sensor may comprise Auxanometer, Capacitive displacement sensor, Capacitive sensing, Free fall sensor, Gravimeter, Gyroscopic sensor, Impact sensor, Inclinometer, Integrated circuit piezoelectric sensor, Laser rangefinder, Laser surface velocimeter, LIDAR, Linear encoder, Linear variable differential transformer (LVDT), Liquid capacitive inclinometers, Odometer, Photoelectric sensor, Piezoelectric accelerometer, Rate sensor, Rotary encoder, Rotary variable differential transformer, Selsyn, Shock detector, Shock data logger, Tilt sensor, Tachometer, Ultrasonic thickness gauge, Variable reluctance sensor, or Velocity receiver. The optical sensor may comprise a Charge-coupled device, Colorimeter, Contact image sensor, Electro-optical sensor, Infra-red sensor, Kinetic inductance detector, light emitting diode (e.g., light sensor), Light-addressable potentiometric sensor, Nichols radiometer, Fiber optic sensor, Optical position sensor, Photo detector, Photodiode, Photomultiplier tubes, Phototransistor, Photoelectric sensor, Photoionization detector, Photomultiplier, Photo resistor, Photo switch, Phototube, Scintillometer, Shack-Hartmann, Single-photon avalanche diode, Superconducting nanowire single-photon detector, Transition edge sensor, Visible light photon counter, or Wave front sensor. The one or more sensors may be connected to a control system (e.g., to a processor, to a computer).

In some embodiments, a plurality of devices may be operatively (e.g., communicatively) coupled to the control system. The plurality of devices may be disposed in a facility (e.g., including a building and/or room). The control system may comprise the hierarchy of controllers. The devices may comprise an emitter, a sensor, or a window (e.g., IGU). The devices may compromise a radio emitter and/or receiver (e.g., a wide band, or ultra-wide band radio emitter and/or receiver). The device may include a locating device. The devices may include a Global Positioning System (GPS) device. The devices may include a Bluetooth device. The device may be any device as disclosed herein. At least two of the plurality of devices may be of the same type. For example, two or more IGUs may be coupled to the control system. At least two of the plurality of devices may be of different types. For example, a sensor and an emitter may be coupled to the control system. At times the plurality of devices may comprise at least 20, 50, 100, 500, 1000, 2500, 5000, 7500, 10000, 50000, 100000, or 500000 devices. The plurality of devices may be of any number between the aforementioned numbers (e.g., from 20 devices to 500000 devices, from 20 devices to 50 devices, from 50 devices to 500 devices, from 500 devices to 2500 devices, from 1000 devices to 5000 devices, from 5000 devices to 10000 devices, from 10000 devices to 100000 devices, or from 100000 devices to 500000 devices). For example, the number of windows in a floor may be at least 5, 10, 15, 20, 25, 30, 40, or 50. The number of windows in a floor can be any number between the aforementioned numbers (e.g., from 5 to 50, from 5 to 25, or from 25 to 50). At times the devices may be in a multi-story building. At least a portion of the floors of the multi-story building may have devices controlled by the control system (e.g., at least a portion of the floors of the multi-story building may be controlled by the control system). For example, the multi-story building may have at least 2, 8, 10, 25, 50, 80, 100, 120, 140, or 160 floors that are controlled by the control system. The number of floors (e.g., devices therein) controlled by the control system may be any number between the aforementioned numbers (e.g., from 2 to 50, from 25 to 100, or from 80 to 160). The floor may be of an area of at least about 150 m², 250 m², 500 m², 1000 m², 1500 m², or 2000 square meters (m²). The floor may have an area between any of the aforementioned floor area values (e.g., from about 150 m² to about 2000 m², from about 150 m² to about 500 m², from about 250 m² to about 1000 m², or from about 1000 m² to about 2000 m²). The building may comprise an area of at least about 1000 square feet (sqft), 2000 sqft, 5000 sqft, 10000 sqft, 100000 sqft, 150000 sqft, 200000 sqft, or 500000 sqft. The building may comprise an area between any of the above mentioned areas (e.g., from about 1000 sqft to about 5000 sqft, from about 5000 sqft to about 500000 sqft, or from about 1000 sqft to about 500000 sqft). The building may comprise an area of at least about 100 m², 200 m², 500 m², 1000 m², 5000 m², 10000 m², 25000 m², or 50000 m². The building may comprise an area between any of the above mentioned areas (e.g., from about 100 m² to about 1000 m², from about 500 m² to about 25000 m², from about 100 m² to about 50000 m²). The facility may comprise a commercial or a residential building. The commercial building may include tenant(s) and/or owner(s). The residential facility may comprise a multi or a single family building. The residential facility may comprise an apartment complex. The residential facility may comprise a single family home. The residential facility may comprise multifamily homes (e.g., apartments). The residential facility may comprise townhouses. The facility may comprise residential and commercial portions. The facility may comprise at least about 1, 2, 5, 10, 50, 100, 150, 200, 250, 300, 350, 400, 420, 450, 500, or 550 windows (e.g., tintable windows). The windows may be divided into zones (e.g., based at least in part on the location, façade, floor, ownership, utilization of the enclosure (e.g., room) in which they are disposed, any other assignment metric, random assignment, or any combination thereof. Allocation of windows to the zone may be static or dynamic (e.g., based on a heuristic). There may be at least about 2, 5, 10, 12, 15, 30, 40, or 46 windows per zone.

In some embodiments, the sensor(s) are operatively coupled to at least one controller and/or processor. Sensor readings may be obtained by one or more processors and/or controllers. A controller may comprise a processing unit (e.g., CPU or GPU). A controller may receive an input (e.g., from at least one sensor). The controller may include circuitry, electrical wiring, optical wiring, socket, and/or outlet. A controller may deliver an output. A controller may comprise multiple (e.g., sub-) controllers. The controller may be a part of a control system. A control system may comprise a master controller, floor (e.g., comprising network controller) controller, or a local controller. The local controller may be a window controller (e.g., controlling an optically switchable window), enclosure controller, or component controller. The controller can be a device controller (e.g., any device disclosed herein). For example, a controller may be a part of a hierarchal control system (e.g., comprising a main controller that directs one or more controllers, e.g., floor controllers, local controllers (e.g., window controllers), enclosure controllers, and/or component controllers). A physical location of the controller type in the hierarchal control system may be changing. For example: At a first time: a first processor may assume a role of a main controller, a second processor may assume a role of a floor controller, and a third processor may assume the role of a local controller. At a second time: the second processor may assume a role of a main controller, the first processor may assume a role of a floor controller, and the third processor may remain with the role of a local controller. At a third time: the third processor may assume a role of a main controller, the second processor may assume a role of a floor controller, and the first processor may assume the role of a local controller. A controller may control one or more devices (e.g., be directly coupled to the devices). A controller may be disposed proximal to the one or more devices it is controlling. For example, a controller may control an optically switchable device (e.g., IGU), an antenna, a sensor, and/or an output device (e.g., a light source, sounds source, smell source, gas source, HVAC outlet, or heater).

In one embodiment, a floor controller may direct one or more window controllers, one or more enclosure controllers, one or more component controllers, or any combination thereof. The floor controller may comprise a floor controller. For example, the floor (e.g., comprising network) controller may control a plurality of local (e.g., comprising window) controllers. A plurality of local controllers may be disposed in a portion of a facility (e.g., in a portion of a building). The portion of the facility may be a floor of a facility. For example, a floor controller may be assigned to a floor. In some embodiments, a floor may comprise a plurality of floor controllers, e.g., depending on the floor size and/or the number of local controllers coupled to the floor controller. For example, a floor controller may be assigned to a portion of a floor. For example, a floor controller may be assigned to a portion of the local controllers disposed in the facility. For example, a floor controller may be assigned to a portion of the floors of a facility.

A master controller may be coupled to one or more floor controllers. The floor controller may be disposed in the facility. The master controller may be disposed in the facility, or external to the facility. The master controller may be disposed in the cloud. A controller may be a part of, or be operatively coupled to, a building management system. A controller may receive one or more inputs. A controller may generate one or more outputs. The controller may be a single input single output controller (SISO) or a multiple input multiple output controller (MIMO). A controller may interpret an input signal received. A controller may acquire data from the one or more components (e.g., sensors). Acquire may comprise receive or extract. The data may comprise measurement, estimation, determination, generation, or any combination thereof. A controller may comprise feedback control. A controller may comprise feed-forward control. Control may comprise on-off control, proportional control, proportional-integral (PI) control, or proportional-integral-derivative (PID) control. Control may comprise open loop control, or closed loop control. A controller may comprise closed loop control. A controller may comprise open loop control. A controller may comprise a user interface. A user interface may comprise (or operatively coupled to) a keyboard, keypad, mouse, touch screen, microphone, speech recognition package, camera, imaging system, or any combination thereof. Outputs may include a display (e.g., screen), speaker, or printer.

In some embodiments, systems, methods, and apparatuses are configured for accepting, processing, distributing, and/or displaying in facility (e.g., in-building) localized wireless emergency alert (WEA) messages. In an example, a facility such as a building may be served by 4G LTE and/or 5G New Radio (NR) wireless cellular network. When an alarm (e.g., a fire alarm) is detected, an in-building wireless emergency alert gateway generates an alert message for each target cell of the wireless cellular network. The wireless cellular network can create a standard message (e.g., a Write Replace Warning Request). The standard message may be delivered to one or more base stations of the wireless cellular network. The wireless emergency alert may be transmitted by the one or more base stations and delivered to one or more UEs in the building.

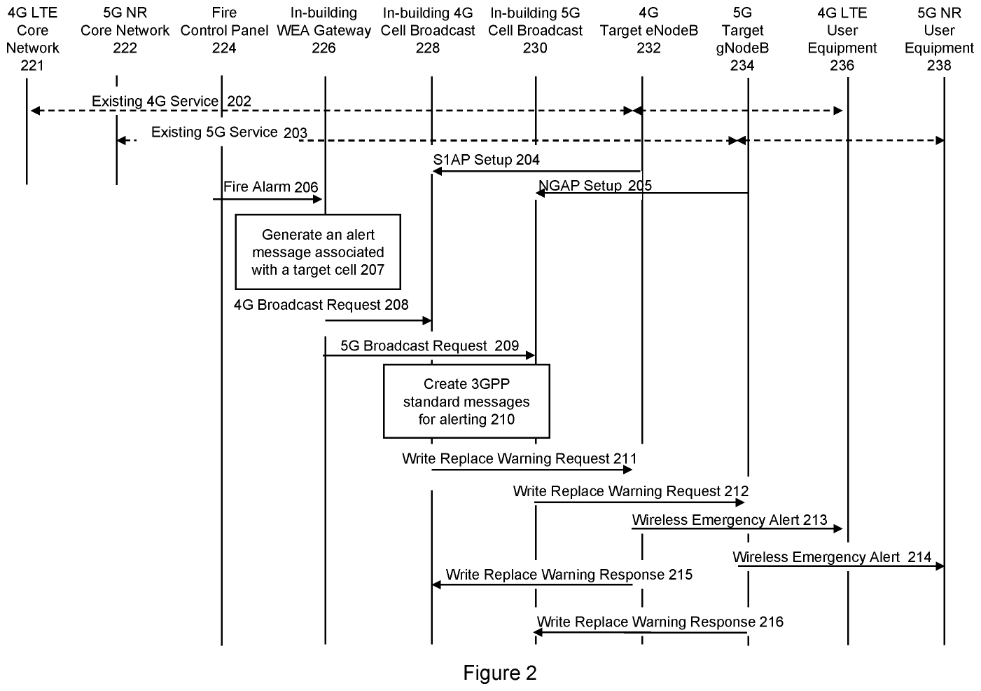

FIG. 2 shows an example of a flow diagram for processing wireless emergency alert messages. A facility such as a building is served by a 4G LTE core network 221 and/or a 5G NR core network 222. The 4G LTE core network 221 provides existing 4G service 202 to a 4G target eNodeB 232 and a 4G LTE UE 236. The 5G NR core network 222 provides existing 5G service to a 5G target gNodeB 234 and a 5G NR UE 238. The 4G target eNode B 232 is configured to have an S1AP setup 204 with in-building 4G Cell Broadcast 228. The 5G target gNodeB 234 is configured to have an NGAP setup 205 with in-building 5G Cell Broadcast 230. When a fire alarm is detected at a fire control panel 224, an in-facility wireless emergency alert (WEA) gateway 226 generates an alert message associated with a target cell (block 207). If the target cell is in the 4G LTE core network 221, a 4G Broadcast Request 208 is delivered to the in-building 4G Cell Broadcast 228. If the target cell is in the 5G NR core network 222, a 5G Broadcast Request 209 is delivered to the in-building 5G Cell Broadcast 230. At block 210, a standard 3GPP message can be generated. For example, in the case of the 4G LTE core network 221, the in-facility 4G Cell Broadcast 228 generates a Write Replace Warning Request 211. In the case of the 5G NR core network 222, the in-facility 5G Cell Broadcast 230 generates a Write Replace Warning Request 212. The Write Replace Warning Request 211 is delivered to the 4G target eNodeB 232. The Write Replace Warning Request 212 is delivered to the 5G target gNodeB 234. The 4G target eNodeB 232 delivers a wireless emergency alert 213 to the 4G LTE UE 236. The 5G target gNodeB 234 delivers a wireless emergency alert 214 to the 5G NR UE 238. When the 4G LTE UE 236 receives the wireless emergency alert 213, a Write Replace Warning Response 215 is sent back to the in-building 4G Cell Broadcast 228. When the 5G NR UE 238 receives the wireless emergency alert 214, a Write Replace Warning Response 216 is sent back to the in-building 5G Cell Broadcast 230.

In some embodiments, in-facility (e.g., in-building) wireless emergency alert messages are provided in response to a fire alarm. A building safety system can have one or more fire control panels. An alarm event can be delivered to an in-building wireless emergency alert (WEA) gateway when a fire has been detected. The WEA gateway may be equipped with an external network interface that operates over a communications network (e.g., the Internet). Once a fire alarm is detected, the in-facility WEA gateway can generate an alert message for one or more target locations. The alert message may be sent over the communications network and delivered to a cellular network. The cellular network can use the alert message to generate a 3GPP-compliant WEA message that is transmitted over the air. The WEA message can be received by one or more UEs in the building.

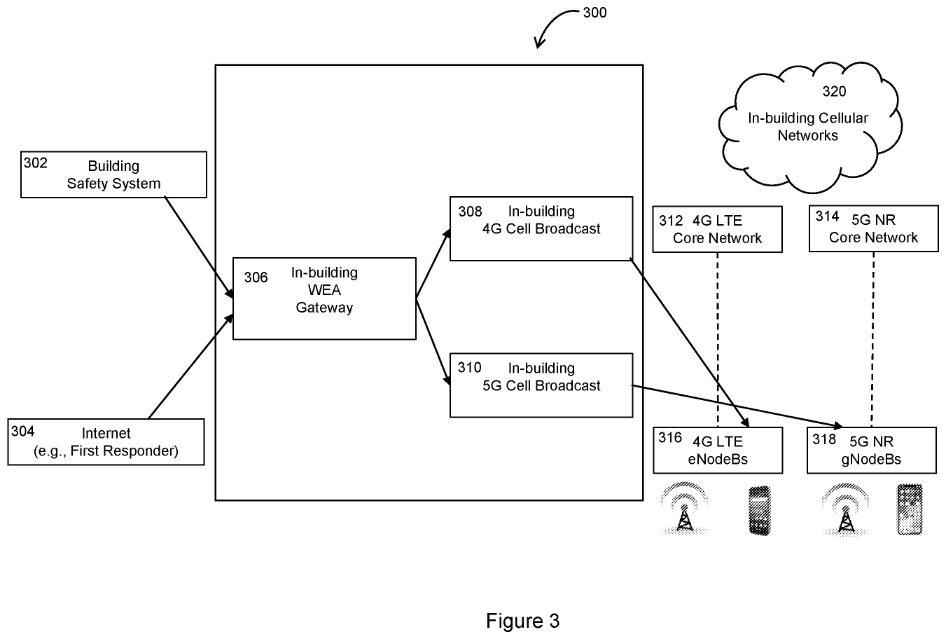

FIG. 3 schematically shows an example of an in-facility (e.g., in-building) wireless emergency alert system 300 for processing emergency alarms that can include fire alarms. An example topology diagram for the wireless emergency alert system 300 includes an in-facility WEA Gateway 306 operatively coupled to an in-facility 4G Cell Broadcast 308 and In-facility 5G Cell Broadcast 310. A facility safety system 302 may have multiple fire control panels. The facility safety system 302 is configured to deliver an alarm notification to the In-facility WEA Gateway 306 whenever a fire has been detected. To support further integration with the nationwide Integrated Public Alert & Warning System (IPAWS) framework operated by the Federal Emergency Management Agency (FEMA), the in-facility WEA gateway 306 has an external network interface connected to Internet 304. The external network interface connected to the Internet 304 can be configured to receive an alarm notification initiated by a First Responder. In some embodiments, this alarm notification can be initiated at a location that is remote from the facility. Once an alarm notification is received at the In-facility WEA gateway 306, the in-facility WEA gateway 306 generates an alert message for each target location. These alert messages is delivered to the in-facility 4G Cell Broadcast 308, and/or the on-facility 5G Cell Broadcast 310. Then, the on-facility 4G Cell Broadcast 308 creates a 3GPP standard-compliant message incorporating a WEA message, and sends the standard-compliant message to an in-facility Cellular Network 320. The in-facility Cellular Network 320 includes a 4G LTE eNodeB 316. The 4G LTE eNodeB 316, controlled by a 4G LTE Core Network 312, initiates an over-the-air transmission of the WEA message. The In-facility 5G Cell Broadcast 310 may create a 3GPP standard-compliant message incorporating a WEA message, and send this standard-compliant message to the In-facility Cellular Network 320. The in-facility Cellular Network 320 includes a 5G LTE gNodeB 318. The 5G LTE gNodeB 318, controlled by a 5G NR Core Network 314, initiates an over-the-air transmission of the WEA message. In some embodiments, the 4G LTE eNodeB 316 establishes an S1AP connection to the in-facility 4G Cell Broadcast 308. The 5G gNodeB 318 establishes an NGAP connection to the In-facility 5G Cell Broadcast 310.

In some embodiments, the alarm notification may specify a type and/or category of alarm (e.g., a fire alarm). In some embodiments, the alarm notification may include location information (e.g., a source tag from the fire control panel) for an emergency event. This source location information may be (e.g., parsed and) translated it into a location-descriptive text. A different text for each section and floor of the facility may be generated, such that a different section may have a different alert text according to the facility's evacuation plan. A set of destination cells can be determined for each alert text, with the results stored in a memory or a queue. An alert can be retrieved from the memory or queue, and then broadcast to one or more target cells.

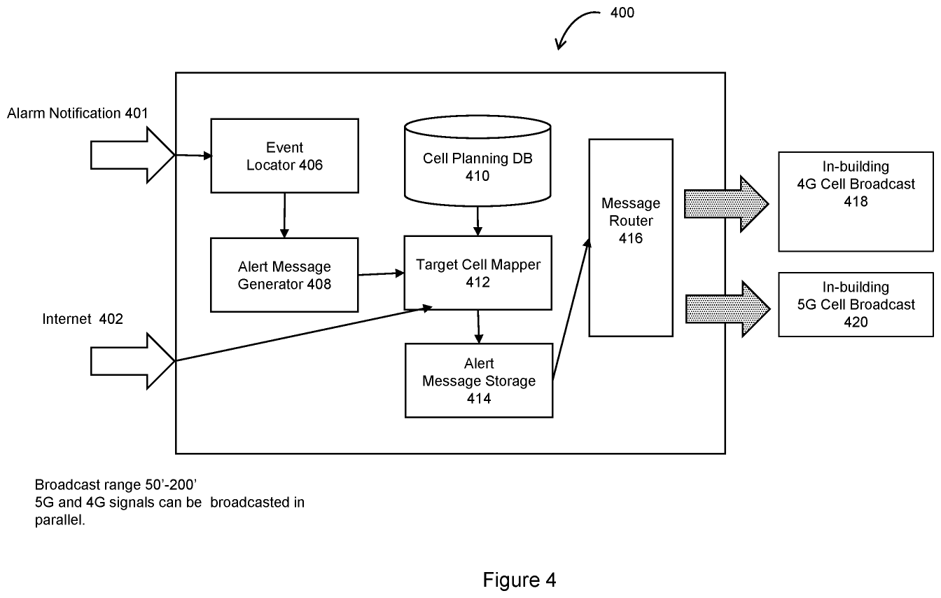

FIG. 4 schematically shows an example of an in-facility wireless emergency alert gateway 400. An alarm notification 401 specifies a type of alarm (e.g., a fire), as well as location information (e.g., a source tag from a fire control panel) for the alarm notification. An Event Locator 406 parses the source location information and translate it into a descriptive text (e.g., “at northeast corner, section 1, 3rd floor”). The Event Locator 406 is operatively coupled to an Alert Message Generator 408. The Alert Message Generator 408 automatically generates a text for a plurality of sections (e.g., for each section) of the facility, e.g., according to zone designation of the sections of the facility and/or according to the facility's evacuation plan. At least two of the sections may have a different alert text, e.g., according to the facility's evacuation plan. At least two of the sections may have the same alert text, e.g., according to the facility's evacuation plan. For example, the Alert Message Generator can generate a text for a plurality of floors of a building. The Alert Message Generator 408 is operatively coupled to a Target Cell Mapper 412. The Target Cell Mapper 412 is configured to retrieve knowledge of an entire cellular network plan from a Cell Planning Database (DB) 410. Because the Target Cell Mapper 412 is in position of the entire cellular network plan in the facility (e.g., as stored in the Cell Planning DB 410), the Target Cell Mapper 412 is able to determine a set of destination cells for each alert text, and store the results in a FIFO queue of an Alert Message Storage 414. By retrieving an alert from the Alert Message Storage 414, a Message Router 416 delivers the alert to an in-facility 4G Cell Broadcast 418 for 4G target cells, and/or deliver the alert to an in-facility 5G Cell Broadcast 420 for 5G target cells (e.g., respectively). An alarm notification is received by the Target Cell Mapper 412 through Internet 402 as an optional network interface to support further integration with an external emergency alerting system.

According to some embodiments, an in-facility 4G cell broadcast may be implemented by exchanging one or more messages between an in-facility gateway and a 4G LTE base station (e.g., an eNodeB). These messages can be defined by a standardization body such as 3GPP. One example of such a message is a “Write Replace Warning Request.” Target destination cells may be identified through the use of tracking area identifiers (TAIs), where each TAI identifies a corresponding destination cell on a 4G wireless communications network.

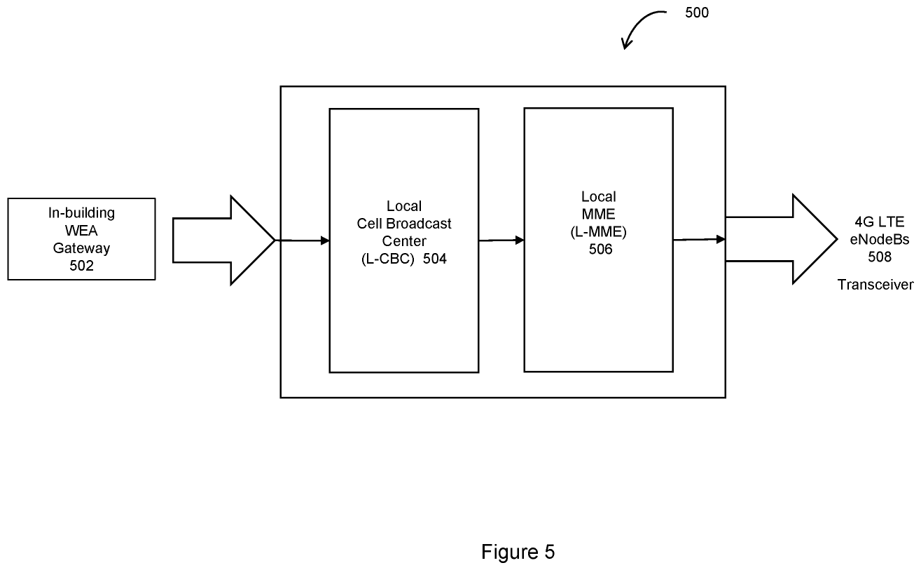

FIG. 5 schematically shows an example of an in-facility 4G cell broadcast. An alert text transmission request from an in-facility WEA Gateway 502 is delivered to a Local Cell Broadcast Center (L-CBC) 504 for a 4G network 500. The following message exchanges between the L-CBC 504, a Local Mobility Management Entity (L-MME) 506, and a set of 4G eNodeBs 508 follows a 3GPP specification (e.g., 3GPP TS 23.041). The L-CBC 504 generates a ‘Write-Replace Warning Request’ message. The L-CBC 504 sends this message to the L-MME 506. During (e.g., contemporaneously with) the generation of the ‘Write Replace Warning Request’ message, the L-CBC 504 finds an LTE Tracking Area ID (TAI) associated with a destination target cell. According to the 3GPP specification, standard messages carries TAI values (e.g., rather than cell identifiers). However, the manner in which a TAI is assigned to a specific cell or eNodeB is not mandated by the 4G standard, and this detail can be freely planned and assigned to a cell during installation and/or planning of the 4G network 500. According to some embodiments, TAIs can be defined such that a unique TAI exists for each cell, and this unique TAI can be retrieved by the L-CBC 504. After receiving the ‘Write Replace Warning Request’, the L-MME 506 sends a ‘Write Replace Warning Confirm’ message that indicates to the L-CBC 504 that the L-MME 506 has started to distribute the alert message to the set of 4G LTE eNodeBs 508. The L-MME 506 forwards the ‘Write-Replace Warning Request’ to the set of 4G LTE eNodeBs 508. The L-MME 506 uses the TAI list to determine the identities of one or more eNodeBs serving the delivery area.

According to some embodiments, an in-facility 5G cell broadcast function is implemented by exchanging one or more messages between an in-facility gateway and a 5G NR base station (e.g., a gNodeB). These messages can be defined by a standardization body such as 3GPP. One example of such a message is a “Write Replace Warning Request.” Target destination cells may be identified through the use of tracking area identifiers (TAIs), where each TAI identifies a corresponding destination cell on a 5G wireless communications network.

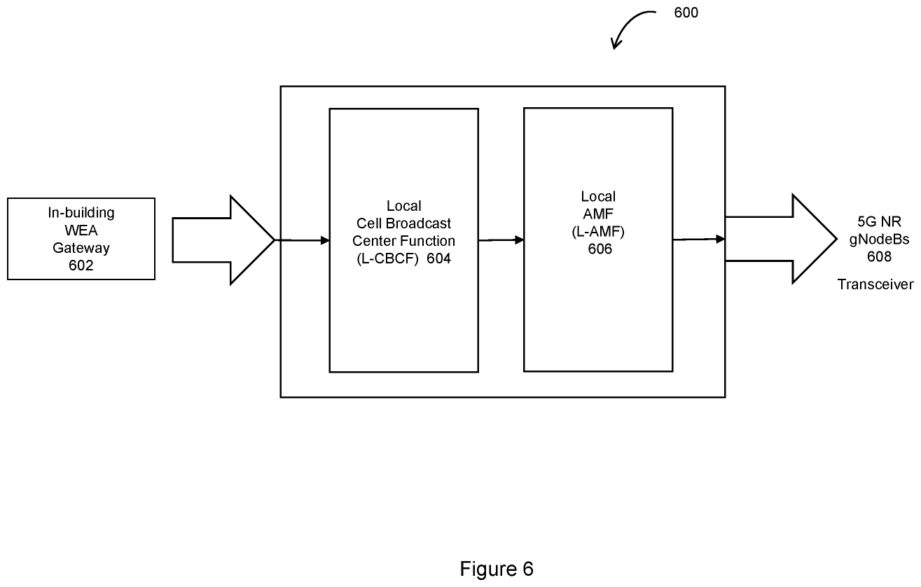

FIG. 6 schematically shows an example of an in-facility 5G cell broadcast. An alert text transmission request is received at an in-facility WEA Gateway 602. The alert text transmission request is delivered to a Local Cell Broadcast Center Function (L-CBCF) 604 for a 5G network 600. The following message exchanges takes place between the L-CBCF 604, a local access and mobility management function (L-AMF) 606, and a set of 5G NR gNodeBs 608. The set of 5G NR gNodeBs 608 are configured to follow the 3GPP TS 23.041 specification. The L-CBCF 604 creates a ‘Write-Replace Warning Request NG-RAN’ message and send it to the L-AMF) 606. During (e.g., contemporaneously with) the creation of the ‘Write Replace Warning Request NG-RAN’ message, the L-CBCF 604 finds a 5G Tracking Area ID (TAI) associated with a destination target cell. The TAIs are configured for retrieval by the L-CBCF 604. After receiving the ‘Write Replace Warning Request NG-RAN’, the L-AMF 606 sends a ‘Write Replace Warning Confirm NG-RAN’ message to the L-CBCF 604. The “Write Replace Warning Confirm NG-RAN” message indicates to the L-CBCF 604 that the L-AMF 606 has started to distribute the alert message to the set of 5G NR gNodeBs 608. The L-AMF 606 forwards ‘Write-Replace Warning Request’ to the set of gNodeBs 608. The L-AMF 606 uses the TAI list to determine which specific gNodeBs in the set of gNodeBs 608 serve the delivery area.

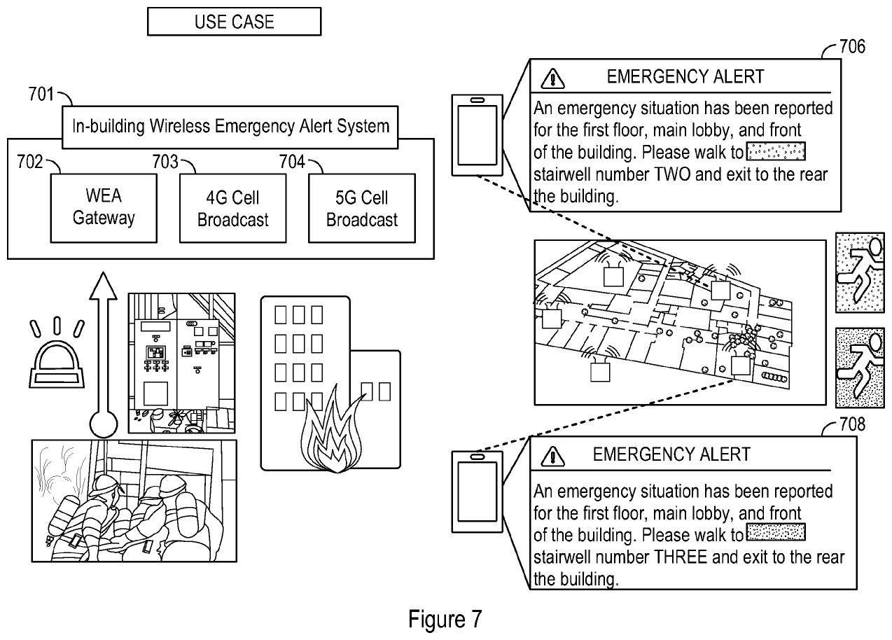

FIG. 7 schematically illustrates an example of a use case for processing alert messages. An in-facility Wireless Emergency Alert System 701 includes a WEA gateway 702, a 4G Cell Broadcast 703 function, and a 5G Cell Broadcast 704 function. A fire starts burning inside the facility (e.g., comprising a building). The fire causes a temperature rise which can be detected by one or more sensors operatively coupled to the in-facility Wireless Emergency Alert System 701. The sensed temperature rise may be of a sufficient magnitude so as to trigger an alarm event. In that event, the in-facility Wireless Emergency Alert System 701 triggers a first Emergency Alert 706 to be sent to any UEs within a first emergency incident area (e.g., a first set of rooms and corridors in the building of the facility). The In-facility Wireless Emergency Alert System 701 triggers a second Emergency Alert 708 to be sent to any UEs within a second emergency incident area (e.g., a second set of rooms and corridors in the building of the facility). The first and second Emergency Alerts 706, 708 can each be each provided in the form of a message (e.g., a vocal message, and/or a visible message such as a text message). The message of the first Emergency Alert 706 may state that an emergency situation has been reported for enumerated facility sections (e.g., “An emergency situation has been reported to the first floor, main lobby, and front of the building”). The message may include action directions for personnel. For example the message may state “Please walk to Stairwell Number TWO and exit to the rear of the building.” The message of the second Emergency Alert 708 may state a different direction. For example, the message of the second Emergency Alert may state “An emergency situation has been reported for the first floor, main lobby, and front of the building. Please walk to Stairwell Number THREE and exit to the rear of the building.” Accordingly, the contents of the emergency alert message may be customized for each of a plurality of emergency incident areas of a facility and/or actions steps to be followed in relation to the facility (e.g., for personnel in the facility, or personnel adjacent to the facility such as those reasonably affected by the emergency event).

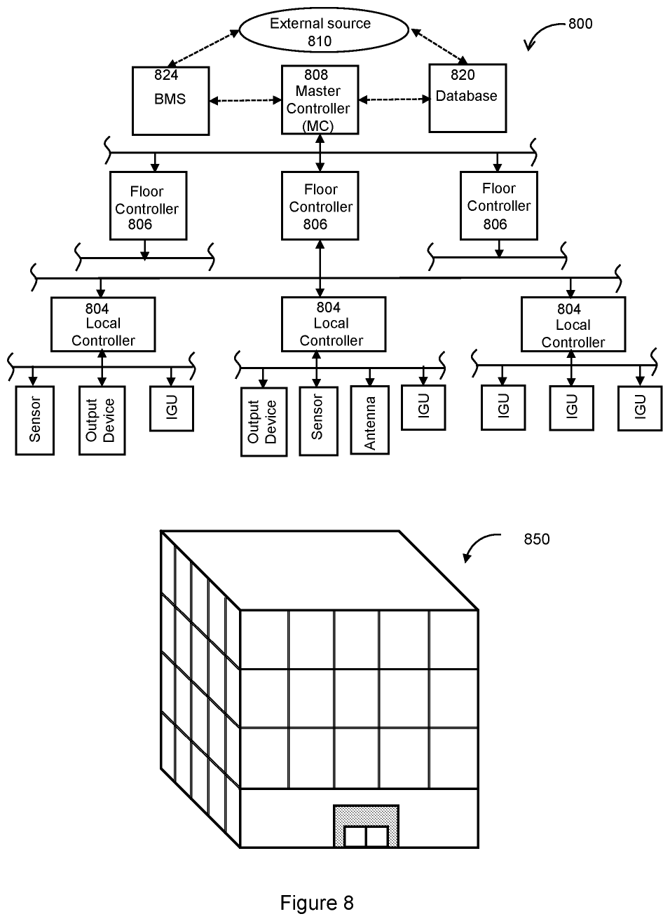

FIG. 8 shows a schematic example of a control system architecture 800 comprising three hierarchical levels that include a master controller 808 that controls floor controllers 806, that in turn control local controllers 804 that in turn control various devices. In some embodiments, a local controller controls one or more IGUs, one or more sensors, one or more output devices (e.g., one or more emitters), or any combination thereof. In the illustrative configuration of FIG. 8, the master controller is operatively coupled (e.g., communicatively coupled wirelessly and/or wired) to a building management system (BMS) 824 and to a database 820. Arrows in FIG. 8 represents communication pathways. A controller may be operatively coupled (e.g., directly/indirectly and/or wired and/wirelessly) to an external source 810. The external source may comprise a network. The external source may comprise one or more sensor or output device. The external source may comprise a cloud-based application and/or database. The communication may be wired and/or wireless. The external source may be disposed external to the facility. For example, the external source may comprise one or more sensors and/or antennas disposed, e.g., on a wall or on a ceiling of the facility. The communication may be monodirectional or bidirectional. In the example shown in FIG. 8, all communication arrows can be bidirectional.

The controller may monitor and/or direct (e.g., physical) alteration of the operating conditions of the apparatuses, software, and/or methods described herein. Control may comprise regulate, manipulate, restrict, direct, monitor, adjust, modulate, vary, alter, restrain, check, guide, or manage. Controlled (e.g., by a controller) may include attenuated, modulated, varied, managed, curbed, disciplined, regulated, restrained, supervised, manipulated, and/or guided. The control may comprise controlling a control variable (e.g. temperature, power, voltage, and/or profile). The control can comprise real time or off-line control. A calculation utilized by the controller can be done in real time, and/or offline. The controller may be a manual or a non-manual controller. The controller may be an automatic controller. The controller may operate upon request. The controller may be a programmable controller. The controller may be programed. The controller may comprise a processing unit (e.g., CPU or GPU). The controller may receive an input (e.g., from at least one sensor). The controller may deliver an output. The controller may comprise multiple (e.g., sub-) controllers. The controller may be a part of a control system. The control system may comprise a master controller, floor controller, local controller (e.g., enclosure controller, or window controller). The controller may receive one or more inputs. The controller may generate one or more outputs. The controller may be a single input single output controller (SISO) or a multiple input multiple output controller (MIMO). The controller may interpret the input signal received. The controller may acquire data from the one or more sensors. Acquire may comprise receive or extract. The data may comprise measurement, estimation, determination, generation, or any combination thereof. The controller may comprise feedback control. The controller may comprise feed-forward control. The control may comprise on-off control, proportional control, proportional-integral (PI) control, or proportional-integral-derivative (PID) control. The control may comprise open loop control, or closed loop control. The controller may comprise closed loop control. The controller may comprise open loop control. The controller may comprise a user interface. The user interface may comprise (or operatively coupled to) a keyboard, keypad, mouse, touch screen, microphone, speech recognition package, camera, imaging system, or any combination thereof. The outputs may include a display (e.g., screen), speaker, or printer.

The methods, systems and/or the apparatus described herein may comprise a control system. The control system can be in communication with any of the apparatuses (e.g., sensors) described herein. The sensors may be of the same type or of different types, e.g., as described herein. For example, the control system may be in communication with the first sensor and/or with the second sensor. The control system may control the one or more sensors. The control system may control one or more components of a building management system (e.g., including lighting, security, occupancy, occupant behavior, HVAC, sensor, emitter, alarms, and/or air conditioning system). The controller may regulate at least one (e.g., environmental) characteristic of the enclosure. The control system may regulate the enclosure environment using any component of the building management system. For example, the control system may regulate the energy supplied by a heating element and/or by a cooling element. For example, the control system may regulate velocity of an air flowing through a vent to and/or from the enclosure. The control system may comprise a processor. The processor may be a processing unit. The controller may comprise a processing unit. The processing unit may be central. The processing unit may comprise a central processing unit (abbreviated herein as “CPU”). The processing unit may be a graphic processing unit (abbreviated herein as “GPU”). The controller(s) or control mechanisms (e.g., comprising a computer system) may be programmed to implement one or more methods of the disclosure. The processor may be programmed to implement methods of the disclosure. The controller may control at least one component of the forming systems and/or apparatuses disclosed herein.

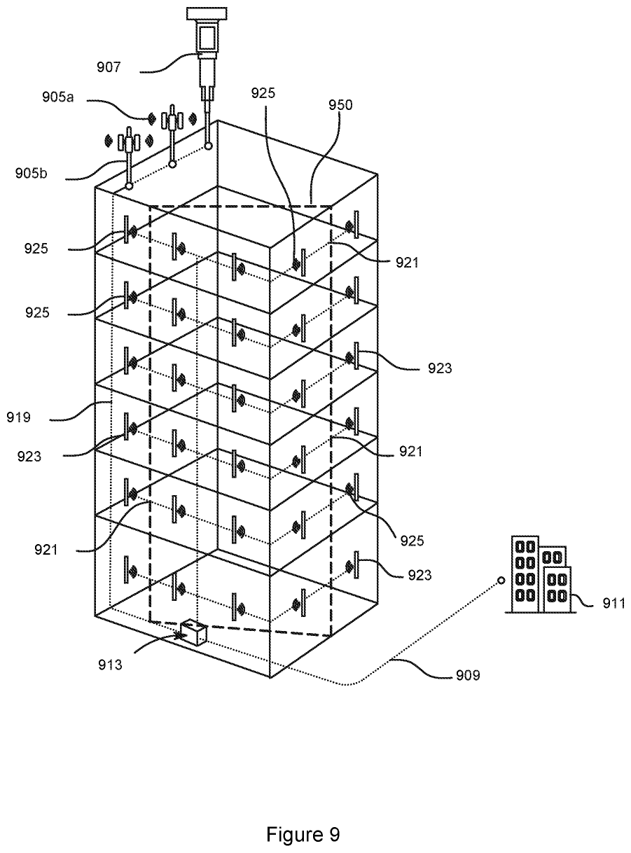

In certain embodiments, a facility (e.g., building) network infrastructure has a vertical data plane (between building floors) and a horizontal data plane (all within a single floor or multiple (e.g., contiguous) floors). In some cases, the horizontal and vertical data planes have at least one (e.g., all) data carrying capabilities and/or components that is (e.g., substantially) the same or similar data. In other cases, these two data planes have at least one (e.g., all) different data carrying capabilities and/or components. For example, the vertical data plane may contain one or more components for fast data transmission rates and/or bandwidths. In one example, the vertical data plane contains components that support at least about 10 Gigabit/second (Gbit/s) or faster (e.g., Ethernet) data transmissions (e.g., using a first type of wiring (e.g., UTP wires and/or fiber optic cables)), while the horizontal data plane contains components that support at most about 8 Gbit/s, 5 Gbit/s, or 1 Gbit/s (e.g., Ethernet) data transmissions, e.g., via a second type of wiring (e.g., coaxial cable). In some cases, the horizontal data plane supports data transmission via d.hn or MoCA standards (e.g., MoCA 2.5 or MoCA 3.0). In certain embodiments, connections between floors on the vertical data plane employ control panels with high speed (e.g., Ethernet) switches that pair communication between the horizontal and vertical data planes and/or between the different types of wiring. These control panels can communicate with (e.g., IP) addressable nodes (e.g., devices) on a given floor via the communication (e.g., d.hn or MoCA) interface and associated wiring (e.g., coaxial cables, twisted cables, or optical cables) on the horizontal data plane. Horizontal and vertical data planes in a single building structure are depicted in FIG. 9.

Data transmission, and in some embodiments voice services, may be provided in a building via wireless and/or wired communications, to and/or from occupants of the building. The data transmission and/or voice services may become difficult due in part to attenuation by building structures such as walls, floors, ceilings, and windows, in third, fourth, or fifth generation (3G, 4G, or 5G) cellular communication. Relative to 3G and 4G communication, the attenuation becomes more severe with higher frequency protocols such as 5G. To address this challenge, a building can be outfitted with components that serve as gateways or ports for cellular signals. Such gateways couple to infrastructure in the interior of the building that provide wireless service (e.g., via interior antennas and other infrastructure implementing Wi-Fi, small cell service (e.g., via microcell or femtocell devices), CBRS, etc.). The gateways or points of entry for such services may include high speed cable (e.g., underground) from a central office of a carrier and/or a wireless signal received at an antenna strategically located on the building exterior (e.g., a donor antenna and/or sky sensor on the building's roof). The high speed cable to the building can be referred to as “backhaul.”

FIG. 9 shows an example of a building with device ensembles (e.g., assemblies). As points of connection, the building can include multiple rooftop donor antennas 905, 905b as well as a sky sensor 907 for sending electromagnetic radiation (e.g., infrared, ultraviolet, and/or visible light). These wireless signals may allow a building services network to wirelessly interface with one or more communications service provider systems. The building has a control panel 913 for connecting to a provider's central office 911 via a physical line 909 (e.g., an optical fiber such as a single mode optical fiber). The control panel 913 may include hardware and/or software configured to provide functions of, for example, a signal source carrier head end, a fiber distribution headend, and/or a (e.g., bi-directional) amplifier or repeater. The rooftop donor antennas 905a and 905b allow building occupants and/or devices to access a wireless system communications service of a (e.g., 3rd party) provider. The antenna and/or controller(s) may provide access to the same service provider system, a different service provider system, or some variation such as two interface elements providing access to a system of a first service provider, and a different interface element providing access to a system of a second service provider.

As shown in the example of FIG. 9, a vertical data plane may include a (e.g., high capacity, or high-speed) data carrying line 919 such as (e.g., single mode) optical fiber or UTP copper lines (of sufficient gauge). In some embodiments, at least one control panel could be provided on at least part of the floors of the building (e.g., on each floor). In some embodiments, one (e.g., high capacity) communication line can directly connect a control panel in the top floor with (e.g., main) control panel 913 in the bottom floor (or in the basement floor). Note that control panel 917 directly connects to rooftop antennas 905a, 905b and/or sky sensor 907, while control panel 913 directly connects to the (e.g., 3rd party) service provider central office 911.

FIG. 9 shows an example of a horizontal data plane that may include one or more of the control panels and data carrying wiring (e.g., lines), which include trunk lines 921. In certain embodiments, the trunk lines are made from coaxial cable. The trunk lines may comprise any wiring disclosed herein. The control panels may be configured to provide data on the trunk lines 921 via a data communication protocol (such as MoCA and/or d.hn). The data communication protocol may comprise (i) a next generation home networking protocol (abbreviated herein as “G.hn” protocol), (ii) communications technology that transmits digital information over power lines that traditionally used to (e.g., only) deliver electrical power, or (iii) hardware devices designed for communication and transfer of data (e.g., Ethernet, USB and Wi-Fi) through electrical wiring of a building. The data transfer protocols may facilitate data transmission rates of at least 1 Gigabits per second (Gbit/s), 2 Gbit/s, 3 Gbit/s, 4 Gbit/s, or 5 Gbit/s. The data transfer protocol may operate over telephone wiring, coaxial cables, power lines, and/or (e.g., plastic) optical fiber. The data transfer protocol may be facilitated using a chip (e.g., comprising a semiconductor device). At least one (e.g., each) horizontal data plane may provide high speed network access to one or more device ensembles 923 (e.g., a set of one or more devices in a housing comprising an assembly of devices) and/or antennas 925, some or all of which are optionally integrated with device ensembles 923. Antennas 925 (and associated radios, not shown) may be configured to provide wireless access by any of various protocols, including, e.g., cellular (e.g., one or more frequency bands at or proximate 28 GHz), Wi-Fi (e.g., one or more frequency bands at 2.4, 5, and 60 GHZ), CBRS, and the like. Drop lines may connect device ensembles 923 to trunk lines 921. In some embodiments, a horizontal data plane is deployed on a floor of a building. The devices in the device ensemble may comprise a sensor, emitter, or antenna. The device ensemble may comprise a circuitry. The devices in the device ensemble may be operatively coupled to the circuitry. One or more donor antennas 905a, 905b may connect to the control panel 913 via high speed lines (e.g., single mode optical fiber or copper). In the depicted example, the control panel 913 may be located in a lower floor of the building. Also as depicted, the connection to the donor antenna(s) 905a, 905b may be via one or more vRAN radios and wiring (e.g., coaxial cable). The communications service provider central office 911 connects to ground floor control panel 913 via a high speed line 909 (e.g., an optical fiber serving as part of a backhaul). This entry point of the service provider to the building is sometimes referred to as a Main Point of Entry (MPOE), and it may be configured to permit the building to distribute both voice and data traffic.

In some cases, a small cell system is made available to a building, at least in part, via one or more antennas. Examples of antennas, sky sensor, and control systems can be found in U.S. patent application Ser. No. 15/287,646, filed Oct. 6, 2016, titled “MULTI-SENSOR DEVICE AND SYSTEM WITH A LIGHT DIFFUSING ELEMENT AROUND A PERIPHERY OF A RING OF PHOTOSENSORS AND AN INFRARED SENSOR,” which is incorporated herein by reference in its entirety. Use of a roof antenna may provide other advantages such facilitating cellular coverage to an increased area (geographically). In some cases, a small cell system is made available to a building, at least in part, via one or more donor antennas.

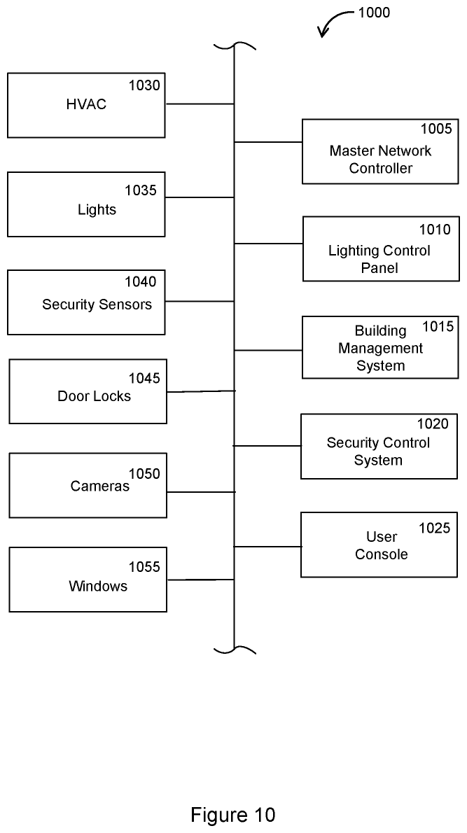

FIG. 10 depicts a block diagram of an embodiment of a building network 1000 for a building. Building network 1000 may employ any number of different communication protocols, including BACnet. As shown, building network 1000 includes a master network controller 1005, a lighting control panel 1010, a building management system 1015, a security control system 1020, and a user console 1025. These different controllers and systems in the building may be used to receive input from and/or control an HVAC system 1030, lights 1035, security sensors 1040, door locks 1045, cameras 1050, and tintable windows 1055 of the building. Master network controller 1005 may function in a similar manner as master controller 808 described with respect to FIG. 8. Lighting control panel 1010 (FIG. 10) may include circuitry to control any device disclosed herein (e.g., the interior lighting that is operatively coupled to the controller. The device may comprise interior lighting, the exterior lighting, the emergency warning lights, the emergency exit signs, and the emergency floor egress lighting, which lighting is associated with the building and is operatively coupled to the controller. Lighting control panel 1010 may include other devices (e.g., an occupancy sensor). Building management system (BMS) 1015 may include a computer server that receives data from, and/or issues commands to, the other systems and controllers operatively coupled to the network 1000. For example, BMS 1015 may receive data from and issue commands to each of the master network controller 1005, lighting control panel 1010, and security control system 1020. Security control system 1020 may include magnetic card access, turnstiles, solenoid driven door locks, surveillance cameras, burglar alarms, metal detectors, and the like. User console 1025 may be a computer terminal that can be used by the building manager to schedule operations of, control, monitor, optimize, and troubleshoot the different systems of the building. Software from Tridium, Inc., may generate visual representations of data from different systems for user console 1025. At least one (e.g., each) of the different controllers may control individual devices/apparatus. Master network controller 1005 may control windows 1055. Lighting control panel 1010 may control lights 1035. BMS 1015 may control HVAC 1030. Security control system 1020 may control security sensors 1040, door locks 1045, and cameras 1050. Data may be exchanged and/or shared between (e.g., all of) the different devices and controllers that are part of the building network 1000. In some cases, at least a portion of the systems of BMS 1015 and/or building network 1000 may run according to daily, monthly, quarterly, or yearly schedules. For example, the lighting control system, the window control system, the HVAC, and the security system may operate on a 24-hour schedule accounting for when people are in the building during the work-day. At least two device categories (e.g., of 1030, 1035, 1040, 1045, 1050, and 1055) may run at a different schedule from each other. At least two device categories (e.g., of 1030, 1035, 1040, 1045, 1050, and 1055) may run at (e.g., substantially) the same schedule. For example, at night the building may enter an energy savings mode, and during the day the systems may operate in a manner that minimizes the energy consumption of the building while providing for occupant comfort, safety, and health. As another example, the systems may shut down or enter an energy savings mode over a holiday period.

The scheduling information may be combined with geographical information. Geographical information may include the latitude and/or longitude of the building. Geographical information may include information about the direction that at least one side of the building faces. Using such information, different rooms on different sides of the building may be controlled in different manners. For example, for East facing rooms of the building in the winter, the window controller may instruct the windows to have no tint in the morning so that the room warms up due to sunlight shining in the room and the lighting control panel may instruct the lights to be dim because of the lighting from the sunlight. The west facing windows may be controllable by the occupants of the room in the morning because the tint of the windows on the west side may have no impact on energy savings. The modes of operation of the east facing windows and the west facing windows may switch in the evening (e.g., when the sun is setting, the west facing windows may not be tinted to allow sunlight in for both heat and lighting).

In some embodiments, a plurality of assemblies (e.g., device ensembles) are deployed as interconnected (e.g., IP) addressable nodes (e.g., devices) within a processing system throughout a particular enclosure (e.g., a building), portions thereof (e.g., rooms or floors), or spanning a plurality of such enclosures.

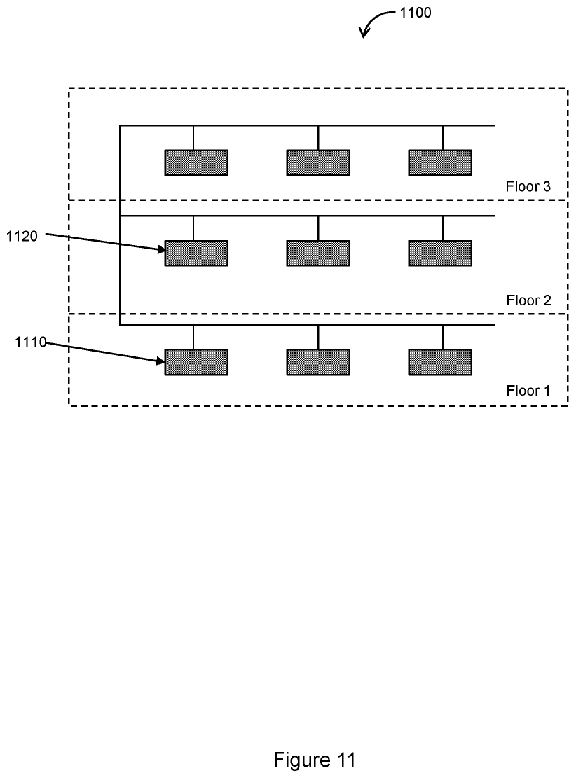

FIG. 11 shows a schematic example of a network system within an enclosure (e.g., building) having a plurality of sub-enclosures (e.g., floors). In the example of FIG. 11, the enclosure 1100 is a building having floor 1, floor 2, and floor 3. The enclosure 1100 includes a network 1120 (e.g., a wired network) that is provided to communicatively couple any addressable circuitry (e.g., addressable node) such as a device or to a device ensemble (also referred to herein as a “community of components” (e.g., community of devices)) collectively represented by 1110. In the example shown in FIG. 11, the three floors are sub enclosures within the enclosure 1100. At least two devices can be of a different type from each other. At least two devices can be of the same type. At least two device ensembles can be of a different type from each other. At least two device ensembles can be of the same type.

In some embodiments, an enclosure includes one or more sensors. The sensor may facilitate controlling the environment of the enclosure, e.g., such that inhabitants of the enclosure may have an environment that is more comfortable, delightful, beautiful, healthy, productive (e.g., in terms of inhabitant performance), easer to live (e.g., work) in, or any combination thereof. The sensor(s) may be configured as low or high resolution sensors. The sensor may provide on/off indications of the occurrence and/or presence of an environmental event (e.g., one pixel sensors). In some embodiments, the accuracy and/or resolution of a sensor may be improved via artificial intelligence (abbreviated herein as “AI”) analysis of its measurements. Examples of artificial intelligence techniques that may be used include: reactive, limited memory, theory of mind, and/or self-aware techniques know to those skilled in the art). Sensors (including their circuitry) may be configured to process, measure, analyze, detect and/or react to: data, temperature, humidity, sound, force, pressure, concentration, electromagnetic waves, position, distance, movement, flow, acceleration, speed, vibration, dust, light, glare, color, gas(es) type, and/or any other aspects (e.g., characteristics) of an environment (e.g., of an enclosure). The gases may include volatile organic compounds (VOCs). The gases may include carbon monoxide, carbon dioxide, water vapor (e.g., humidity), oxygen, radon, and/or hydrogen sulfide. The one or more sensors may be calibrated in a factory setting and/or in the facility. A sensor may be optimized to performing accurate measurements of one or more environmental characteristics present in the factory setting and/or in the facility in which it is deployed.

In some embodiments, a plurality of sensors of the same type may be distributed in a plurality of locations or in a housing. For example, at least one of the plurality of sensors of the same type, may be part of an ensemble. For example, at least two of the plurality of sensors of the same type, may be part of at least two different ensembles. The device ensembles may be distributed in an enclosure. An enclosure may comprise a conference room or a cafeteria. For example, a plurality of sensors of the same type may measure an environmental characteristic (e.g., parameter) in the conference room. Responsive to measurement of the environmental parameter of an enclosure, a parameter topology of the enclosure may be generated. A parameter topology may be generated utilizing output signals from any type of sensor or device ensemble, e.g., as disclosed herein. Parameter topologies may be generated for any enclosure of a facility such as conference rooms, hallways, bathrooms, cafeterias, garages, auditoriums, utility rooms, storage facilities, equipment rooms, piers (e.g., electricity and/or elevator pier), and/or elevators. Examples of artificial intelligence techniques that may be used include: reactive, limited memory, theory of mind, and/or self-aware techniques know to those skilled in the art). Sensors may be configured to process, measure, analyze, detect and/or react to one or more of: data, temperature, humidity, sound, force, pressure, electromagnetic waves, position, distance, movement, flow, acceleration, speed, vibration, dust, light, glare, color, gas(es), pathogen exposure (or likely pathogen exposure), and/or other aspects (e.g., characteristics) of an environment (e.g., of an enclosure). The gases may include volatile organic compounds (VOCs). The gases may include carbon monoxide, carbon dioxide, formaldehyde, Naphthalene, Taurine, water vapor (e.g., humidity), oxygen, radon, and/or hydrogen sulfide. The one or more sensors may be calibrated in a factory setting. A sensor may be optimized to be capable of performing accurate measurements of one or more environmental characteristics present in the factory setting. In some instances, a factory calibrated sensor may be less optimized for operation in a target environment. For example, a factory setting may comprise a different environment than a target environment. The target environment can be an environment in which the sensor is deployed. The target environment can be an environment in which the sensor is expected and/or destined to operate. The target environment may differ from a factory environment. A factory environment corresponds to a location at which the sensor was assembled and/or built. The target environment may comprise a factory in which the sensor was not assembled and/or built. In some instances, the factory setting may differ from the target environment to the extent that sensor readings captured in the target environment are erroneous (e.g., to a measurable extent). In this context, “erroneous” may refer to sensor readings that deviate from a specified accuracy (e.g., specified by a manufacture of the sensor). In some situations, a factory-calibrated sensor may provide readings that do not meet accuracy specifications (e.g., by a manufacturer) when operated in the target environments.

In some embodiments, processing sensor data comprises performing sensor data analysis. The sensor data analysis may comprise at least one rational decision making process, and/or learning. The sensor data analysis may be utilized to adjust and environment, e.g., by adjusting one or more components that affect the environment of the enclosure. The data analysis may be performed by a machine based system (e.g., a circuitry). The circuitry may be of a processor. The sensor data analysis may utilize artificial intelligence. The sensor data analysis may rely on one or more models (e.g., mathematical models). In some embodiments, the sensor data analysis comprises linear regression, least squares fit, Gaussian process regression, kernel regression, nonparametric multiplicative regression (NPMR), regression trees, local regression, semiparametric regression, isotonic regression, multivariate adaptive regression splines (MARS), logistic regression, robust regression, polynomial regression, stepwise regression, ridge regression, lasso regression, elasticnet regression, principal component analysis (PCA), singular value decomposition, fuzzy measure theory, Borel measure, Han measure, risk-neutral measure, Lebesgue measure, group method of data handling (GMDH), Naive Bayes classifiers, k-nearest neighbors algorithm (k-NN), support vector machines (SVMs), neural networks, support vector machines, classification and regression trees (CART), random forest, gradient boosting, or generalized linear model (GLM) technique.

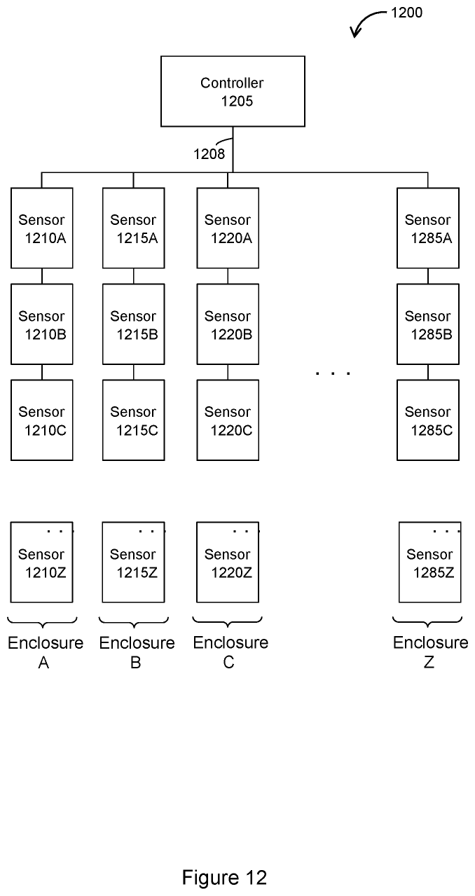

FIG. 12 shows an example of a diagram 1200 of an arrangement of sensors distributed among enclosures. In the example shown in FIG. 12, a controller 1205 is communicatively linked 1208 with sensors located in enclosure A (sensors 1210A, 1210B, 1210C, . . . 1210Z), enclosure B (sensors 1215A, 1215B, 1215C, 1215Z), enclosure C (sensors 1220A, 1220B, 1220C, . . . 1220Z), and enclosure Z (sensors 1285A, 1285B, 1285C, . . . 1285Z). Communicatively linked comprises wired and/or wireless communication. In some embodiments, a device ensemble includes at least two sensors of a differing types. In some embodiments, a device ensemble includes at least two emitters of a differing types. In some embodiments, a device ensemble includes at least two sensors of the same type (e.g., a sensor array). In some embodiments, a device ensemble includes at least two emitters of the same type (e.g., an emitter array such as a light emitting diode array).

In some embodiments, a device ensemble includes at least two sensors of the same type. In the example shown in FIG. 12, sensors 1210A, 1210B, 1210C, . . . 1210Z of enclosure A represent an ensemble. An ensemble of sensors can refer to a collection of diverse sensors. In some embodiments, at least two of the sensors in the ensemble cooperate to determine environmental parameters, e.g., of an enclosure in which they are disposed. For example, a device ensemble may include a carbon dioxide sensor, a carbon monoxide sensor, a volatile organic chemical compound sensor, an environmental noise sensor, a light (visible, UV, and IR) sensor, a temperature sensor, and/or a humidity sensor. A device ensemble may comprise other types of sensors, and claimed subject matter is not limited in this respect. The enclosure may comprise one or more sensors that are not part of an ensemble of sensors. The enclosure may comprise a plurality of ensembles. At least two of the plurality of ensembles may differ in at least one of their sensors. At least two of the plurality of ensembles may have at least one of their sensors that is similar (e.g., of the same type). For example, an ensemble can have two motion sensors and one temperature sensor. For example, an ensemble can have a carbon dioxide sensor and an IR sensor. The ensemble may include one or more devices that are not sensors. The one or more other devices that are not sensors may include sound emitter (e.g., buzzer), and/or electromagnetic radiation emitters (e.g., light emitting diode). In some embodiments, a single sensor (e.g., not in an ensemble) may be disposed adjacent (e.g., immediately adjacent such as contacting) another device that is not a sensor.

Sensors of a device ensemble may collaborate with one another. A sensor of one type may have a correlation with at least one other type of sensor. A situation in an enclosure may affect one or more of different sensors. Sensor readings of the one or more different may be correlated and/or affected by the situation. The correlations may be predetermined. The correlations may be determined over a period of time (e.g., using a learning process). The period of time may be predetermined. The period of time may have a cutoff value. The cutoff value may consider an error threshold (e.g., percentage value) between a predictive sensor data and a measured sensor data, e.g., in similar situation(s). The time may be ongoing. The correlation may be derived from a learning set (also referred to herein as “training set”). The learning set may comprise, and/or may be derived from, real time observations in the enclosure. The observations may include data collection (e.g., from sensor(s)). The learning set may comprise sensor(s) data from a similar enclosure. The learning set may comprise third party data set (e.g., of sensor(s) data). The learning set may derive from simulation, e.g., of one or more environmental conditions affecting the enclosure. The learning set may compose detected (e.g., historic) signal data to which one or more types of noise were added. The correlation may utilize historic data, third party data, and/or real time (e.g., sensor) data. The correlation between two sensor types may be assigned a value. The value may be a relative value (e.g., strong correlation, medium correlation, or weak correlation). The learning set that is not derived from real-time measurements, may serve as a benchmark (e.g., baseline) to initiate operations of the sensors and/or various components that affect the environment (e.g., HVAC system, and/or tinting windows). Real time sensor data may supplement the learning set, e.g., on an ongoing basis or for a defined time period. The (e.g., supplemented) learning set may increase in size during deployment of the sensors in the environment. The initial learning set may increase in size, e.g., with inclusion of additional (i) real time measurements, (ii) sensor data from other (e.g., similar) enclosures, (iii) third party data, (iv) other and/or updated simulation.

In some embodiments, data from sensors is correlated (e.g., synergistically). Once a correlation between two or more sensor types is established, a deviation from the correlation (e.g., from the correlation value) may indicate an irregular situation and/or malfunction of a sensor of the correlating sensors. The malfunction may include a slippage of a calibration. The malfunction may indicate a requirement for re-calibration of the sensor. A malfunction may comprise complete failure of the sensor. In an example, a movement sensor may collaborate with a carbon dioxide sensor. In an example, responsive to a movement sensor detecting movement of one or more individuals in an enclosure, a carbon dioxide sensor may be activated to begin taking carbon dioxide measurements. An increase in movement in an enclosure, may be correlated with increased levels of carbon dioxide. In another example, a carbon monoxide sensor may be activated to begin taking carbon monoxide measurements. An increase in combustion processes within an enclosure may be correlated with increased levels of carbon monoxide. In another example, a motion sensor detecting individuals in an enclosure may be correlated with an increase in noise detected by a noise sensor in the enclosure.

In some embodiments, detection by a first type of sensor that is not accompanied by detection by a second type of sensor, may result in a sensor posting an error message. For example, if a motion sensor detects numerous individuals in an enclosure without detecting an increase in carbon dioxide and/or noise, the carbon dioxide sensor and/or the noise sensor may be identified as having failed or as having an erroneous output. An error message may be posted. A first plurality of different correlating sensors in a first ensemble may include one sensor of a first type, and a second plurality of sensors of different types. If the second plurality of sensors indicate a correlation, and the one sensor indicates a reading different from the correlation, there is an increased likelihood that the one sensor malfunctions. If the first plurality of sensors in the first ensemble detect a first correlation, and a third plurality of correlating sensors in a second ensemble detect a second correlation different from the first correlation, there is an increased likelihood that the situation to which the first ensemble of sensors is exposed to is different from the situation to which the third ensemble of sensors are exposed to. Sensors of a device ensemble may collaborate with one another. The collaboration may comprise considering sensor data of another sensor (e.g., of a different type) in the ensemble. The collaboration may comprise trends projected by the other sensor (e.g., type) in the ensemble. The collaboration may comprise trends projected by data relating to another sensor (e.g., type) in the ensemble. The other sensor data can be derived from the other sensor in the ensemble, from sensors of the same type in other ensembles, or from data of the type collected by the other sensor in the ensemble, which data does not derive from the other sensor. For example, a first ensemble may include a pressure sensor and a temperature sensor. The collaboration between the pressure sensor and the temperature sensor may comprise considering pressure sensor data while analyzing and/or projecting temperature data of the temperature sensor in the first ensemble. The pressure data may be (i) of a pressure sensor in the first ensemble, (ii) of pressure sensor(s) in one or more other ensembles, (iii) pressure data of other sensor(s) and/or (iv) pressure data of a third party.

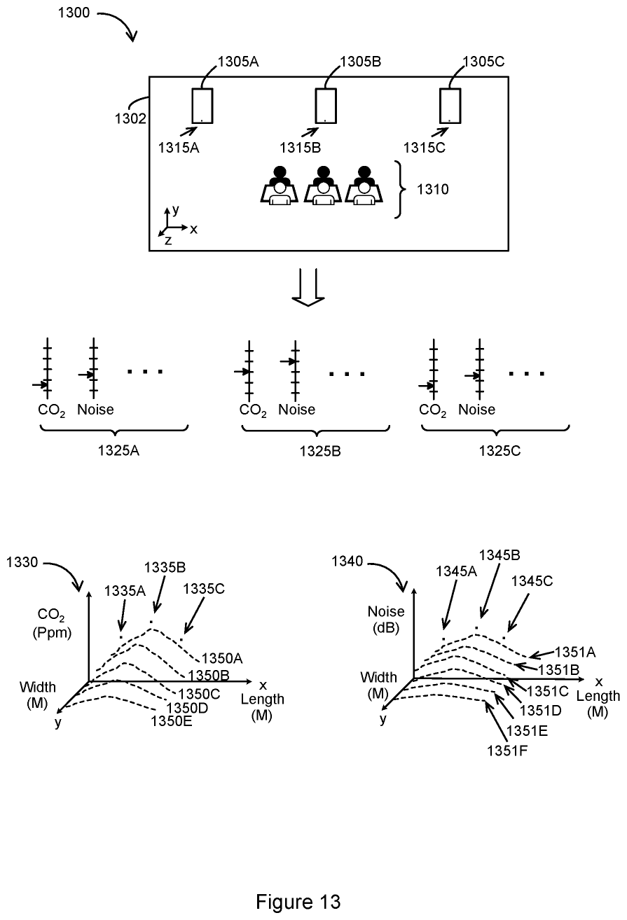

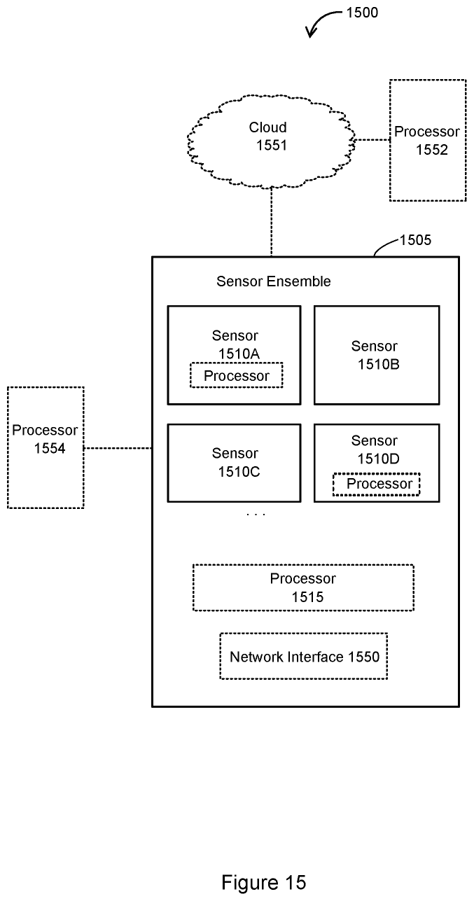

FIG. 13 shows an example of a diagram 1300 of an arrangement of device ensembles distributed within an enclosure. In the example shown in FIG. 13, a group 1310 of individuals are seated in a conference room 1302. The conference room includes an “X” dimension to indicate length, a “Y” dimension to indicate height, and a “Z” dimension to indicate depth. XYZ are directions in a Cartesian coordination system. Device ensembles 1305A, 1305B, and 1305C comprise sensors can operate similar to sensors described in reference to device ensembles 1505 of FIG. 15. At least two device ensembles (e.g., 1305A, 1305B, and 1305C) may be integrated into a single device ensemble. Device ensembles 1305A, 1305B, and 1305C can include a carbon dioxide (CO2) sensor, a carbon monoxide (CO) sensor, an ambient noise sensor, or any other sensor disclosed herein. In the example shown in FIG. 13, a first device ensemble 1305A is disposed (e.g., installed) near point 1315A, which may correspond to a location in a ceiling, wall, or other location to a side of a table at which the group 1310 of individuals are seated. In the example shown in FIG. 13, a second device ensemble 1305B is disposed (e.g., installed) near point 1315B, which may correspond to a location in a ceiling, wall, or other location above (e.g., directly above) a table at which the group 1310 of individuals are seated. In the example shown in FIG. 13, a third device ensemble 1305C may be disposed (e.g., installed) at or near point 1315C, which may correspond to a location in a ceiling, wall, or other location to a side of the table at which the relatively small group 1310 of individuals are seated. Any number of additional sensors and/or device ensembles may be positioned at other locations of conference room 1302. The device ensembles may be disposed anywhere in the enclosure. The location of an ensemble of sensors in an enclosure may have coordinates (e.g., in a Cartesian coordinate system). At least one coordinate (e.g., of x, y, and z) may differ between two or more device ensembles, e.g., that are disposed in the enclosure. At least two coordinates (e.g., of x, y, and z) may differ between two or more device ensembles, e.g., that are disposed in the enclosure. All the coordinates (e.g., of x, y, and z) may differ between two or more device ensembles, e.g., that are disposed in the enclosure. For example, two device ensembles may have the same x coordinate, and different y and z coordinates. For example, two device ensembles may have the same x and y coordinates, and a different z coordinate. For example, two device ensembles may have different x, y, and z coordinates. In some embodiments, one or more sensors of the device ensemble provide readings. In some embodiments, the sensor is configured to sense a parameter. The parameter may comprise temperature, particulate matter, volatile organic compounds, electromagnetic energy, pressure, acceleration, time, radar, lidar, glass vibrations, glass breakage, movement, or gas. The gas may comprise a Nobel gas. The gas may be a gas harmful to an average human. The gas may be a gas present in the ambient atmosphere (e.g., oxygen, carbon dioxide, ozone, chlorinated carbon compounds, or nitrogen). The gas may comprise radon, carbon monoxide, hydrogen sulfide, hydrogen, oxygen, water (e.g., humidity). The electromagnetic sensor may comprise an infrared, visible light, ultraviolet sensor. The infrared radiation may be passive infrared radiation (e.g., black body radiation). The electromagnetic sensor may sense radio waves. The radio waves may comprise wide band, or ultra-wideband radio signals. The radio waves may comprise pulse radio waves. The radio waves may comprise radio waves utilized in communication. The radio waves may be at a medium frequency of at least about 300 kilohertz (KHz), 500 KHz, 800 KHz, 1000 KHz, 1500 KHz, 2000 KHz, or 2500 KHz. The radio waves may be at a medium frequency of at most about 500 KHz, 800 KHz, 1000 KHz, 1500 KHz, 2000 KHz, 2500 KHz, or 3000 KHz. The radio waves may be at any frequency between the aforementioned frequency ranges (e.g., from about 300 KHz to about 3000 KHz). The radio waves may be at a high frequency of at least about 3 megahertz (MHz), 5 MHz, 8 MHz, 10 MHz, 15 MHZ, 20 MHz, or 25 MHz. The radio waves may be at a high frequency of at most about 5 MHZ, 8 MHz, 10 MHz, 15 MHz, 20 MHZ, 25 MHZ, or 30 MHz. The radio waves may be at any frequency between the aforementioned frequency ranges (e.g., from about 3 MHz to about 30 MHz). The radio waves may be at a very high frequency of at least about 30 Megahertz (MHz), 50 MHz, 80 MHz, 100 MHz, 150 MHz, 200 MHZ, or 250 MHz. The radio waves may be at a very high frequency of at most about 50 MHz, 80 MHz, 100 MHZ, 150 MHZ, 200 MHZ, 250 MHz, or 300 MHz. The radio waves may be at any frequency between the aforementioned frequency ranges (e.g., from about 30 MHz to about 300 MHz). The radio waves may be at an ultra-high frequency of at least about 300 kilohertz (MHz), 500 MHZ, 800 MHZ, 1000 MHZ, 1500 MHZ, 2000 MHz, or 2500 MHz. The radio waves may be at an ultra-high frequency of at most about 500 MHz, 800 MHZ, 1000 MHz, 1500 MHZ, 2000 MHz, 2500 MHZ, or 3000 MHz. The radio waves may be at any frequency between the aforementioned frequency ranges (e.g., from about 300 MHz to about 3000 MHz). The radio waves may be at a super high frequency of at least about 3 gigahertz (GHz), 5 GHZ, 8 GHZ, 10 GHZ, 15 GHZ, 20 GHz, or 25 GHz. The radio waves may be at a super high frequency of at most about 5 GHZ, 8 GHZ, 10 GHz, 15 GHz, 20 GHZ, 25 GHZ, or 30 GHz. The radio waves may be at any frequency between the aforementioned frequency ranges (e.g., from about 3 GHz to about 30 GHz). The gas sensor may sense a gas type, flow (e.g., velocity and/or acceleration), pressure, and/or concentration. The readings may have an amplitude range. The readings may have a parameter range. For example, the parameter may be electromagnetic wavelength, and the range may be a range of detected wavelengths.

In some embodiments, the sensor data is responsive to the environment in the enclosure and/or to any inducer(s) of a change (e.g., any environmental disruptor) in this environment. The sensors data may be responsive to emitters operatively coupled to (e.g., in) the enclosure (e.g., an occupant, appliances (e.g., heater, cooler, ventilation, and/or vacuum), opening). For example, the sensor data may be responsive to an air conditioning duct, or to an open window. The sensor data may be responsive to an activity taking place in the room. The activity may include human activity, and/or non-human activity. The activity may include electronic activity, gaseous activity, and/or chemical activity. The activity may include a sensual activity (e.g., visual, tactile, olfactory, auditory, and/or gustatory). The activity may include an electronic and/or magnetic activity. The activity may be sensed by a person. The activity may not be sensed by a person. The sensors data may be responsive to the occupants in the enclosure, substance (e.g., gas) flow, substance (e.g., gas) pressure, and/or temperature. In one example, device ensembles 1305A, 1305B, and 1305C may include a carbon dioxide (CO2) sensor, a carbon monoxide (CO) sensor, and an ambient noise sensor. A carbon dioxide sensor of device ensemble 1305A may provide a reading as depicted in sensor output reading profile 1325A. A noise sensor of device ensemble 1305A may provide a reading depicted in sensor output reading profile 1325A. A carbon monoxide sensor of device ensemble 1305B may provide a reading as depicted in sensor output reading profile 1325B. A noise sensor of device ensemble 1305B may provide a reading also as depicted in sensor output reading profile 1325B. Sensor output reading profile 1325B may indicate higher levels of carbon monoxide and noise relative to sensor output reading profile 1325A. Sensor output reading profile 1325C may indicate lower levels of carbon monoxide and noise relative to sensor output reading profile 1325B. Sensor output reading profile 1325C may indicate carbon monoxide and noise levels similar to those of sensor output reading profile 1325A. Sensor output reading profiles 1325A, 1325B, and 1325C may comprise indications representing other sensor readings, such as temperature, humidity, particulate matter, volatile organic compounds, ambient light, pressure, acceleration, time, radar, lidar, ultra-wideband radio signals, passive infrared, and/or glass breakage, movement detectors. In some embodiments, data from a sensor in a sensor in the enclosure (e.g., and in the device ensemble) is collected and/or processed (e.g., analyzed). The data processing can be performed by a processor of the sensor, by a processor of the device ensemble, by another sensor, by another ensemble, in the cloud, by a processor of the controller, by a processor in the enclosure, by a processor outside of the enclosure, by a remote processor (e.g., in a different facility), by a manufacturer (e.g., of the sensor, of the window, and/or of the building network). The data of the sensor may have a time indicator (e.g., may be time stamped). The data of the sensor may have a sensor location identification (e.g., be location stamped). The sensor may be identifiably coupled with one or more controllers. In particular embodiments, sensor output reading profiles 1325A, 1325B, and 1325C may be processed. For example, as part of the processing (e.g., analysis), the sensor output reading profiles may be plotted on a graph depicting a sensor reading as a function of a dimension (e.g., the “X” dimension) of an enclosure (e.g., conference room 1302). In an example, a carbon dioxide level indicated in sensor output reading profile 1325A may be indicated as point 1335A of CO graph 1330 of FIG. 13. In an example, a carbon monoxide level of sensor output reading profile 1325B may be indicated as point 1335B of CO graph 1330. In an example, a carbon monoxide level indicated in sensor output reading profile 1325C may be indicated as point 1335C of CO graph 1330. In an example, an ambient noise level indicated in sensor output reading profile 1325A may be indicated as point 1345A of noise graph 1340. In an example, an ambient noise level indicated in sensor output reading profile 1325B may be indicated as point 1345B of noise graph 1340. In an example, an ambient noise level indicated in sensor output reading profile 1325C may be indicated as point 1345C of noise graph 1340. In some embodiments, processing data derived from the sensor comprises applying one or more models. The models may comprise mathematical models. The processing may comprise fitting of models (e.g., curve fitting). The model may be multi-dimensional (e.g., two or three dimensional). The model may be represented as a graph (e.g., 2 or 3 dimensional graph). For example, the model may be represented as a contour map (e.g., as depicted in FIG. 13). The modeling may comprise one or more matrices. The model may comprise a topological model. The model may relate to a topology of the sensed parameter in the enclosure. The model may relate to a time variation of the topology of the sensed parameter in the enclosure. The model may be environmental and/or enclosure specific. The model may consider one or more properties of the enclosure (e.g., dimensionalities, openings, and/or environmental disrupters (e.g., emitters)). Processing of the sensor data may utilize historical sensor data, and/or current (e.g., real time) sensor data. The data processing (e.g., utilizing the model) may be used to project an environmental change in the enclosure, and/or recommend actions to alleviate, adjust, or otherwise react to the change. In particular embodiments, device ensembles 1305A, 1305B, and/or 1305C, may be capable of accessing a model to permit curve fitting of sensor readings as a function of one or more dimensions of an enclosure. In an example, a model may be accessed to generate sensor profile curves 1350A, 1350B, 1350C, 1350D, and 1350E, utilizing points 1335A, 1335B, and 1335C of CO graph 1330. In an example, a model may be accessed to generate sensor profile curves 1351A, 1351B, 1351C, 1351B, 1351E, and 1351F utilizing points 1345A, 1345B, and 1345C of noise graph 1340. Additional models may utilize additional readings from device ensembles (e.g., 1305A, 1305B, and/or 1305C) to provide curves in addition to sensor profile curves 1350 and 1351 of FIG. 13. Sensor profile curves generated in response to use of a model may sensor output reading profiles indicate a value of a particular environmental parameter as a function of a dimension of an enclosure (e.g., an “X” dimension, a “Y” dimension, and/or a “Z” dimension). In certain embodiments, one or more models utilized to form curves 1350A-1350E and 1351A-1351F) may provide a parameter topology of an enclosure. In an example, a parameter topology (as represented by curves 1350A-1350E and 1351A-1351F) may be synthesized or generated from sensor output reading profiles. The parameter topology may be a topology of any sensed parameter disclosed herein. In an example, a parameter topology for a conference room (e.g., conference room 1302) may comprise a carbon dioxide profile having relatively low values at locations away from a conference room table and relatively high values at locations above (e.g., directly above) a conference room table. In an example, a parameter topology for a conference room may comprise a multi-dimensional noise profile having relatively low values at locations away from a conference table and slightly higher values above (e.g., directly above) a conference room table. In an example, for a carbon dioxide sensor, a relevant parameter may correspond to carbon dioxide concentration. In an example, a carbon dioxide sensor may determine that a time window during which fluctuations in carbon dioxide concentration could be minimal corresponds to a two-hour period, e.g., between 5:00 AM and 7:00 AM. Self-calibration may initiate at 5:00 AM and continue while searching for a duration within these two hours during which measurements are stable (e.g., minimally fluctuating). In some embodiments, the duration is sufficiently long to allow separation between signal and noise. In an example, data from a carbon dioxide sensor may facilitate determination that a 5-minute duration (e.g., between 5:25 AM and 5:30 AM) within a time window between 5:00 AM and 7:00 AM forms an optimal time period to collect a lower baseline. The determination can be performed at least in part (e.g., entirely) at the sensor level. The determination can be performed by one or more processors operatively couple to the sensor. During a selected duration, a sensor may collect readings to establish a baseline, which may correspond to a lower threshold. In an example, for gas sensors disposed in a room (e.g., in an office environment), a relevant parameter may correspond to gas (e.g., CO2) levels, where desired levels are typically in a range of about 1000 ppm or less. In an example, a CO2 sensor may determine that self-calibration should occur during a time window where CO2 levels are minimal such as when no occupants are in the vicinity of the sensor. Time windows during which fluctuations in CO2 levels are minimal, may correspond to, e.g., a one-hour period during lunch from about 12:00 PM to about 1:00, and during closed business hours.

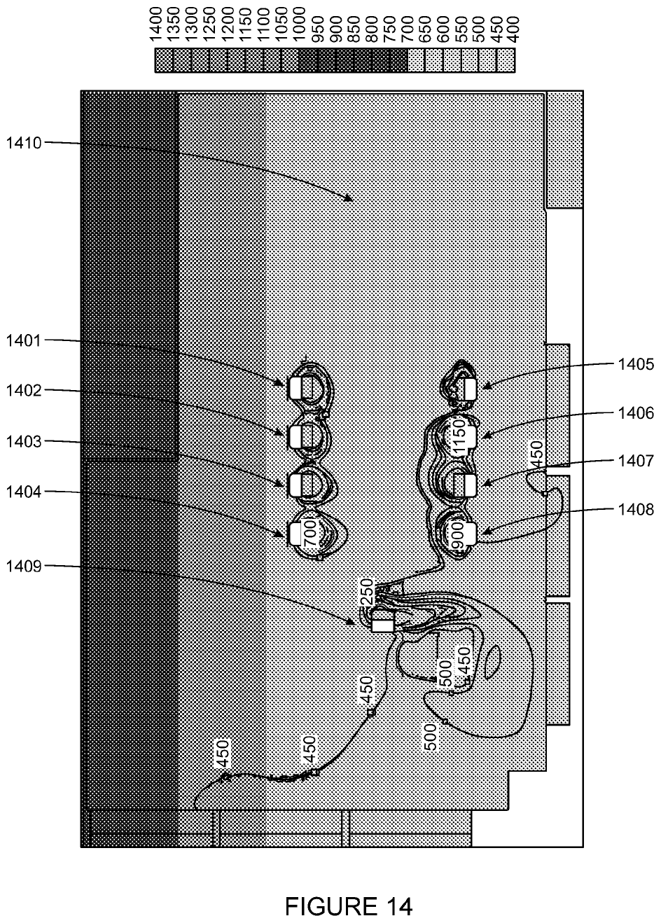

FIG. 14 shows a contour map example of a horizontal (e.g., top) view of an office environment depicting various levels of CO2 concentrations. The office environment may include a first occupant 1401, a second occupant 1402, a third occupant 1403, a fourth occupant 1404, a fifth occupant 1405, a sixth occupant 1406, a seventh occupant 1407, an eighth occupant 1408, and a ninth occupant 1409. The gas (CO2) concentrations may be measured by sensors placed at various locations in the enclosure (e.g., office). In an example, for an ambient noise sensor disposed in a crowded area such as a cafeteria, a relevant parameter may correspond to sound pressure (e.g., noise) level measured in decibels above background atmospheric pressure. In an example, an ambient noise sensor may determine that self-calibration should occur during a time window while fluctuations in sound pressure level are minimal. A time window while fluctuations in sound pressure are minimal may correspond to a one-hour period from about 12:00 AM to about 1:00 AM. Self-calibration may continue with the sensor determining a duration within a window during which may be made to establish a baseline (e.g., an upper threshold). In an example, an ambient noise sensor may determine that a 10-minute duration (e.g., from about 12:30 AM to about 12:40 AM) within a time window of from about 12:00 AM to about 1:00 AM forms an optimal time to collect an upper baseline, which may correspond to an upper threshold.

At least two sensors of the plurality of sensors may be of a different type (e.g., are configured to measure different properties). Various sensor types can be assembled together (e.g., bundled up) and form a device ensemble. The plurality of sensors may be coupled to one electronic board. The electrical connection of at least two of the plurality of sensors in the sensor suit may be controlled (e.g., manually and/or automatically). For example, the device ensemble may be operatively coupled to, or comprise, a controller (e.g., a microcontroller). The controller may control and on/off connectivity of the sensor to electrical power. The controller can thus control the time (e.g., period) at which the sensor will be operative.

In some embodiments, baseline of one or more sensors of the device ensemble may drift. A recalibration may include one or more (e.g., but not all) sensors of a device ensemble. For example, a collective baseline drift can occur in at least two sensor types in a given device ensemble. A baseline drift in one sensor of the device ensemble may indicate malfunction of the sensor. Baseline drifts measured in a plurality of sensors in the device ensemble, may indicate a change in the environment sensed by the sensors in the device ensemble (e.g., rather than malfunction of these baseline drifted sensors). Such sensor data baseline drifts may be utilized to detect environmental changes. For example (i) that a building was erected/destroyed next to the device ensemble, (ii) that a ventilation channel was altered (e.g., damaged) next to the device ensemble, (iii) that a refrigerator is installed/dismantled next to the device ensemble, (iv) that a working location of a person is altered relative (e.g., and adjacent) to the device ensemble, (v) that an electronic change (e.g., malfunction) is experienced by the device ensemble, (vi) that a structure (e.g., interior wall) has been changed, or (vii) any combination thereof. In this manner, the data can be used e.g. to update a three-dimensional (3D) model of the enclosure. In some embodiments, one or more sensors are added or removed from a community of sensors, e.g., disposed in the enclosure and/or in the device ensemble. Newly added sensors may inform (e.g., beacon) other members of a community of sensor of its presence and relative location within a topology of the community. Examples of sensor community(ies), network, control system, and devices can be found, for example, in International Patent Application Serial No. PCT/US21/12313 that was filed Jan. 6, 2020, titled “LOCALIZATION OF COMPONENTS IN A COMPONENT COMMUNITY,” which is incorporated by reference herein in its entirety. Sensors of a device ensemble may be organized into a device ensemble. A device ensemble may comprise at least one circuit board, such as a printed circuit board, in which a number of devices (e.g., sensors and/or emitters) are adhered or affixed to the at least one circuit board. Devices can be removed from the device ensemble. For example, a sensor may be plugged and/or unplugged from the circuit board. Sensors may be individually activated and/or deactivated (e.g., using a switch). The circuit board may comprise a polymer. The circuit board may be transparent or non-transparent. The circuit board may comprise metal (e.g., elemental metal and/or metal alloy). The circuit board may comprise a conductor. The circuit board may comprise an insulator. The circuit board may comprise any geometric shape (e.g., rectangle or ellipse). The circuit board may be configured (e.g., may be of a shape) to allow the ensemble to be disposed in a mullion (e.g., of a window). The circuit board may be configured (e.g., may be of a shape) to allow the ensemble to be disposed in a frame (e.g., door frame and/or window frame). The mullion, transom, and/or frame may comprise one or more holes to allow the sensor(s) to obtain (e.g., accurate) readings. The sensor ensemble may comprise a housing. The housing may comprise one or more holes to facilitate sensor readings. The circuit board may include an electrical connectivity port (e.g., socket). The circuit board may be connected to a power source (e.g., to electricity). The power source may comprise renewable or non-renewable power source.

FIG. 15 shows an example of a system 1500 including an ensemble of sensors organized into a device ensemble. Sensors 1510A, 1510B, 1510C, and 1510D are shown as included in a device ensemble 1505. The device ensembles (including the device ensemble 1505) that are organized into a device ensemble may include at least 1, 2, 4, 5, 8, 10, 20, 50, or 500 sensors. The device ensemble may include a number of sensors in a range between any of the aforementioned values (e.g., from about 1 to about 1000, from about 1 to about 500, or from about 500 to about 1000). Sensors of a device ensemble may comprise sensors configured or designed for sensing a parameter comprising, temperature, humidity, carbon dioxide, particulate matter (e.g., between 2.5 μm and 10 μm), total volatile organic compounds (e.g., via a change in a voltage potential brought about by surface adsorption of volatile organic compound), ambient light, audio noise level, pressure (e.g. gas, and/or liquid), acceleration, time, radar, lidar, radio signals (e.g., ultra-wideband radio signals), passive infrared, glass breakage, or movement detectors. The device ensemble (e.g., 1505) may comprise non-sensor devices, such as buzzers and light emitting diodes. Examples of device ensembles and their uses can be found in U.S. patent application Ser. No. 16/447,169, filed Jun. 20, 2019, titled “SENSING AND COMMUNICATIONS UNIT FOR OPTICALLY SWITCHABLE WINDOW SYSTEMS,” that is incorporated herein by reference in its entirety. In some embodiments, an increase in the number and/or types of sensors may be used to increase a probability that one or more measured property is accurate and/or that a particular event measured by one or more sensor has occurred. In some embodiments, sensors of device ensemble and/or of different device ensembles may cooperate with one another. In an example, a radar sensor of device ensemble may determine presence of a number of individuals in an enclosure. A processor (e.g., processor 1515) may determine that detection of presence of a number of individuals in an enclosure is positively correlated with an increase in carbon dioxide concentration. In an example, the processor-accessible memory may determine that an increase in detected infrared energy is positively correlated with an increase in temperature as detected by a temperature sensor. In some embodiments, network interface (e.g., 1550) may communicate with other device ensembles similar to device ensemble. The network interface may additionally communicate with a controller. Individual sensors (e.g., sensor 1510A, sensor 1510D, etc.) of a device ensemble may comprise and/or utilize at least one dedicated processor. A device ensemble may utilize a remote processor (e.g., 1554) utilizing a wireless and/or wired communications link. A device ensemble may utilize at least one processor (e.g., processor 1552), which may comprise a cloud-based processor coupled to a device ensemble via the cloud (e.g., 1551). Processors (e.g., 1552 and/or 1554) may be located in the same building, in a different building, in a building owned by the same or different entity, a facility owned by the manufacturer of the window/controller/device ensemble, or at any other location. In various embodiments, as indicated by the dotted lines of FIG. 15, device ensemble 1505 is not required to comprise a separate processor and network interface. These entities may be separate entities and may be operatively coupled to ensemble 1505. The dotted lines in FIG. 15 designate optional features. In some embodiments, onboard processing and/or memory of one or more ensemble of sensors may be used to support other functions (e.g., via allocation of ensembles(s) memory and/or processing power to the network infrastructure of a building). In some embodiments, a plurality of sensors of the same type may be distributed in an enclosure. At least one of the plurality of sensors of the same type, may be part of an ensemble. For example, at least two of the plurality of sensors of the same type, may be part of at least two ensembles. The device ensembles may be distributed in an enclosure. An enclosure may comprise a conference room. For example, a plurality of sensors of the same type may measure an environmental parameter in the conference room. Responsive to measurement of the environmental parameter of an enclosure, a parameter topology of the enclosure may be generated. A parameter topology may be generated utilizing output signals from any type of sensor of device ensemble, e.g., as disclosed herein. Parameter topologies may be generated for any enclosure of a facility such as conference rooms, hallways, bathrooms, cafeterias, garages, auditoriums, utility rooms, storage facilities, equipment rooms, and/or elevators.

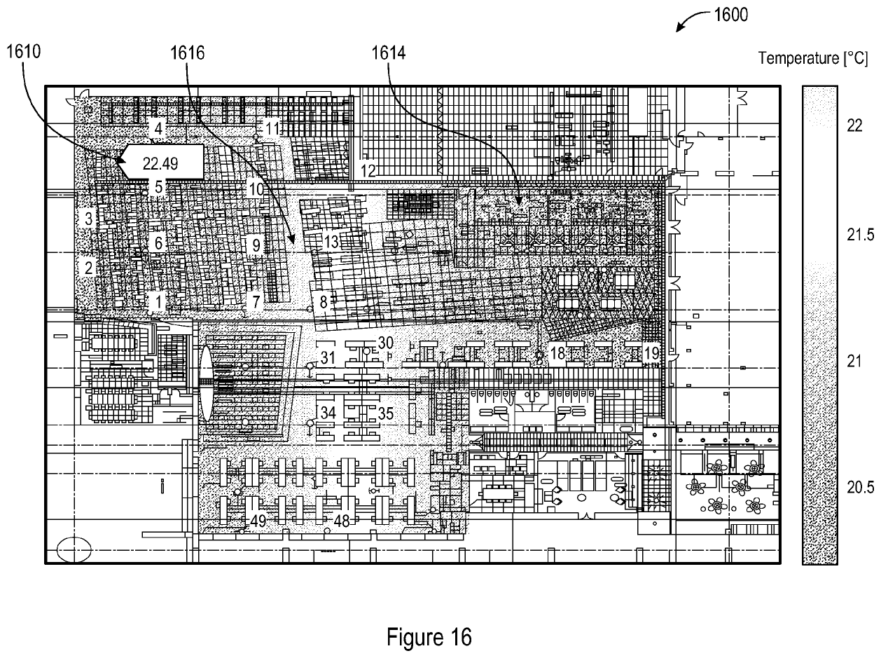

FIG. 16 shows an example of temperature mapping in an enclosure 1600. The enclosure 1600 may include one or more offices, such as an office 1614. The enclosure may include one or more corridors, such as a corridor 1616. The interior of the enclosure 1600 can be mapped to indicate localized temperatures using gray scale shading. Lighter shades may represent higher temperatures (e.g., approximately 22 degrees Celsius), whereas darker shades may represent lower temperatures (e.g., approximately 20.5 degrees Celsius). Alternatively, lighter shades could be used to represent lower temperatures, with darker shades representing higher temperatures. In the example shown in FIG. 16, a temperature of 22.49 degrees Celsius is indicated at a point 1610 within the enclosure 1600.

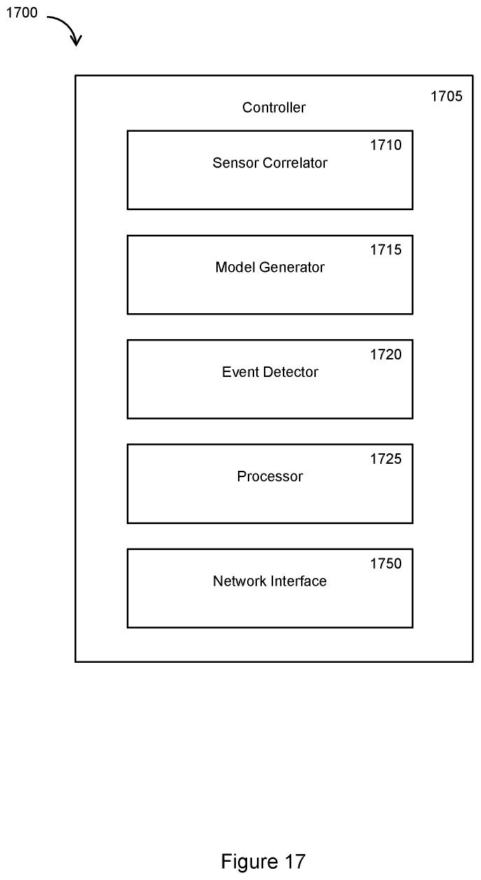

FIG. 17 schematically depicts a controller 1705 for controlling one or more sensors. The controller 1705 comprises a sensor correlator 1710, a model generator 1715, an event detector 1720, a processor 1725, and a network interface 1750. The sensor correlator 1710 operates to detect correlations between or among various sensor types. For example, an infrared radiation sensor measuring an increase in infrared energy may be positively correlated with an increase in measure temperature. A sensor correlator may establish correlation coefficients, such as coefficients for negatively-correlated sensor readings (e.g., correlation coefficients between −1 and 0). For example, the sensor correlator may establish coefficients for positively-correlated sensor readings (e.g., correlation coefficients between 0 and +1).

In some embodiments, the enclosure includes at least one digital architectural element. The Device ensemble may be a digital architectural element (DAE), e.g., that may be attached or contained in an architectural fixture. The device ensemble (e.g., the DAE) may contain various sensors, emitters, devices, processors (e.g., a microcontroller and/or a non-volatile memory), network interfaces, and/or one or more peripheral interfaces. The term DAE can refer to any device, device ensemble, or interface, configured to be mounted to and/or retained in, or on, any structural component in an enclosure (e.g., framework, beam, joist, wall, ceiling, floor, window, fascia, transom, and/or casement of a building or of a room of a building). A DAE may include, for example, a window-mullion interface, a digital wall interface, and/or a ceiling-mounted interface. Examples of DAE sensors include light sensors, optionally including image capture sensors such as cameras, audio sensors such as voice coils or microphones, air quality sensors, and proximity sensors (e.g., certain IR and/or RF sensors). The network interface may be a high bandwidth interface such as a gigabit (or faster) Ethernet interface. Examples of DAE peripherals include video display monitors, add-on speakers, mobile devices, battery chargers, and the like. Examples of peripheral interfaces include standard Bluetooth modules, ports such as USB ports and network ports, etc. Ports may include any of various proprietary ports for third party devices.

In some embodiments, the DAE operates in conjunction with other hardware and/or software provided for an optically switchable window system to a display coupled to window, and/or to a display projected on the window. In some embodiments, the DAE includes a controller (e.g., any controller disclosed herein).

In some embodiments, a DAE includes one or more signal generating devices such as a speaker, a light source (e.g., an LED), a beacon, an antenna (e.g., a Wi-Fi or cellular communications antenna), and the like. The signal generating device can be an emitter. In some embodiments, a DAE includes an energy storage component and/or a power harvesting component. For example, a DAE may contain one or more batteries and/or capacitors, e.g., as energy storage devices, the DAE may include a photovoltaic cell. In one example, a DAE has one or more user interface components (e.g., a microphone or a speaker), one more sensors (e.g., a proximity sensor), and a network interface (e.g., for a high bandwidth communications).

In some embodiments, a DAE is designed, or configured to, attach to (or otherwise be collocated with) a structural element of an enclosure (e.g., a building). In some embodiments, a DAE has an appearance that blends in with the structural element with which it is associated. For example, a DAE may have a shape, size, and/or color that blends with the associated structural element. For example, a DAE may not be easily visible to occupants of a building; e.g., the element is fully or partially camouflaged in the surrounding in which it is disposed. However, such element may interface with other component(s) that do not blend in, such as one or more video display monitors, touch screens, projectors, and the like.

In some embodiments, the building structural elements to which DAE may be attached include any of various building structures. In some embodiments, building structures to which DAEs attach are installed and/or constructed during building construction, in some cases early in building construction when the building skeleton or envelope is constructed. In some embodiments, the building structural elements for DAEs are elements that serve a building structural function. Such elements may be permanent, e.g., not easily removable from a building. Examples include columns, piers (e.g., elevator, communication, or electrical piers), walls, partitions (e.g., office space partitions), doors, beams, stairs, façades, moldings, mullions and/or transoms. In various examples, the structural elements are located on a perimeter of the enclosure. In some embodiments, the DAE is provided as separate modular unit or as a housing (e.g., box) that attach to the building structural element. In some cases, DAEs are provided as façades for building structural elements. For example, a DAE may be provided as a cover for a portion of a mullion, transom, or door. In one example, a DAE is configured as a mullion or disposed in or on a mullion. If it is attached to a mullion, the DAE may be bolted on or otherwise attached to the rigid parts of the mullion. In some embodiments, a DAE can snap onto a structural element of the enclosure. In some embodiments, a DAE serves as a molding, e.g., a crown molding. In some embodiments, a DAE is modular; e.g., it serves as a module for part of a larger system such as a communications network, a power distribution network, and/or computational system. The computation system can employ an external video display and/or other user interface components.

In some embodiments, the DAE is a digital mullion designed to be deployed on one or more mullions in a room, floor, or building. In some embodiments, digital mullions are deployed in a regular or periodic fashion. For example, digital mullions may be deployed on every sixth successive mullion.

In some embodiments, in addition to the high bandwidth network connection (port, switch, and/or router) and a housing, the DAE includes one or more of the following digital and/or analog components: a camera, a proximity or movement sensor, an occupancy sensor, a color temperature sensor, an infrared sensor, an ultraviolet sensor, a visible light sensor, a biometric sensor, a speaker, a microphone, an air quality sensor, a hub for power and/or data connectivity, display video driver, a Wi-Fi access point, an antenna, a location service (e.g., Bluetooth, Global Positioning System, or ultra-wide band) via beacons or other mechanism, a power source, a light source, a processor, a memory, and/or ancillary processing device. One or more cameras may include a sensor and processing logic for imaging features in the visible, IR (see use of thermal imager below), or other wavelength region; various resolutions are possible including HD and greater. The DAE may include one or more devices disclosed herein.

One or more proximity or movement sensors may include an infrared sensor (abbreviated herein as an “IR” sensor). In some embodiments, a proximity sensor is a radar or radar-like device that detects distances from and between objects using a ranging function. Radar sensors can also be used to distinguish between closely spaced occupants via detection of their biometric functions, for example, detection of their different breathing movements. When radar or radar-like sensors are used, better operation may be facilitated when disposed unobstructed or behind a plastic case of a DAE. One or more occupancy sensors may include a multi-pixel thermal imager, which when configured with an appropriate computer implemented algorithm can be used to detect and/or count the number of occupants in a room. In some embodiments, data from a thermal imager or thermal camera is correlated with data from a radar sensor to provide a better level of confidence in a particular determination being made. In some embodiments, thermal imager measurements can be used to evaluate other thermal events in a particular location, for example, changes in air flow caused by open windows and doors, the presence of intruders, and/or fires. One or more color temperature sensors may be used to analyze the spectrum of illumination present in a particular location and to provide outputs that can be used to implement changes in the illumination as needed or desired, for example, to improve an occupant's health or mood. One or more biometric sensors (e.g., for fingerprint, retina, or facial recognition) may be provided as a stand-alone sensor or be integrated with another sensor such as a camera.

One or more speakers and associated power amplifiers may be included as part of a DAE or separate from it. In some embodiments, two or more speakers and an amplifier are configured as a sound bar; e.g., a bar-shaped device containing multiple speakers. The device may be designed (e.g., configured) to provide high fidelity sound. One or more microphones and/or logic for detecting and processing sounds may be provided as part of a DAE or separate from it. The microphones may be configured to detect internally and/or externally generated sounds. In some embodiments, processing and analysis of the sounds is performed by logic embodied as software, firmware, or hardware in one or more digital structural element and/or by logic in one or more other devices coupled to the network, for example, one or more controllers coupled to the network. In some embodiments, based at least in part on the analysis, the logic is configured to automatically adjust a sound output of one or more speaker to mask and/or cancel sounds, frequency variations, echoes, and other factors detected by one or more microphone, e.g., that negatively impact (or potentially could negatively impact) occupants present in a particular location within the enclosure (e.g., the building). In some embodiments, the sounds comprise sounds generated by, but not limited to: indoor machinery, indoor office equipment, outdoor construction, outdoor traffic, and/or airplanes.

One or more air quality sensors (optionally able to measure one or more of the following air components: volatile organic compounds (VOC), carbon dioxide temperature, humidity) may be used in conjunction with HVAC to improve air circulation control.

One or more hubs for power and/or data connectivity to sensor(s), speakers, microphone, and the like may be provided. The hub may comprise a USB hub, or a Bluetooth hub. The hub may include one or more ports such as USB ports, High Definition Multimedia Interface (HDMI) ports, or any other port, plug, or socket disclosed herein. For example, the DAE may include a connector dock for external sensors, light fixtures, peripherals (e.g., a camera, microphone, speaker(s)), network connectivity, power sources, etc.

One or more video drivers may be provided. The driver may be utilized for a display (e.g., a transparent OLED device) on or proximate to a window (such as an integrated glass unit (IGU)) associated with the DAE element. The driver may be physically wired or optically coupled to the DAE. For example, the optical signal may be launched into the window by optical transmission, such as a switchable Bragg grating that includes a display with a light engine and lens that focuses on glass waveguides that transmits through the glass and travels perpendicularly to line of sight.

One or more Wi-Fi access points and antenna(s), which may be part of the Wi-Fi access point or serve a different purpose. In some embodiments, the DAE or a faceplate that covers all or a portion of the DAE, may serve as an antenna. Various approaches may be employed to insulate the DAE and use it to transmit and/or receive directionally. A prefabricated antenna may be employed in the enclosure. A window antenna may be employed. Examples of antennas and their integration in a facility and deployment may be found in International Patent Application Serial No. PCT/US17/31106, filed May 4, 2017, titled “WINDOW ANTENNAS,” which is incorporated herein by reference in its entirety.

One or more power sources such as an energy storage device (e.g., a rechargeable battery and/or a capacitor), and the like may be provided. The power source may be renewable or non-renewable. In some embodiments, a power harvesting device is included; e.g., a photovoltaic cell or panel of cells. This may allow the device to be self-contained or partially self-contained. The light harvesting device may be transparent or opaque, e.g., depending on where it is attached. For example, a photovoltaic cell may be attached to, e.g., and partially or fully cover, the exterior of a digital mullion. For example, a transparent photovoltaic cell may be cover a display and/or user interface (e.g., a dial, button, etc.), e.g., on the DAE.

One or more light sources (e.g., light emitting diodes) may be configured to interface with the processor in order to emit light under certain conditions, such as signaling when the device is active.

One or more processors may be configured to provide various embedded or non-embedded applications. The processor may comprise a microcontroller. In some embodiments, the processor is low-powered mobile computing unit (MCU) with memory and configured to run a lightweight secure operating system hosting applications and data. In some embodiments, the processor is an embedded system, system on chip, or an extension. One or more ancillary processing devices (such as a graphical processing unit, or an equalizer or other audio processing device) may be used to interpret audio signals.

In some embodiments, a DAE (or building structural element associated with a DAE) may include one or more antennas. The antenna(s) may be pre-constructed. The antenna(s) may be attached to, or embedded in, the DAE, e.g., either on the surface on or in the DAE interior. An antenna may be configured such that the structure of a DAE (or building structural element) may serve as an antenna component. For example, a conductive metal piece of a mullion may serve as an antenna element or ground plane. In some embodiments, a portion of a DAE or building structural element is removed (or added) so that the remaining portion serves as a tuned antenna element. For example, a part of a mullion may be punched out to provide a tuned antenna element. By attaching cable(s) (e.g., coaxial or other cables), an RF transmitter, and/or an RF receiver, the building structural element and/or an associated DAE may serve as an antenna element. The antenna components may be designed with an impedance (e.g., of at least about 50 ohms) that matches that of the RF transmitter.

Depending on construction, the antenna element may be a Wi-Fi antenna, a Bluetooth antenna, a cellular communication antenna, etc. The antenna may be configured for at least a third generation (3G), fourth generation (4G), or fifth generation (5G) communication protocol. In some embodiments, the antenna transmits and/or receives in the radio frequency portion of the electromagnetic spectrum. The antenna may be a patch antenna, a monopole antenna, a dipole antenna, etc. It may be configured to transmit or receive electromagnetic signals in any appropriate wavelength range. Examples of antenna, its components, and its integration in the enclosure (e.g., building) and its components (e.g., optically switchable window) can be found in International Patent Application Serial No. PCT/US17/31106, filed May 4, 2017, which was previously incorporated herein by reference in its entirety.

In some embodiments, a camera of a DAE is configured to capture images, e.g., in the visible portion of the electromagnetic spectrum. For example, the camera may provide images in low resolution, e.g., low definition (e.g., 24×32 pixels). For example, the camera may provide images in high resolution, e.g., high definition (e.g., 4K camera). The camera may have a horizontal resolution of at least about 24 pixels, 32 pixels, 720 pixels, 1080 pixels, or 3840 pixels. The camera may have a horizontal display resolution of approximately 4,000 pixels. The camera resolution may provide images that have at least 24 pixels by at least 32 pixels, at least 1280 pixels by at least 720 pixels (e.g., at least about 921,600 pixels), that have at least 1920 pixels by at least 1080-pixel (e.g., at least about 2.1 megapixels), at least about 3840 pixels by at least about 2160 pixels, or at least 4096 by at least about 2160 pixels. The number of pixels of the camera can be at least about 800 pixels, 0.5 megapixels (MP), 1 MP, 1.5MP, 2MP, 2.5MP, 3MP, 4MP, 5MP, 6MP, 7MP, 8MP, 9MP, 10MP, or 15MP. The camera resolution may be any camera resolution between the aforementioned values (e.g., from about 0.5 MP to about 15MP). In some embodiments, the camera captures images having information about the intensity of wavelengths outside the visible range. For example, a camera may be able capture infrared signals. For example, a camera may be able capture ultraviolet signals. In some embodiments, a DAE includes a near infrared device such as a forward looking infrared (FLIR) camera or near-infrared (NIR) camera. Examples of suitable infrared cameras include the Boson™ or Lepton™ from FLIR Systems, of Wilsonville, OR. Such infrared cameras may be employed to augment a visible camera in a DAE.

In some embodiments, one or more sensors (e.g., of a camera such as an IR camera) is configured to map a heat signature of an enclosure or portion thereof (e.g., a room) such that it may serve as a temperature sensor, e.g., with three-dimensional awareness. In some embodiments, such cameras in a device ensemble (e.g., DAE) enable occupancy detection, augment visible cameras to facilitate detecting a human instead of a hot wall, and/or provide quantitative measurements of solar heating (e.g., image the floor or desks and see what the sun is actually illuminating).

In some embodiments, a speaker, microphone, and associated logic are configured to use acoustic information to characterize air quality and/or air conditions. As an example, an algorithm (of a logic scheme) may issue ultrasonic pulses, and facilitate (e.g., direct) detection of the transmitted and/or reflected pulses coming back to a microphone. This or another algorithm, may be configured to analyze, or direct analysis of, the detected acoustic signal, sometimes using a transmitted vs. received differential audio signal, e.g., to determine air density, and/or particulate deflection to characterize air quality.

In some embodiments, locally-initiated, in-facility wireless emergency alerts are provided. WEA messages may be initiated at a control interface of a facility (e.g., an emergency control panel, a security system control panel, a sensor monitoring panel, and/or an electrical power distribution box). The WEA messages may be forwarded to User Equipments (UEs) within an emergency incident area of the building.

In some embodiments, a local first responder generates a WEA message and provides it to the emergency (e.g., fire, flood, electrical, and/or health) control panel of the facility. The emergency control panel may also accept a WEA message instruction from a first responder specifying the emergency incident area (e.g., the facility including the building, one or more floors of the facility, one or more rooms of the facility, and/or an area surrounding the facility).

In some embodiments, an apparatus includes a processor and a memory coupled with the processor, e.g., for effectuating operations. The operations include (1) receiving an event from a facility (e.g., building) safety alarm system; (2) obtaining an in-facility location identifying where the event occurred; (3) obtaining a category for the event; (4) mapping the location of the event to one or more in-facility small cells to be used to transmit WEA messages to UEs within the emergency incident area of the facility; (5) generating a WEA message for each of the mapped in-facility small cells in response to the in-facility location and the category of the event; and/or (6) sending the WEA message to the mapped in-facility small cells for distribution to the UEs within the emergency incident area of the facility.

In some embodiments, a wireless emergency alert (WEA) message is accepted at an interface. A WEA instruction can be accepted at the interface. The WEA instruction can specify an emergency incident area for an emergency event. The WEA message can be forwarded to one or more UEs within the specified emergency incident area.

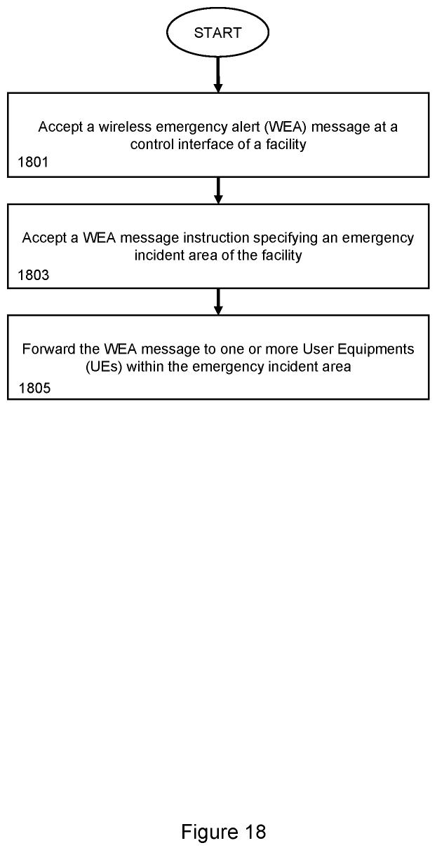

FIG. 18 shows an example of a flowchart depicting acceptance and processing of wireless alert messages. At block 1801, a WEA message is accepted at a control interface of a facility. At block 1803, a WEA message instruction is accepted. The WEA instruction may specify an emergency incident area of the facility. At block 1805, the WEA message is forwarded to one or more UEs within the emergency incident area.

In some embodiments, a sensor is operatively coupled to the control system. The sensor may be included in a device ensemble (e.g., in a DAE). In some embodiments, the sensor is configured to sense a parameter. The parameter may comprise temperature, particulate matter, volatile organic compounds, electromagnetic energy, pressure, acceleration, time, radar, lidar, glass breakage, movement, or gas. The gas may comprise a Nobel gas. The gas may be a gas harmful to an average human. The gas may be a gas present in the ambient atmosphere (e.g., oxygen, carbon dioxide, ozone, chlorinated carbon compounds, or nitrogen). The gas may comprise radon, carbon monoxide, hydrogen sulfide, hydrogen, oxygen, water (e.g., humidity). The electromagnetic sensor may comprise an infrared, visible light, ultraviolet sensor. The infrared radiation may be passive infrared radiation (e.g., black body radiation). The electromagnetic sensor may sense radio waves. The radio waves may comprise wide band, or ultra-wideband radio signals. The radio waves may comprise pulse radio waves. The radio waves may comprise radio waves utilized in communication. The gas sensor may sense a gas type, flow (e.g., velocity and/or acceleration), pressure, and/or concentration. The readings may have an amplitude range. The readings may have a parameter range. For example, the parameter may be electromagnetic wavelength, and the range may be a range of detected wavelengths.

In some embodiments, a control system is disposed in an enclosure such as a facility. The control system may include, or be operatively coupled to, a building management system (BMS). The facility can comprise a building such as a multistory building. The control system may functions at least to control the environment in the building. The control system and/or BMS may control at least one environmental characteristic of the enclosure. The at least one environmental characteristic may comprise temperature, humidity, fine spray (e.g., aerosol), sound, electromagnetic waves (e.g., light glare, and/or color), gas makeup, gas concentration, gas speed, vibration, volatile compounds (VOCs), debris (e.g., dust), or biological matter (e.g., gas borne bacteria and/or virus). The gas(es) may comprise oxygen, nitrogen, carbon dioxide, carbon monoxide, hydrogen sulfide, Nitric oxide (NO) and nitrogen dioxide (NO2), inert gas, Nobel gas (e.g., radon), cholorophore, ozone, formaldehyde, methane, or ethane. For example, a BMS may control temperature, carbon dioxide levels, and/or humidity in an enclosure. Mechanical devices that can be controlled by a BMS and/or control system may comprise lighting, a heater, air conditioner, blower, or vent. To control the enclosure (e.g., building) environment, a BMS and/or control system may turn on and off one or more of the devices it controls, e.g., under defined conditions. A (e.g., core) function of a modern BMS and/or control system may be to maintain a comfortable, healthy, and/or productive environment for the occupant(s) of the enclosure, e.g., while minimizing energy consumption (e.g., while minimizing heating and cooling costs/demand). A BMS and/or control system can be used to control (e.g., monitor), and/or to optimize the synergy between various systems, for example, to conserve energy and/or lower enclosure (e.g., facility) operation costs.

In some embodiments, an event notification can be received from a control interface of a facility. The control interface of the facility may include an emergency control panel, a security system control panel, a sensor monitoring panel, and/or a facility safety alarm system and/or the electrical power distribution box. The emergency control panel may include the facility safety alarm system, and/or the electrical power distribution box. The emergency control panel may be configured to alert on instance(s) of extreme weather. The extreme weather may include hurricane, typhoon, flood, fire, tornado, blizzard, dust storm, hail-storm, ice storm, lightning storm. The emergency control panel may be configured to alert on instance(s) of health related hazard(s). The health related hazard(s) may comprise elevated levels of hazardous gas, hazardous volatile organic compounds (VOCs), and/or particulate matter (e.g., of particles of a size of about 2.5 micrometers or less). The emergency control panel may be configured to alert on instance(s) of active aggressor (e.g., terroristic activity, a military activity, a police activity, and/or other physical aggressor (e.g., shooter such as an active shooter) in the facility or in an immediate premise of the facility (e.g., within a block of the facility). The emergency control panel may be configured to alert on emergency instances in the municipality of the facility, or within a threshold distance from the facility (e.g., within at most 5 miles, 10 miles, 20 miles, 50 miles, or 100 miles), which thresholds may be dependent on the type of emergency, degree of risk to facility occupants, and/or pace of risk escalation with respect to occupants of the facility (e.g., degree of risk as a function of time and distance from the facility).

In some examples, one or more sensors in the enclosure are VOC sensors. A VOC sensor can be specific for a VOC compound (e.g., as disclosed herein), or to a class of compounds (e.g., having similar chemical characteristic). For example, the sensor can be sensitive to aldehydes, esters, thiophenes, alcohols, aromatics (e.g., benzenes and/or toluenes), or olefins. In some example, a group of sensors (e.g., sensor array) sensed various chemical compounds (VOCs) (e.g., having different chemical characteristics). The group of compound may comprise identified or non-identified compounds. The chemical sensor(s) can output a sensed value of a particular compound, class of compounds, or group of compounds. The sensor output may be of a total (e.g., accumulated) measurements of the class, or group of compounds sensed. The sensor output may be of a total (e.g., accumulated) measurements of multiple sensor outputs of (i) individual compounds, (ii) classes of compounds, or (iii) groups of compounds. The one or more sensors may output a total VOC output (also referred to herein as TVOC). Sensing can be over a period of time. VOCs may arise from human and/or other sources, e.g., perspiration of non-humans, or aldehydes from carpet and/or furnishing.

In some embodiments, at least one of the atmospheric components is a VOC. The atmospheric component (e.g., VOC) may include benzopyrrole volatiles (e.g., indole and skatole), ammonia, short chain fatty acids (e.g., having at most six carbons), and/or volatile sulfur compounds (e.g., Hydrogen sulfide, methyl mercaptan (also known as methanethiol), dimethyl sulfide, dimethyl disulfide and dimethyl trisulfide). The atmospheric component (e.g., VOC) may include 2-propanone (acetone), 1-butanol, 4-ethyl-morpholine, Pyridine, 3-hexanol, 2-methyl-cyclopentanone, 2-hexanol, 3-methyl-cyclopentanone, 1-methyl-cyclopentanol, p-cymene, Octanal, 2-methyl-cyclopentanol, Lactic acid, methyl ester, 1,6-heptadien-4-ol, 3-methyl-cyclopentanol, 6-methyl-5-hepten-2-one, 1-methoxy-hexane, Ethyl (−)-lactate, Nonanal, 1-octen-3-ol, Acetic acid, 2,6-dimethyl-7-octen-2-ol (dihydromyrcenol), 2-ethyl hexanol, Decanal, 2,5-hexanedione, 1-(2-methoxypropoxy)-2-propanol, 1,7,7-trimethylbicyclo[2·2· 1]heptan-2-one (camphor), Benzaldehyde, 3,7-dimethyl-1,6-octadien-3-ol (linalool), 1-methyl hexyl acetate, Propanoic acid, 6-hydroxy-hexan-2-one, 4-cyanocyclohexene, 3,5,5-trimethylcyclohex-2-en-1-one (isophoron), Butanoic acid, 2-(2-propyl)-5-methyl-1-cyclohexanol (menthol), Furfuryl alcohol, 1-phenyl-ethanone (acetophenone), Isovaleric acid, Ethyl carbamate (urethane), 4-tert-butylcyclohexyl acetate (vertenex), p-menth-1-en-8-ol (alpha-terpineol), Dodecanal, 1-phenylethylester acetic acid, 2(5H)-furanone, 3-methyl, 2-ethylhexyl 2-ethylhexanoate, 3,7-dimethyl-6-octen-1-ol (citronellol), 1,1′-oxybis-2-propanol, 3-hexene-2,5-diol, 3,7-dimethyl-2,6-octadien-1-ol (geraniol), Hexanoic acid, Geranylacetone 3,2,4,6-tri-tert-butyl-phenol, Unknown, 2,6-bis(1,1-dimethylethyl)-4-(1-oxopropyl)phenol, Phenyl ethyl alcohol, Dimethylsulphonec, 2-ethyl-hexanoic acid, Unknown, Benzothiazole, Phenol, Tetradecanoic acid, 1-methylethyl ester (isopropyl myristate), 2-(4-tert-butylphenyl)propanal (p-tert-butyl dihydrocinnamaldehyde), Octanonic acid, α-methyl-ß-(p-tert-butylphenyl)propanal (lilial), 1,3-diacetyloxypropan-2-yl acetate (triacetin), p-cresol, Cedrol, Lactic acid, Hexadecanoic acid, 1-methylethyl ester (isopropyl palmitate), 2-hydroxy, hexyl ester benzoic acid (hexyl salicylate), Palmitic acid, ethyl ester, Methyl 2-pentyl-3-oxo-1-cyclopentyl acetate (methyl dihydrojasmonate or hedione), 1,3,4,6,7,8-hexahydro-4,6,6,7,8,8-hexamethyl-cyclopenta-gamma-2-benzopyran (galaxolide), 2-ethylhexylsalicylate, Propane-1,2,3-triol (glycerin), Methoxy acetic acid, dodecyl ester, α-hexyl cinnamaldehyde, Benzoic acid, Dodecanoic acid, 5-(hydroxymethyl)-2-furaldehyde, Homomethylsalicylate, 4-vinyl imidizole, Methoxy acetic acid, tetradecyl ester, Tridecanoic acid, Tetradecanoic acid, Pentadecanoic acid, Hexadecanoic acid, 9-hexadecanoic acid, Heptadecanoic acid, 2,6,10,15,19,23-hexamethyl-2,6, 10, 14, 18,22-tetracosahexaene (squalene), Hexadecanoic acid, and/or 2-hydroxyethylester.

In some embodiments, a particulate matter sensor is operatively coupled to the control system. The particulate matter sensor may use sensing an optical density of a body of gas (e.g., air), e.g., through which an energy beam travels. The particular matter sensor may measure a dispersion (e.g., dispersion pattern) of the energy beam as it travels through the body of gas. The particulate matter sensor may measure an intensity (e.g., an optical density) of the energy beam after it has passed through the body of gas, e.g., as compared to that of the energy beam as it is entering into the body of gas (e.g., as it is emitted from the energy source such as from a laser). The particulate matter sensor may utilize an energy beam that travels through a body of gas, e.g., and is dispersed on encountering a particulate matter in that body of gas (e.g., air). The energy beam may comprise a laser beam. The laser beam may be configured to an energy of at least 500 nanometers (nm), 525 nm, 550 nm, 600 nm, 650 nm, 660 nm, 700 nm, 750 nm, or 800 nm. The energy beam may comprise an infrared (IR) energy beam. The particulate matter may see at a frequency of every 1 second (sec), 2.5 sec, 5 sec, 7.5 sec, 10 sec, 20 sec, 30 sec, or 60 sec. The particulate matter may be configured to sense at least nanometer, or micrometer sized particles. The particulate matter sensed by a particulate matter sensor may comprise particles of a FLS (e.g., diameter or diameter of its bounding circle) of at least a nanometer or a micrometer scale. For example, the particulate matter sensed by the particulate matter sensor may be of a FLS of at least 1 micrometer (μm), 2 μm, 2.5 μm, 5 μm, 7 μm, 10 μm, or 20 μm. The particulate matter sensed by the particulate matter sensor may be of any value between the aforementioned values, e.g., from about 1 μm (PM1) to about 20 μm (PM20), from about 1 μm (PM1) to about 5 μm (PM5), from about 2.5 μm (PM2.5) to about 10 μm (PM10), or from about 5 μm (PM5) to about 20 μm (PM20). The particulate matter sensor alone or in conjunction with data of other sensor(s) (e.g., VOC sensor, light sensor, noise sensor, and/or ulpersonnel ID sensor) may be utilized to monitor, notify, and/or optimize cleaning service in a facility. For example, the sensor(s) may be utilized to alert that a cleaning service is required in a portion (e.g., an enclosure) of a facility, e.g., based on sensing elevated foul odor, elevated particulate matter, and/or high number of personnel (e.g., beyond a threshold value, and/or as a function of time such as at a certain timespan).

A location (specific location including an area) at which the event occurred, may be identified. A category for the event may be obtained. The category may include weather, health, electrical, or human aggressor. An emergency incident location (e.g., area) for the event can be determined. The emergency incident area may be mapped to one or more small cells. A WEA message can be sent to the mapped one or more small cells. The mapped one or more small cells can distribute the WEA message to one or more UEs within the emergency incident area.

In some embodiments, the event notification is received automatically (e.g., using, or directed by, the control system). The notification may arise due to one or more sensors of the facility being activated, such as a response to a feedback control scheme trigged by the sensor measurements. In some embodiments, the event notification can be entered by a First Responder, building manager, and/or by a superintendent.

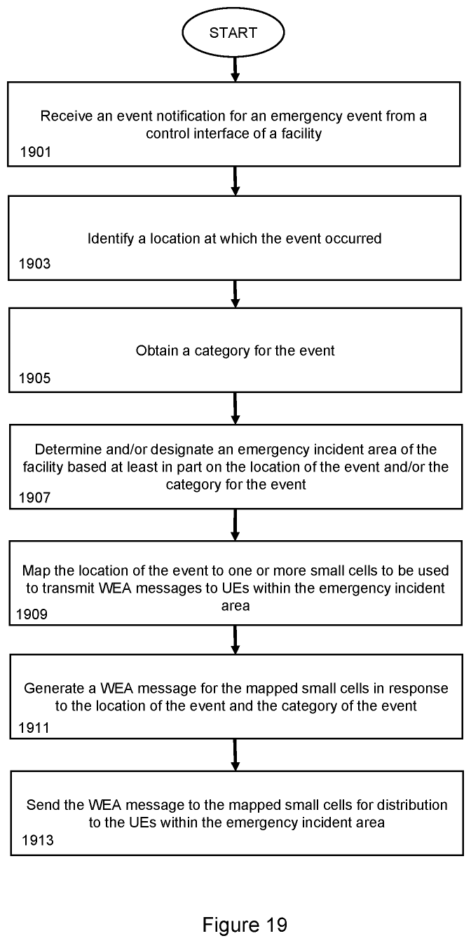

FIG. 19 is an example of a flowchart depicting a method for processing event notifications including blocks 1901-1913.

At block 1901, an event notification for an emergency event (e.g., a fire, a water leak, an explosion, an earthquake, a tornado, a hurricane, a storm, a deranged individual who is armed, a terrorist attack, a release of a hazardous substance, a report of a bomb) is received from a control interface of a facility.

At block 1903, an (e.g., in-facility) location at which the event occurred is identified. The location can be identified using known location(s) of triggered sensor(s). The location can be identified using on-site observations. The event may occur external to the facility, but may have the potential for causing damage to the interior or structure of the facility (e.g., an earthquake, tornado, bomb exploding outside the building, or hurricane-force winds blowing out windows).

At block 1905, a category for the event is obtained. The category can be obtained based upon the type(s) of sensor(s) that were triggered by the event. The category can be obtained by means of on-site observations. Such observations may be conducted, for example, by First Responders, facility superintendents, and/or facility managers. The category can be obtained based at least in part upon the location at which the event occurred. For example, the location may include areas or rooms designed to house fuel storage tanks. The location may include areas or rooms designed to house electrical equipment and switching. The location may include areas or zones used for industrial machinery, or used to perform certain industrial processes (e.g., a lab in a semiconductor fabrication shop that uses specific hazardous materials—GaAs, etc.). The category can be obtained by comparing one or more parameters of the event to a database of event parameters. The category can be manually entered by a First Responder, facility superintendent, facility manager, event coordinator, and/or other personnel.

At block 1907, an emergency incident area of the facility is determined and/or designated, based at least in part on the location of the event, and/or the category for the event. The emergency incident area can be within the facility. The emergency incident area may be floor-based. For example, a floor including the location where the event occurred may be designated as the emergency incident area. A portion of the floor including the location where the event occurred may be designated as the emergency incident area. An entire floor that includes the location where the event occurred, and one or more floors above the location and one or more floors below the location, may be designated as the emergency incident area. A portion of a floor that includes the location where the event occurred, and a portion of one or more adjoining floors above, below, or adjacent to the location where the event occurred, may be designated as the emergency incident area.

In some embodiments, the emergency incident area is based at least in part on zone allocation to the facility. The zone may include various rooms (e.g., offices) and/or passage ways. The emergency incident area may be room-based. For example, the room in which the event occurred may be designated as the emergency incident area. A group of rooms (e.g., forming a zone) in which the event occurred may be designated as the emergency incident area. In some embodiments, the emergency incident area may encompass area(s) outside of the facility. For example, a fixed radius around the location where the event occurred may be designated as the emergency incident area. The emergency incident area may be designated based at least in part on a risk of harm (e.g., as a function of time and space). For example, the risk of harm may relate to the weather conditions (e.g., wind direction) and their alteration with respect to time and space (e.g., their evolution as affecting the location of the facility). The emergency incident area may be designated based on seismic conditions (e.g., tremors), and/or their time and space evolution, e.g., with respect to the facility. The emergency incident area may be designated based at least in part on a prevailing direction of groundwater flow (e.g., applicable in case of an industrial accident where a plume of toxic material (e.g., Tetrachloroethylene or other VOC) is released into the environment, and/or the time and space evolution (e.g., propagation) of such release, e.g., with respect to the facility.

In some embodiments, the emergency incident area may encompass areas within the facility enclosure(s) and areas outside of the facility enclosure(s) (e.g., in the facility premises). The facility enclosure may comprise a building. The facility premises outside of the enclosures may comprise parking lot(s) and/or garden(s). The emergency incident area may be defined by combining the following: (1) floor-based; (2) room-based; (3) fixed radius around the location where the event occurred; and/or (4) risk of incident. The risk of the incident may include time and/or space evolution (e.g., propagation) of the incident. The risk of the incident may include the type of the incident (e.g., related to weather, armed person(s), weaponry, electrical, and/or health). The weaponry may comprise bomb, missile, firearm, rocket, sword, spear, torpedo, rifle, grenade, artillery, aircraft, biological weapon, or chemical weapon. In some embodiments, the emergency incident area may be specified by First Responder, and/or specified by Facility Superintendent or Manager.

At block 1909, the location of the event is mapped to one or more small cells that are to be used to transmit WEA message(s) to UE(s) within the emergency incident area. In some embodiments, this mapping is performed using digitized (radio frequency (RF)) coverage maps of the facility (e.g., using iBwave, SPLAT, or another RF propagation algorithm), e.g., to identify one or more (e.g., small) cells predicted to provide the highest received signal level(s) and/or the highest signal to interference and noise ratio (SINR) within the emergency incident area. In some embodiments, one or more groupings of (e.g., small) cells are allocated to serve specifically designated floor(s), room(s), and/or areas of the facility.

At block 1911, a WEA message is generated for the mapped (e.g., small) cells in response to a location of the event, affected facility zone(s), a category of the event, and optionally risk of the event (e.g., including time and/or space evolution of the event). The risk assessment may include forecasting an evolution (e.g., preparation) of the event in time and/or space. In some embodiments, the WEA message can be generated by filling in a pre-generated template retrieved from computer memory. In some embodiments, the WEA message can be generated by automatically selecting an appropriate message from a pre-stored menu. In some embodiments, the WEA message can be generated by means of a First Responder, Facility Superintendent, and/or Manager completing a pre-generated template. In some embodiments, the WEA message can be generated by means of the First Responder, Facility Superintendent, and/or Manager selecting an appropriate message from a pre-stored menu. The WEA message is sent to the mapped (e.g., small) cells for distribution to the UEs within the emergency incident area at block 1913.

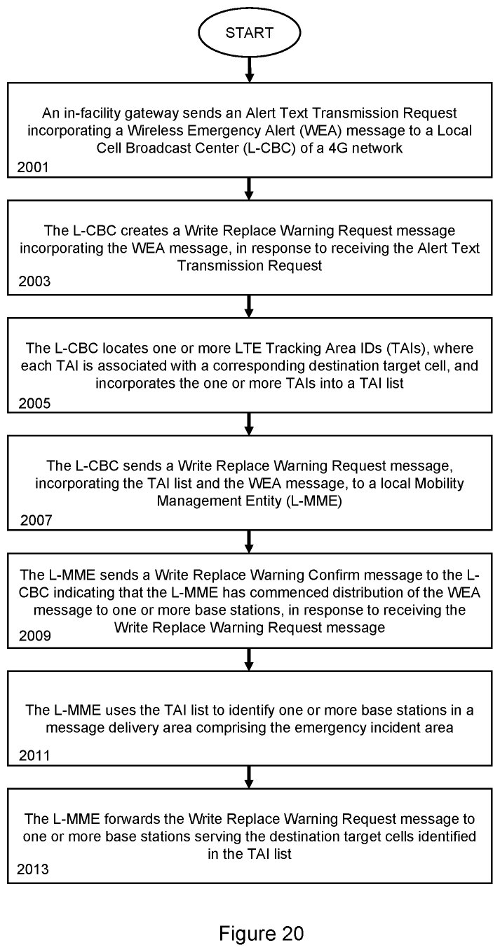

FIG. 20 shows an example of a flowchart depicting a method for distributing a wireless alert message in a 4G (e.g., 4G LTE) wireless communication system. At block 2001, an in-facility gateway sends an Alert Text Transmission Request to a Local Cell Broadcast Center (L-CBC) of a 4G network. The Alert Text Transmission request incorporates the WEA message. Next, at block 2003, the L-CBC creates a Write Replace Warning Request message in response to receiving the Alert Text Transmission Request. The Write Replace Warning Request Message incorporates the WEA message. At block 2005, the L-CBC finds one or more LTE Tracking Area IDs (TAIs), where each TAI is associated with a corresponding destination target cell. The one or more TAIs are incorporated into a TAI list. In some embodiments, the operations of block 2005 can be executed in 4G implementations where a unique TAI exists for each cell. At block 2007 where the L-CBC sends a Write Replace Warning Request message, incorporating the TAI list and the WEA message, to a Local Mobility Management Entity (L-MME). At block 2009, the L-MME sends a Write Replace Warning Confirm message to the L-CBC in response to receiving the Write Replace Warning Request. The Write Replace Warning Confirm message indicates to the L-CBC that L-MME has started to distribute the WEA message to one or more 4G eNodeBs (e.g., 4G base stations). At block 2011, the L-MME uses the TAI list to determine/identify one or more eNodeB's (e.g., 4G base stations) in a message delivery area comprising the emergency incident area. At block 2013, the L-MME then forwards the Write Replace Warning Request (including the WEA message) to the one or more eNodeB's (e.g., 4G base stations) serving the destination target cells identified in the TAI list.

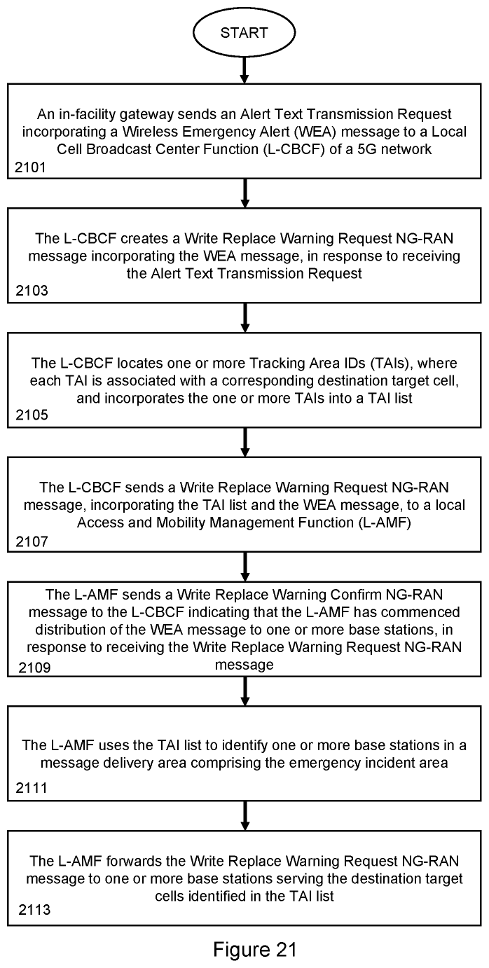

FIG. 21 shows an example of a flowchart depicting a method for distributing a wireless alert message in a 5G (e.g., 5G NR) wireless communication system. At block 2101, an in-facility gateway sends an Alert Text Transmission Request to a Local Cell Broadcast Center Function (L-CBCF) of a 5G network. The Alert Text Transmission request incorporates the WEA message. At block 2103, the L-CBCF creates a Write Replace Warning Request NG-RAN message in response to receiving the Alert Text Transmission Request. The Write Replace Warning Request NG-RAN Message incorporates the WEA message. At block 2105, the L-CBCF finds one or more Tracking Area IDs (TAIs), where each TAI is associated with a corresponding destination target cell. The one or more TAIs are incorporated into a TAI list.

In some embodiments, the operations of block 2105 are executed in 5G implementations where a unique TAI exists for each cell. At block 2107 the L-CBCF sends a Write Replace Warning Request NG-RAN message, incorporating the TAI list and the WEA message, to a Local Access and Mobility Management Function (L-AMF). At block 2109, the L-AMF sends a Write Replace Warning Confirm NG-RAN message to the L-CBCF in response to receiving the Write Replace Warning Request NG-RAN message. The Write Replace Warning Confirm NG-RAN message indicates to the L-CBCF that L-AMF has started to distribute the WEA message to one or more 5G gNodeBs (e.g., 5G base stations). At block 2111, the L-AMF uses the TAI list to determine/identify one or more gNodeB's (e.g., 5G base stations) in a message delivery area comprising the emergency incident area. At block 2113, the L-AMF forwards the Write Replace Warning Request NG-RAN message (incorporating the WEA message) to the one or more 5G gNodeB's identified in the TAI list.

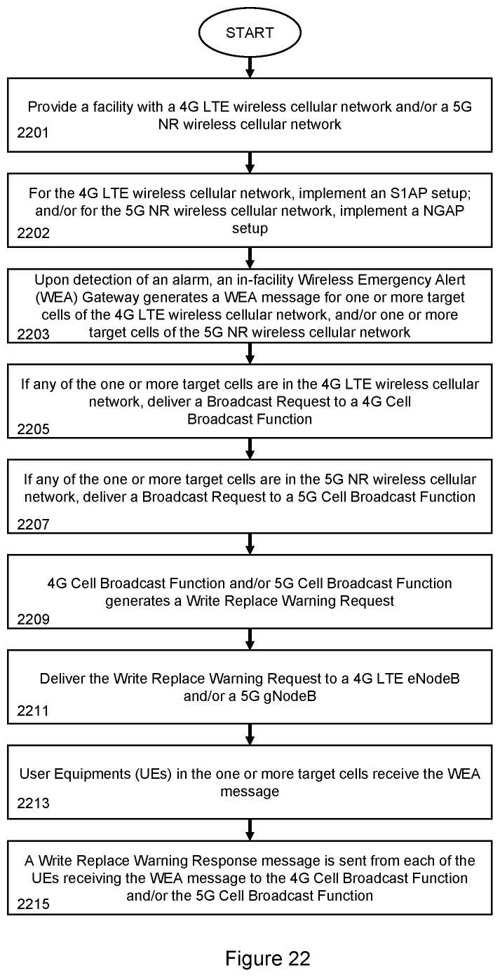

FIG. 22 shows an example of a flowchart depicting a method for distributing a wireless alert message in a communication system that provides a combination of 4G cells and 5G cells. At block 2201, a building is provided with a 4G and/or a 5G wireless cellular network. At block 2202, an S1AP setup is implemented for the 4G wireless cellular network, and/or an NGAP setup with (e.g., in-facility) 5G Cell Broadcast is implemented for the 5G wireless cellular network. At block 2203, upon detection of an (e.g., fire) alarm, an in-facility WEA Gateway generates a WEA message for one or more target cells (e.g., small cells) of the 4G and/or 5G wireless cellular network. At block 2205, if any of the one or more target cells are in the 4G wireless cellular network, a Broadcast Request is delivered to an (e.g., in-facility) 4G Cell Broadcast function. At block 2207, if any of the one or more target cells are in the 5G wireless cellular network, a Broadcast Request is delivered to an (e.g., in-facility) 5G Cell Broadcast Function. At block 2209 the 4G Cell Broadcast Function and/or the 5G Cell Broadcast Function generate(s) a Write Replace Warning Request. At block 2211, the Write Replace Warning Request is delivered to a 4G eNodeB and/or a 5G gNodeB. At block 2213, UEs in the one or more target cells receive the WEA message. At block 2215, a Write Replace Warning Response message is sent from each of the UE(s) receiving the WEA message to the 4G Cell Broadcast Function and/or the 5G Cell Broadcast Function. In some embodiments, the procedure of FIG. 22 is used to perform automatic triggering of WEA messages.

In some embodiments, various environmental characteristics of the enclosure are controlled (e.g., monitored and/or adjusted). These characteristics can be controlled to provide an optimized occupant environment (e.g., in terms of wellness, health, and/or comfort). The one or more environmental characteristics may be monitored by sensor(s). The sensor(s) may be disposed in the enclosure. One or more models may be constructed using baseline readings and/or 3D schematics of the space. At least one controller (e.g., a control system) and/or a processor can use one or more AI algorithm(s). The AI algorithms may comprise predictive extrapolation. The predictive extrapolation may be based at least in part on trend, and/or expected physical parameters. The AI algorithm(s) may be utilized to further refine the models using sensor readings of the enclosure space. The AI algorithm(s) may be utilized to control the environment of the enclosure. Controlling the environment may include directly or indirectly controlling any device. The device can be operatively coupled with the building (e.g., HVAC). Indirect control may comprise using a building management system (BMS). The BMS may or may not be communicatively coupled to the controller(s). The BMS may or may not be communicatively coupled to the processor(s). The AI modeling of the enclosure space may include locations on a grid. The AI modeling of the enclosure space may utilize locations on a grid. The locations of the grid may have a different (e.g., higher or lower) spatial resolution than the spacing of the sensors.

In some embodiments, an enclosure includes one or more sensors. The sensor may facilitate controlling the environment of the enclosure, e.g., such that inhabitants of the enclosure may have an environment that is more comfortable, delightful, beautiful, healthy, productive (e.g., in terms of inhabitant performance), easer to live (e.g., work) in, or any combination thereof. The sensor(s) may be configured as low or high resolution sensors. Sensor may provide on/off indications of the occurrence and/or presence of an environmental event (e.g., one pixel sensors). In some embodiments, the accuracy and/or resolution of a sensor may be improved via artificial intelligence (abbreviated herein as “AI”) analysis of its measurements. Examples of artificial intelligence techniques that may be used include: reactive, limited memory, theory of mind, and/or self-aware techniques).

In some embodiments, the sensor data analysis comprises linear regression, least squares fit, Gaussian process regression, kernel regression, nonparametric multiplicative regression (NPMR), regression trees, local regression, semiparametric regression, isotonic regression, multivariate adaptive regression splines (MARS), logistic regression, robust regression, polynomial regression, stepwise regression, ridge regression, lasso regression, elasticnet regression, principal component analysis (PCA), singular value decomposition, fuzzy measure theory, Borel measure, Han measure, risk-neutral measure, Lebesgue measure, group method of data handling (GMDH), Naive Bayes classifiers, k-nearest neighbors algorithm (k-NN), support vector machines (SVMs), neural networks, support vector machines, classification and regression trees (CART), random forest, gradient boosting, or generalized linear model (GLM) technique. Sensors may be configured to process, measure, analyze, detect and/or react to: data, temperature, humidity, sound, force, pressure, concentration, electromagnetic waves, position, distance, movement, flow, acceleration, speed, vibration, dust, light, glare, color, gas(es) type, and/or other aspects (e.g., characteristics) of an environment (e.g., of an enclosure). The gases may include volatile organic compounds (VOCs). The gases may include carbon monoxide, carbon dioxide, water vapor (e.g., humidity), oxygen, radon, and/or hydrogen sulfide. The one or more sensors may be calibrated in a factory setting and/or in the facility. A sensor may be optimized to performing accurate measurements of one or more environmental characteristics present in the factory setting and/or in the facility in which it is deployed.

In some embodiments, a processor interfaces with actuators and/or sensors. This interfacing may be provided for control purposes. The processor may include a hierarchy of controllers. The processor may control an enclosure such as a smart building. A smart building can be any structure that uses one or more automated processes to automatically control the operation of the building. These automated processes can include heating, ventilation, air conditioning, lighting, security, window blind controls, and/or other systems. The smart building may use sensors, actuators and/or microchips to collect data. The smart building can use this data to manage the environment of the building. This infrastructure may help owners, operators and facility managers to enhance the comfort of building occupants. Energy use may be reduced. The manner in which space is used may be improved. The environmental impact of buildings can be reduced.

In some embodiments, the enclosure may have interacting systems. The enclosure can be a facility, a room, and/or a collection of portions of multiple buildings. The enclosure can be any enclosure disclosed herein. The processor may operate in a network environment, e.g., the processor may be operatively (e.g., communicatively and/or physically) coupled to a network. The network environment may be configured for remote (e.g., Cloud) interaction. The remote interaction may include users and/or a service provider. The network environment may include wired and/or wireless communication. The processor may execute a control scheme. The control scheme may include feed forward, fast forward, open loop, and/or closed loop. The processor may control the BMS and/or any controllable device such as a sensor, emitter, antenna, or tintable window (e.g., an IGU). The controllable device may include optically controllable electrochromic devices. The processor may be communicatively coupled to sensors and/or emitters. Multiple sensors, emitters, actuators, transmitters, and/or receivers may be integrated into a single assembly. The single assembly may be provided in the form of a digital architectural element. The general processor may be communicatively coupled to other output devices. The other output devices may include an HVAC system and/or one or more antennas.

In some embodiments, processing data derived from the sensor comprises applying one or more models. The models may comprise a mathematical model. The processing may comprise fitting of model(s) (e.g., curve fitting). The model may be multi-dimensional (e.g., two or three dimensional). The model may comprise a linear or non-linear equation. The model may comprise an exponential or logarithmic equation. The model may comprise one or more Boolean operations. The model may consider the enclosure. Considering the enclosure may include the structure and/or makeup of the enclosure. Makeup of the enclosure may comprise material makeup of any fixture and/or non-fixture the model in the enclosure. The model may consider a Building Information Modeling (BIM) (e.g., Revit file) of the enclosure before, during, and/or after its construction. The model may consider a two dimensional (e.g., floor plan) and/or three dimensional modeling (e.g., 3D model rendering) of the enclosure. The model may or may not comprise a finite element analysis. The model may comprise, or be utilized in, a simulation. The simulation may be of at least one environmental characteristic of at least a portion of enclosure (e.g., depicting status in various positions in the enclosure such as a POI). The model may be represented as a graph (e.g., 2 or 3 dimensional graph). For example, the model may be represented as a contour map. The modeling may comprise one or more matrices. The model may comprise a topological model. The model may relate to a topology of the sensed parameter in the enclosure. The model may relate to a time variation of the topology of the sensed parameter in the enclosure. The model may be environmental and/or enclosure specific. The model may consider one or more properties of the enclosure (e.g., dimensionalities, openings, and/or environmental disrupters (e.g., emitters)). Processing of the sensor data may utilize historical sensor data, and/or current (e.g., real time) sensor data. The data processing (e.g., utilizing the model) may be used to project an environmental change in the enclosure, and/or recommend actions to alleviate, adjust, or otherwise react to the change.

In some embodiments, the model of the enclosure comprises the architecture of a building (e.g., including one or more fixtures). The model may be a 3D model. The model may identify one or more materials of which these fixtures are comprised. The model may comprise Building Information Modeling (BIM) software (e.g., Autodesk Revit) product (e.g., file). The BIM product may allow a user to design a building with parametric modeling and drafting elements. In some embodiments, the BIM is a Computer Aided Design (CAD) paradigm that allows for intelligent, 3D and/or parametric object-based design. The BIM model may contain information pertaining to a full life cycle for a building, from concept to construction to decommissioning. This functionality can be provided by the underlying relational database architecture of the BIM model, that may be referred to as the parametric change engine. The BIM product may use .RVT files for storing BIM models. Parametric objects—whether 3D building objects (such as windows or doors) or 2D drafting objects—may be referred to as families, can be saved in RFA files, and can be imported into the RVT database. There are many sources of pre-drawn RFA libraries.

The BIM (e.g., Revit) may allow users to create parametric components in a graphical “family editor.” The model can capture relationships between components, views, and annotations, such that a change to any element is automatically propagated to keep the model consistent. For example, moving a wall updates neighboring walls, floors, and roofs, corrects the placement and values of dimensions and notes, adjusts the floor areas reported in schedules, redraws section views, etc. The BIM may facilitate continuous connection, updates, and/or coordination between the model and (e.g., all) documentation of the facility, e.g., for simplification of update in real time and/or instant revisions of the model. The concept of bi-directional associativity between components, views, and annotations can be a feature of BIM.

The BIM model can use a single file database that can be shared among multiple users. Plans, sections, elevations, legends, and schedules can be interconnected. The BIM can provide (e.g., full) bi-directional associativity. Thus, if a user makes a change in one view, the other views can be automatically updated. Likewise, BIM files can be updated automatically in response to an input received from a sensor. BIM drawings and/or schedules can be fully coordinated in terms of the building objects shown in drawings. A base facility (e.g., building) can be drawn using 3D objects to create fixtures (e.g., walls, floors, roofs, structure, windows, and/or doors) and other objects as needed. The BIM model (e.g., BIM virtual model, or BIM virtual file) can incorporate information regarding the structure and/or material associated with the facility. Generally, if a component of the design is going to be seen in more than one view, it can be created using a 3D object. Users can create their own 3D and 2D objects for modeling and drafting purposes. Small-scale views of building components may be created using a combination of 3D and 2D drafting objects, or by importing drafting work done in another computer aided design (CAD) platform, for example, via DWG, DXF, DGN, SAT or SKP.

In some embodiments, when a project database is shared using BIM, a central file can be created which stores a master copy of the project database on a file server. A user can work on a copy of the central file (known as the local file), stored on his/her workstation. Users can save to the central file to update the central file with their changes, and to receive changes from other users, the BIM model can check with the central file whenever a user starts working on an object in the database to see if another user is editing the object. This procedure may prevent two people from making the same change simultaneously and causing a conflict. Multiple disciplines working together on the same project can make their own project databases and link in databases from other consultants for verification. BIM can perform interference checking, which may detect if different components of the building are occupying the same physical space.

In some embodiments, when a structural change takes place in the facility, the BIM model may require manual updates to at least one document associated with the facility to document the change and remain updated. The control system (e.g., using the sensor(s)) of the facility) may (e.g., automatically) feed structural updates to the BIM model, to the AI engine, and/or to the physics engine. The structural updates fed by the control system may be done in real time (e.g., as the changes occur), or at a time in which the facility is not occupied (e.g., at night, during the weekend, or during a holiday). The update may be scheduled (e.g., pre-scheduled). The update may take place at a closest time frame to the structural change made (e.g., the first time in which the facility is idle after the structural change has been made). The update and/or sensor scan may be at a predetermined (e.g., pre-scheduled) intervals.

In some embodiments, one or more models (as disclosed herein) are used by the AI engine. The model may incorporate non-fixed materials, for example, water that occupies pipes, heat capacity of materials, optical absorbance/reflectivity, heat signature, acoustic properties, and/or outgassing/VoC's of materials versus temperature. The model may incorporate openings, time of day, sun angle, and/or penetration depth. The model may be applied to a scenario where room assignments and/or walls are unknown. The model may be applied to a scenario where a dry wall, hallway, open area, reception area, stairs, and/or a closed area are known. The model may include building elements such as fixtures and non-fixtures. The building elements may comprise partitions, walls, floors, roofs, structure, windows, doors, ceilings, cabinets, furniture, desks, cubicles, tables, chairs, ventilation ducts, electrical conduits, lighting fixtures, water supply lines, roof vents, and/or piping for utilities. The model may associate a fixture with one or more physical properties, such as a material for the fixture, a heat capacity for the fixture, an acoustical property for the fixture, and/or any of a number of other physical properties.

The model can include information about the energy-related characteristics of commercial and/or residential buildings. For example, as mentioned previously, the model can include information from a Building Performance Database (BPD) maintained by the U.S. Department of Energy. In some embodiments, the BPD combines, cleanses and/or anonymizes data collected from buildings by jurisdictional authorities (e.g., federal, state and local governments), utilities, energy efficiency programs, building owners and/or private companies. A variety of physical and operational characteristics for a plurality of building types can be stored in the BPD, e.g., to document trends in energy performance. The BPD can allow users to create and/or save customized datasets based on specific variables, e.g., including building types, locations, sizes, ages, equipment, and/or operational characteristics. The BPD can allow users to compare buildings using statistical or actuarial methods. The BPD can comprise a graphical web interface and/or a web API (application programming interface) that allows applications and/or services to dynamically query the BPD.

In some embodiments, an initial physics simulation is conducted to simulate propagation of the environmental characteristics in the enclosure. A separate simulation may be performed for an environmental characteristic (e.g., for each environmental characteristic). The AI model may be configured using outputs of the physics simulation. The AI model may be an AI engine comprising a neural network, or any other sensor analysis methodology and/or mathematical model disclosed herein. The physics simulation may be lengthy, for example, on the order of hours or days. The physics simulation may simulate the interior as well as the exterior of the enclosure. The physics simulation may simulate the (e.g., entire) interior environment of the enclosure. The interior environment may encompass areas beyond the perimeter skin of the enclosure. The interior of the enclosure may be simulated based at least in part on the grid of nodes (e.g., vertex points). The grid of vertex points may be an intersection of 3D grid lines. There may be any number of vertex points in the grid. The grid may have a constant density or a varied density. For example, at least one portion of the grid may have a higher density (e.g., adjacent to and including the POI). One or more sensors may be placed throughout the enclosure. The at least one of the sensors may be included in an ensemble of sensors (e.g., suite of sensors). The ensemble of sensors may comprise any device disclosed herein (e.g., sensor, emitter, controller, and/or antenna). The sensors may be disposed at coordinates of the grid. The grid may have a vertex occupied by at least one sensor. The grid may have a vertex devoid of any sensor.

In some embodiments, the model uses a variate model. The variate model may be a single-variate model or a multi-variate model. The single-variate model may be applicable to one type of environmental characteristic (and use corresponding one type of sensor data). The multi-variate model may be applicable to a plurality of environmental characteristic types (and use corresponding multiple types of sensor data). The multi-variate model may be applicable to one environmental characteristic type (and use multiple types of sensor data). The variate model may determine a missing value imputation. The missing value imputation may be used to increase the trust in a sensor reading (e.g., verify that the sensor reading is correct). The multi-variate model can use sensors reading of different properties (e.g., different environmental characteristics). The multi-variate model can use sensors reading at different portions of the enclosure (e.g., different rooms in a floor, different floors of a building, or different building of a facility). The single-variate model can use (e.g., only) one sensor property. The variate model may use anomaly detection of sudden spikes and/or outliers.

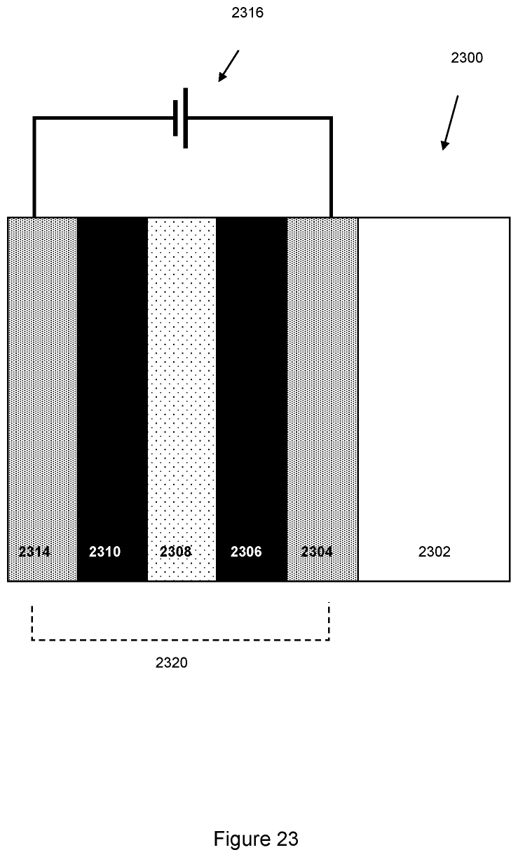

In some embodiments, the devices comprise tintable windows disposed in the facility. The tintable window may comprise an electrochromic device. The control system may be operatively coupled to the device(s) (e.g., to the tintable window(s)) of the facility. FIG. 23 shows an example of a schematic cross-section of an electrochromic device 2300 in accordance with some embodiments is shown in FIG. 23. The EC device coating is attached to a substrate 2302, a transparent conductive layer (TCL) 2304, an electrochromic layer (EC) 2306 (sometimes also referred to as a cathodically coloring layer or a cathodically tinting layer), an ion conducting layer or region (IC) 2308, a counter electrode layer (CE) 2310 (sometimes also referred to as an anodically coloring layer or anodically tinting layer), and a second TCL 2314. Elements 2304, 2306, 2308, 2310, and 2314 are collectively referred to as an electrochromic stack 2320. A voltage source 2316 operable to apply an electric potential across the electrochromic stack 2320 effects the transition of the electrochromic coating from, e.g., a clear state to a tinted state. In other embodiments, the order of layers is reversed with respect to the substrate. That is, the layers are in the following order: substrate, TCL, counter electrode layer, ion conducting layer, electrochromic material layer, TCL. In various embodiments, the ion conductor region (e.g., 2308) may form from a portion of the EC layer (e.g., 2306) and/or from a portion of the CE layer (e.g., 2310). In such embodiments, the electrochromic stack (e.g., 2320) may be deposited to include cathodically coloring electrochromic material (the EC layer) in direct physical contact with an anodically coloring counter electrode material (the CE layer). The ion conductor region (sometimes referred to as an interfacial region, or as an ion conducting substantially electronically insulating layer or region) may form where the EC layer and the CE layer meet, for example through heating and/or other processing steps. Examples of electrochromic devices (e.g., including those fabricated without depositing a distinct ion conductor material) can be found in U.S. patent application Ser. No. 13/462,725, filed May 2, 2012, titled “ELECTROCHROMIC DEVICES,” that is incorporated herein by reference in its entirety. In some embodiments, an EC device coating may include one or more additional layers such as one or more passive layers. Passive layers can be used to improve certain optical properties, to provide moisture, and/or to provide scratch resistance. These and/or other passive layers can serve to hermetically seal the EC stack 2320. Various layers, including transparent conducting layers (such as 2304 and 2314), can be treated with anti-reflective and/or protective layers (e.g., oxide and/or nitride layers).

In certain embodiments, the electrochromic device is configured to (e.g., substantially) reversibly cycle between a clear state and a tinted state. Reversible may be within an expected lifetime of the ECD. The expected lifetime can be at least about 5, 10, 15, 25, 50, 75, or 100 years. The expected lifetime can be any value between the aforementioned values (e.g., from about 5 years to about 100 years, from about 5 years to about 50 years, or from about 50 years to about 100 years). A potential can be applied to the electrochromic stack (e.g., 2320) such that available ions in the stack that can cause the electrochromic material (e.g., 2306) to be in the tinted state reside primarily in the counter electrode (e.g., 2310) when the window is in a first tint state (e.g., clear). When the potential applied to the electrochromic stack is reversed, the ions can be transported across the ion conducting layer (e.g., 2308) to the electrochromic material and cause the material to enter the second tint state (e.g., tinted state).

It should be understood that the reference to a transition between a clear state and tinted state is non-limiting and suggests only one example, among many, of an electrochromic transition that may be implemented. Unless otherwise specified herein, whenever reference is made to a clear-tinted transition, the corresponding device or process encompasses other optical state transitions such as non-reflective-reflective, and/or transparent-opaque. In some embodiments, the terms “clear” and “bleached” refer to an optically neutral state, e.g., untinted, transparent and/or translucent. In some embodiments, the “color” or “tint” of an electrochromic transition is not limited to any wavelength or range of wavelengths. The choice of appropriate electrochromic material and counter electrode materials may govern the relevant optical transition (e.g., from tinted to untinted state).

In certain embodiments, at least a portion (e.g., all of) the materials making up electrochromic stack are inorganic, solid (i.e., in the solid state), or both inorganic and solid. Because various organic materials tend to degrade over time, particularly when exposed to heat and UV light as tinted building windows are, inorganic materials offer an advantage of a reliable electrochromic stack that can function for extended periods of time. In some embodiments, materials in the solid state can offer the advantage of being minimally contaminated and minimizing leakage issues, as materials in the liquid state sometimes do. One or more of the layers in the stack may contain some amount of organic material (e.g., that is measurable). The ECD or any portion thereof (e.g., one or more of the layers) may contain little or no measurable organic matter. The ECD or any portion thereof (e.g., one or more of the layers) may contain one or more liquids that may be present in little amounts. Little may be of at most about 100 ppm, 10 ppm, or 1 ppm of the ECD. Solid state material may be deposited (or otherwise formed) using one or more processes employing liquid components, such as certain processes employing sol-gels, physical vapor deposition, and/or chemical vapor deposition.

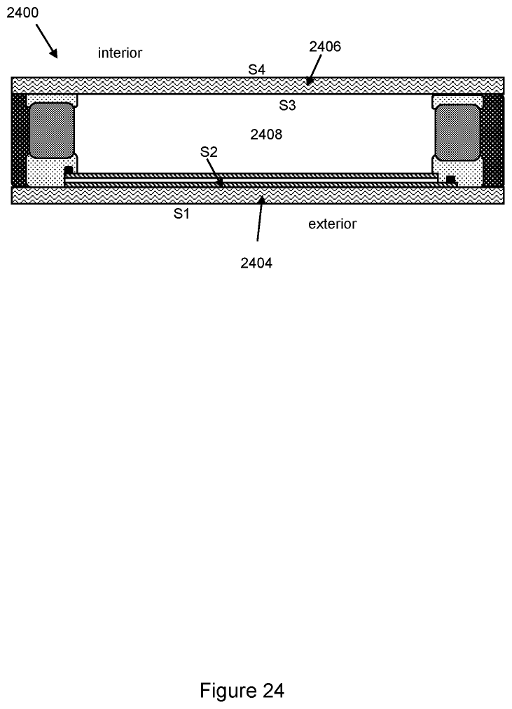

FIG. 24 show an example of a cross-sectional view of a tintable window embodied in an insulated glass unit (“IGU”) 2400, in accordance with some implementations. The terms “IGU,” “tintable window,” and “optically switchable window” can be used interchangeably herein. It can be desirable to have IGUs serve as the fundamental constructs for holding electrochromic panes (also referred to herein as “lites”) when provided for installation in a building. An IGU lite may be a single substrate or a multi-substrate construct. The lite may comprise a laminate, e.g., of two substrates. IGUs (e.g., having double- or triple-pane configurations) can provide a number of advantages over single pane configurations. For example, multi-pane configurations can provide enhanced thermal insulation, noise insulation, environmental protection and/or durability, when compared with single-pane configurations. A multi-pane configuration can provide increased protection for an ECD. For example, the electrochromic films (e.g., as well as associated layers and conductive interconnects) can be formed on an interior surface of the multi-pane IGU and be protected by an inert gas fill in the interior volume (e.g., 2408) of the IGU. The inert gas fill may provide at least some (heat) insulating function for an IGU. Electrochromic IGUs may have heat blocking capability, e.g., by virtue of a tintable coating that absorbs (and/or reflects) heat and light.

In some embodiments, an “IGU” includes two (or more) substantially transparent substrates. For example, the IGU may include two panes of glass. At least one substrate of the IGU can include an electrochromic device disposed thereon. The one or more panes of the IGU may have a separator disposed between them. An IGU can be a hermetically sealed construct, e.g., having an interior region that is isolated from the ambient environment. A “window assembly” may include an IGU. A “window assembly” may include a (e.g., stand-alone) laminate. A “window assembly” may include one or more electrical leads, e.g., for connecting the IGUs and/or laminates. The electrical leads may operatively couple (e.g. connect) one or more electrochromic devices to a voltage source, switches and the like, and may include a frame that supports the IGU or laminate. A window assembly may include a window controller, and/or components of a window controller (e.g., a dock).

FIG. 24 shows an example implementation of an IGU 2400 that includes a first pane 2404 having a first surface S1 and a second surface S2. In some implementations, the first surface S1 of the first pane 2404 faces an exterior environment, such as an outdoors or outside environment. The IGU 2400 also includes a second pane 2406 having a first surface S3 and a second surface S4. In some implementations, the second surface (e.g., S4) of the second pane (e.g., 2406) faces an interior environment, such as an inside environment of a home, building, vehicle, or compartment thereof (e.g., an enclosure therein such as a room).

In some implementations, the first and the second panes (e.g., 2404 and 2406) are transparent or translucent, e.g., at least to light in the visible spectrum. For example, each of the panes (e.g., 2404 and 2406) can be formed of a glass material. The glass material may include architectural glass, and/or shatter-resistant glass. The glass may comprise a silicon oxide (SOx). The glass may comprise a soda-lime glass or float glass. The glass may comprise at least about 75% silica (SiO₂). The glass may comprise oxides such as Na₂O, or CaO. The glass may comprise alkali or alkali-earth oxides. The glass may comprise one or more additives. The first and/or the second panes can include any material having suitable optical, electrical, thermal, and/or mechanical properties. Other materials (e.g., substrates) that can be included in the first and/or the second panes are plastic, semi-plastic and/or thermoplastic materials, for example, poly(methyl methacrylate), polystyrene, polycarbonate, allyl diglycol carbonate, SAN (styrene acrylonitrile copolymer), poly(4-methyl-1-pentene), polyester, and/or polyamide. The first and/or second pane may include mirror material (e.g., silver). In some implementations, the first and/or the second panes can be strengthened. The strengthening may include tempering, heating, and/or chemically strengthening.

While preferred embodiments of the present invention have been shown, and described herein, it will be obvious to those skilled in the art that such embodiments are provided by way of example only. It is not intended that the invention be limited by the specific examples provided within the specification. While the invention has been described with reference to the afore-mentioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations, or relative proportions set forth herein which depend upon a variety of conditions and variables. It should be understood that various alternatives to the embodiments of the invention described herein might be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

In view of this description embodiments may include different combinations of features. Implementation examples are described in the following numbered clauses:

Clause 1: A method of providing a wireless emergency alert message for a facility, the method comprising: receiving an alert for an emergency event at an in-facility network; identifying an emergency incident area of the facility; and sending the wireless emergency alert message through a cellular network to one or more wireless devices within the emergency incident area.

Clause 2: The method of clause 1, further comprising configuring the in-facility network to provide power distribution and communication on a single path.

Clause 3: The method of clause 2 further comprising configuring the single path using a cabling system having a cable configured to transmit an electrical current, a first communication type utilized for control of at least one device of the facility, and a second communication type configured for media communication.

Clause 4: The method of clause 3, wherein the cabling system comprises a distribution junction.

Clause 5: The method of clause 4, wherein the distribution junction distributes the power unevenly.

Clause 6: The method of clause 4, wherein the distribution junction distributes the first communication type and/or second communication type unevenly.

Clause 7: The method of clause 4, wherein the distribution junction is passive.

Clause 8: The method of clause 4, wherein the distribution junction comprises an active element.

Clause 9: The method of clause 8, wherein the active element is a controller.

Clause 10: The method of clause 9, further comprising operatively coupling the in-facility network to at least one controller.

Clause 11: The method of clause 10, further comprising providing a cabling system having a cable configured to transmit an electrical current, a first communication type utilized for control of at least one device of the facility, and a second communication type configured for media communication.

Clause 12: The method of clause 11, wherein the cabling system is configured to provide power distribution and communication to the at least one device of the facility.

Clause 13: The method of clause 12, wherein the cabling system is configured to provide power distribution and communication to the at least one device of the facility on a single path.

Clause 14: The method of clause 11, wherein the at least one controller is configured to generate the first communication type.

Clause 15: The method of clause 10, wherein the at least one controller is configured to operatively couple to a building management system.

Clause 16: The method of clause 11, wherein the first communication type is generated and/or utilized by the at least one device.

Clause 17: The method of clause 11, wherein the at least one device of the facility comprises a sensor, emitter, antenna, tintable window, lighting, security system, heating ventilation and air conditioning system (HVAC), or any of various combinations thereof.

Clause 18: The method of clause 17, wherein the sensor is configured for sensing, or directing sensing of, the emergency event.

Clause 19: The method of clause 18, wherein the sensor is sensitive to movement.

Clause 20: The method of clause 18, wherein the sensor comprises an accelerometer.

Clause 21: The method of clause 18, wherein the emitter comprises a light emitter or a sound emitter.

Clause 22: The method of clause 18, wherein the sensor comprises an infrared, ultraviolet, or visible light sensor.

Clause 23: The method of clause 18, wherein the sensor is sensitive to at least one environmental characteristic comprising humidity, carbon dioxide, temperature, sound, electromagnetic, volatile organic compound, or pressure.

Clause 24: The method of clause 18, wherein the sensor comprises a gas sensor sensitive to gas type, movement, and/or pressure.

Clause 25: The method of clause 11, wherein the at least one device of the facility is part of a device ensemble comprising one or more devices enclosed in a housing.

Clause 26: The method of clause 11, wherein the at least one device of the facility comprises at least two devices of the same type.

Clause 27: The method of clause 11, wherein the at least one device of the facility comprises at least two devices that are not of the same type.

Clause 28: The method of clause 27, wherein the facility is a multi-story building.

Clause 29: The method of clause 28, wherein the multi-story building is a skyscraper.

Clause 30: The method of clause 11, wherein the at least one device of the facility comprises at least one geo-location sensor operatively coupled to the in-facility network.

Clause 31: The method of clause 30, wherein the at least one geo-location sensor comprises a transceiver having a known position.

Clause 32: The method of clause 31, wherein the known position comprises a location within the facility.

Clause 33: The method of clause 31, wherein the known position comprises a location within an enclosure.

Clause 34: The method of clause 31, wherein the known position comprises third-party data.

Clause 35: The method of clause 31, further comprising establishing the known position using a traveler.

Clause 36: The method of clause 30, wherein the at least one geo-location sensor comprises a plurality of stationary transceivers each having a known stationary position.

Clause 37: The method of clause 36, wherein the at least one geo-location sensor further comprises a transitory transceiver.

Clause 38: The method of clause 37, wherein the plurality of stationary transceivers are configured to locate the transitory transceiver in the facility.

Clause 39: The method of clause 37, wherein the transitory transceiver is configured to be (i) carried by an occupant of the facility, and/or (ii) attached to an asset disposed in the facility.

Clause 40: The method of clause 31, wherein the transceiver is disposed in a housing that comprises (i) sensors or (ii) a sensor and an emitter.

Clause 41: The method of clause 40, wherein the housing is disposed in a fixture of the facility.

Clause 42: The method of clause 40, wherein components of the housing are configured to facilitate adjustment of an environment of the facility in which the housing is disposed.

Clause 43: The method of clause 30, wherein the at least one geo-location sensor comprises an ultra-wideband (UWB) device.

What is claimed is:

1. A method of providing a wireless emergency alert message for a facility, the method comprising:
receiving an alert for an emergency event at an in-facility network;
identifying an emergency incident area of the facility; and
sending the wireless emergency alert message through a cellular network to one or more wireless devices within the emergency incident area.

2. The method of claim 1, further comprising:
mapping a location of the emergency event to one or more cells of the cellular network that serve the emergency incident area;
generating the wireless emergency alert message for the one or more cells; and
sending the wireless emergency alert message to the one or more cells for distribution to the one or more wireless devices within the emergency incident area.

3. The method of claim 1, further comprising:
obtaining a category for the emergency event;
determining the emergency incident area of the facility based at least in part on the category;
mapping a location of the emergency event to one or more cells of the cellular network that serve the emergency incident area;
generating the wireless emergency alert message for the one or more cells; and
sending the wireless emergency alert message to the one or more cells for distribution to the one or more wireless devices within the emergency incident area.

4. The method of claim 1, further comprising:
receiving an alerting request incorporating the wireless emergency alert message;
generating a write request incorporating the wireless emergency alert message;
selecting one or more area identifiers corresponding to the emergency incident area, wherein each of the one or more area identifiers is associated with a corresponding destination cell of the cellular network;
sending the write request and the one or more area identifiers to a mobility management mechanism; and
receiving a confirmation message from the mobility management mechanism indicating that the wireless emergency alert message has been distributed to the corresponding destination cell.

5. The method of claim 1, wherein the cellular network comprises a 4G network and/or a 5G network, the method further comprising:
receiving an alerting request at a local cell broadcast center of the cellular network, the alerting request incorporating the wireless emergency alert message;
generating a write replace warning request incorporating the wireless emergency alert message;
selecting one or more tracking area identifiers corresponding to the emergency incident area, wherein each tracking area identifier is associated with a corresponding destination cell of the cellular network;
sending the write replace warning request and the one or more tracking area identifiers to a local mobility management entity; and
receiving a confirmation message from the mobility management entity indicating that the wireless emergency alert message has been distributed to the corresponding destination cell.

6. The method of claim 1, further comprising:
receiving an alarm;
generating the wireless emergency alert message for one or more target cells of the cellular network serving the emergency incident area;
delivering a first broadcast request to a 4G cell broadcast function when any of the one or more target cells are in a 4G cellular network;
delivering a second broadcast request to a 5G cell broadcast function when any of the one or more target cells are in a 5G cellular network;
generating a first write replace warning request in response to the first broadcast request;
generating a second write replace warning request in response to the second broadcast request;
delivering at least one of the first write replace warning request and the second write replace warning request to the one or more target cells.

7. The method of claim 1, further comprising coupling the in-facility network to a plurality of devices.

8. The method of claim 7, further comprising disposing the plurality of devices in an envelope of an enclosure.

9. The method of claim 8, wherein the envelope of the enclosure comprises a building of the facility.

10. The method of claim 1, further comprising configuring the in-facility network to provide power distribution and communication on a single path.

11. The method of claim 10, wherein the single path comprises a coaxial cable, a twisted pair, an optical cable, or any of various combinations thereof.

12. The method of claim 10, wherein the communication is compatible with a device control protocol, a command protocol, a 4G protocol, a 5G protocol, a video protocol, a media protocol, or any of various combinations thereof.

13. The method of claim 10 further comprising configuring the single path using a cabling system having a cable configured to transmit an electrical current, a first communication type utilized for control of at least one device of the facility, and a second communication type configured for media communication.

14. The method of claim 3, further comprising operatively coupling the at least one device of the facility to the in-facility network.

15. The method of claim 3, further comprising configuring a first antenna to receive signals of the second communication type external to the facility and transmit signals of the second communication type externally to the facility, which first antenna is operatively coupled to the cabling system.

16. The method of claim 15, further comprising configuring a second antenna to receive signals of the second communication type internal to the facility, and to transmit signals of the second communication type internally in the facility, which second antenna is operatively coupled to the cabling system.

17. The method of claim 14, further comprising operatively coupling at least one controller to the cabling system, the at least one controller being configured to control the at least one device using the first communication type.

18. The method of claim 3, wherein the first communication type and the second communication type have no overlapping signal frequencies.

19. The method of claim 3, wherein the first communication type is in one frequency window.

20. The method of claim 3, wherein the first communication type comprises a plurality of frequency windows.

21. The method of claim 3, wherein the second communication type is in one frequency window.

22. The method of claim 3, wherein the second communication type comprises a plurality of frequency windows.

23. The method of claim 3, further comprising operatively coupling the cabling system to one or more signal frequency filters.

24. The method of claim 3, further comprising operatively coupling the cabling system to one or more signal amplifiers and/or repeaters.

25. The method of claim 3, wherein the second communication type comprises fourth generation (4G) and/or fifth generation (5G) cellular communication.

26. The method of claim 3, wherein the second communication type comprises analog radio-frequency signals.

27. The method of claim 15, wherein the first antenna is a directional antenna.

28. The method of claim 16, wherein the second antenna is part of a distributed antenna system.

29. The method of claim 16, wherein the second antenna is disposed in one of a plurality of edge distribution frame devices disposed in the facility.

30. The method of claim 3, wherein the electrical current is a direct current.

31. The method of claim 3, further comprising using the electrical current to supply electrical power to the at least one device of the facility.

32. The method of claim 31, further comprising supplying electrical power to the at least one device using a voltage of at most about 48 volts.

33. The method of claim 3, wherein the facility comprises floors and wherein the cabling system comprises an optical cable that transits the first communication type and/or the second communication type between the floors.

34. The method of claim 3, wherein the facility comprises a plurality of control panels and wherein the cabling system comprises an optical cable that transmits the first communication type and/or the second communication type between the plurality of control panels.

35. The method of claim 3, wherein the cabling system comprises a distribution junction.

36. The method of claim 1, further comprising transmitting an alert message to an external entity outside the facility, in response to receiving the alert for the emergency event at the in-facility network.

37. The method of claim 36, wherein the external entity comprises a police department, a fire department, the National Guard, a facility owner, a facility manager, a local governmental unit, or any of various combinations thereof.

38. The method of claim 1, wherein the facility comprises one or more buildings.

39. The method of claim 1, wherein the facility comprises one or more buildings and property adjoining the one or more buildings.

40. The method of claim 1, wherein the wireless emergency alert message is provided locally to the facility.

41. The method of claim 1, wherein the alert for the emergency event is received locally to the facility.

42. A non-transitory computer readable program product for providing a wireless emergency alert message for a facility, the non-transitory computer readable program product having instructions that, when read by at least one processor, cause the at least one processor to execute, or direct execution of, operations of any one of the methods in claims 1 to 41.

43. A non-transitory computer readable program product for providing a wireless emergency alert message for a facility, the non-transitory computer readable program product having instructions that, when read by at least one processor, cause the at least one processor to execute operations comprising:
(a) receiving, or directing receipt of, an alert for an emergency event at an in-facility network;
(b) identifying, or directing identification of, an emergency incident area of the facility; and
(c) sending, or directing sending of, the wireless emergency alert message through a cellular network to one or more wireless devices within the emergency incident area.

44. An apparatus for providing a wireless emergency alert message for a facility, the apparatus comprising at least one controller configured to operatively couple to an in-facility network and perform, or direct performance of, any one of the methods in claims 1 to 41.

45. An apparatus for providing a wireless emergency alert message for a facility, the apparatus comprising at least one controller configured to operatively couple to an in-facility network and perform, wherein the at least one controller is further configured to:
(a) receive, or direct receipt of, an alert for an emergency event at the in-facility network;
(b) identify, or direct identification of, an emergency incident area of the facility; and
(c) send, or direct sending of, the wireless emergency alert message through a cellular network to one or more wireless devices within the emergency incident area.

46. An apparatus for providing a wireless emergency alert message for a facility, the apparatus comprising at least one controller configured to operatively couple to a 4G cellular network and/or a 5G cellular network, wherein the at least one controller is further configured to:
(a) receive, or direct receipt of, a wireless emergency alert from an in-facility network;
(b) receive, or direct receipt of, one or more tracking area identifiers from the in-facility network that identify an emergency incident area of the facility; and
(c) send, or direct sending of, the wireless emergency alert message to one or more wireless devices within the emergency incident area using the one or more tracking area identifiers.

47. A system for providing a wireless emergency alert message for a facility, the system comprising a network of a facility; and one or more sensors disposed in the facility and configured for sensing an emergency event, wherein the network is configured to one or more signals associated with any of the methods in claims 1 to 41.

48. A system for providing a wireless emergency alert message for a facility, the system comprising a network of a facility; and one or more sensors disposed in the facility and configured for sensing an emergency event; and wherein the network is configured to transmit wireless emergency alert message to a cellular network that serves the emergency incident area, which wireless emergency alert is generated based at least in part on measurements of the one or more sensors.
